(19) United States
(12) Patent Application Publication
(10) Pub. No.: US 2026/0361914 A1
(43) Pub. Date: Nov. 12, 2026

(54) MESH DATA TRANSMISSION DEVICE, MESH DATA TRANSMISSION METHOD, MESH DATA RECEPTION DEVICE, AND MESH DATA RECEPTION METHOD

(71) Applicant: LG Electronics Inc., Seoul (KR)

(72) Inventors: Daehyun KIM, Seoul (KR); Joohyung BYEON, Seoul (KR); Naseong KWON, Gyeonggi-do (KR); Donggyu SIM, Seoul (KR)

(21) Appl. No.: 19/515,249

(22) PCT Filed: Aug. 30, 2024
(86) PCT No.: PCT/KR2024/013049

§ 371 Date: Feb. 27, 2026

(30) Foreign Application Priority Data
Aug. 30, 2023 (KR) 10-2023-0114100
Jan. 4, 2024 (KR) 10-2024-0001432

(51) Int. Cl. H04N 19/597; G06T 15/04; G06T 17/20; H04N 19/132

(52) U.S. Cl. CPC H04N 19/597; G06T 15/04; G06T 17/20; H04N 19/132

(57) ABSTRACT

A mesh data decoding method according to embodiments may comprise: a step of receiving a base mesh bitstream, a displacement vector bitstream, a texture map bitstream, and signaling information; a base mesh processing step of restoring a base mesh from the base mesh bitstream; a displacement information processing step of restoring displacement information from the displacement vector bitstream; a restoration step of restoring a mesh on the basis of the base mesh and the displacement information; and a texture map processing step of restoring texture maps from the texture map bitstream.

### TECHNICAL FIELD

Embodiments provide a method for providing 3D content to provide a user with various services such as virtual reality (VR), augmented reality (AR), mixed reality (MR), and self-driving services.

### BACKGROUND ART

Point cloud data or mesh data in 3D content is a set of points in 3D space. However, it is difficult to create point cloud data or mesh data due to the large amount of points in 3D space.

In other words, a large throughput is required to transmit and receive 3D data with a considerable number of points, such as a point cloud or mesh data.

### DISCLOSURE

### Technical Problem

An object of the present disclosure is to provide an apparatus and method for efficiently transmitting and receiving mesh data to resolve the aforementioned issue.

Another object of the present disclosure is to provide an apparatus and method to address the latency and encoding/decoding complexity of mesh data.

Another object of the present disclosure is to provide an apparatus and method for efficiently performing encoding and decoding of displacement vectors.

Embodiments are not limited to the above-described objects, and the scope of the embodiments may be extended to other objects that can be inferred by those skilled in the art based on the entire contents of the present disclosure.

### Technical Solution

To achieve these objects and other advantages and in accordance with the purpose of the present disclosure, as embodied and broadly described herein, a method of decoding mesh data may include receiving a base mesh bitstream, a displacement vector bitstream, a texture map bitstream, and signaling information, a base mesh processing operation of reconstructing a base mesh from the base mesh bitstream, a displacement information processing operation of reconstructing displacement information from the displacement vector bitstream, a reconstruction operation of reconstructing a mesh based on the base mesh and the displacement information, and a texture map processing operation of reconstructing texture maps from the texture map bitstream.

According to embodiments, the texture map processing operation may include decoding the texture map bitstream based on the signaling information and reconstructing the texture maps, checking, based on the signaling information, whether at least one texture map is skipped from the texture map bitstream, and generating, based on that it is checked that there is the at least one skipped texture map, the at least one skipped texture map based on the signaling information and at least one reference frame.

According to embodiments, a unit of skipping of the at least one texture map may be at least one of a frame, a patch, a submesh, a tile, or a slice.

According to embodiments, the signaling information may include information for identifying whether the at least one texture map is skipped, and reference texture map information related to the at least one reference frame.

According to embodiments, an apparatus for decoding mesh data may include a receiver configured to receive a base mesh bitstream, a displacement vector bitstream, a texture map bitstream, and signaling information, a base mesh processor configured to reconstruct a base mesh from the base mesh bitstream, a displacement information processor configured to reconstruct displacement information from the displacement vector bitstream, a reconstructor configured to reconstruct a mesh based on the base mesh and the displacement information, and a texture map processor configured to reconstruct texture maps from the texture map bitstream.

According to embodiments, the texture map processor may be configured to decode the texture map bitstream based on the signaling information and reconstructing the texture maps, check, based on the signaling information, whether at least one texture map is skipped from the texture map bitstream, and generate, based on that it is checked that there is the at least one skipped texture map, the at least one skipped texture map based on the signaling information and at least one reference frame.

According to embodiments, a unit of skipping of the at least one texture map may be at least one of a frame, a patch, a submesh, a tile, or a slice.

According to embodiments, the signaling information may include information for identifying whether the at least one texture map is skipped, and reference texture map information related to the at least one reference frame.

According to embodiments, a method of encoding mesh data may include encoding an original mesh, and transmitting a bitstream containing the encoded mesh and signaling information.

According to embodiments, the encoding may include a base mesh processing operation of generating a base mesh bitstream by encoding a base mesh generated by decimating the original mesh, a displacement information processing operation of generating a displacement vector bitstream by encoding displacement information generated based on the base mesh, a mesh reconstruction operation of reconstructing a mesh based on the encoded base mesh and the encoded displacement information, and a texture map processing operation of determining whether at least one texture map among texture maps generated based on the original mesh and the reconstructed mesh is skipped and generating a texture map bitstream by encoding texture maps that are not skipped.

According to embodiments, the texture map processing operation may include before encoding the generated texture maps, comparing similarity between a current texture map and a reference texture map and determining whether the current texture map is skipped.

According to embodiments, the texture map processing operation may further include based on that a difference between a peak-signal-to-noise ratio (PSNR) calculated based on the current texture map and a PSNR calculated based on the reference texture map is less than a preset threshold, skipping coding and transmission of the current texture map.

According to embodiments, a unit of skipping of the at least one texture map may be at least one of a frame, a patch, a submesh, a tile, or a slice.

According to embodiments, the signaling information may include information for identifying whether the at least one texture map is skipped, and reference texture map information related to at least one reference frame for generating the skipped texture map.

According to embodiments, the reference texture map information may include information for identifying a direction of the at least one reference frame.

According to the embodiments, a computer program stored in a computer-readable recording medium may perform the above-described methods in combination with a computer, which is hardware.

### ADVANTAGEOUS EFFECTS

Embodiments may provide a mesh data transmission method, a mesh data transmission apparatus, a mesh data reception method, and a mesh data reception apparatus capable of providing high-quality 3D services.

Embodiments may provide a mesh data transmission method, a mesh data transmission apparatus, a mesh data reception method, and a mesh data reception apparatus capable of achieving various video codec schemes.

Embodiments may provide a mesh data transmission method, a mesh data transmission apparatus, a mesh data reception method, and a mesh data reception apparatus capable of providing general-purpose 3D content, such as autonomous driving services.

Embodiments may provide a mesh data transmission method, a mesh data transmission apparatus, a mesh data reception method, and a mesh data reception apparatus that, when similarity between a reference texture map and a current texture map of a dynamic mesh is high, skip coding and transmission of the current texture map, thereby reducing bits of the transmitted texture map, improving transmission speed, and reducing the complexity of an encoder and a decoder.

### DESCRIPTION OF DRAWINGS

The accompanying drawings, which are included to provide a further understanding of the disclosure and are incorporated in and constitute a part of this application, illustrate embodiment(s) of the disclosure and together with the description serve to explain the principle of the disclosure. For a better understanding of various embodiments described below, reference should be made to the description of the following embodiments in connection with the accompanying drawings. The same reference numbers will be used throughout the drawings to refer to the same or like parts. In the drawings:

FIG. 1 illustrates a system for providing dynamic mesh content according to embodiments;

FIG. 2 illustrates a V-MESH compression method according to embodiments;

FIG. 3 illustrates pre-processing in V-MESH compression according to embodiments;

FIG. 4 illustrates a mid-edge subdivision method according to embodiments;

FIG. 5 illustrates a displacement generation process according to embodiments;

FIG. 6 illustrates an intra-frame encoding process for V-MESH data according to embodiments;

FIG. 7 illustrates an inter-frame encoding process for V-MESH data according to embodiments;

FIG. 8 illustrates a lifting transform process for displacements according to embodiments;

FIG. 9 illustrates a process of packing transform coefficients into a 2D image according to embodiments;

FIG. 10 illustrates an attribute transfer process in a V-MESH compression method according to embodiments;

FIG. 11 illustrates an intra-frame decoding process for V-MESH data according to embodiments;

FIG. 12 illustrates an inter-frame decoding process for V-MESH data according to embodiments;

FIG. 13 illustrates a transmission apparatus according to embodiments;

FIG. 14 illustrates a reception apparatus according to embodiments;

FIG. 15 illustrates another example of a transmission apparatus according to the embodiments;

FIG. 16 is a flowchart illustrating an example of a method of determining whether texture map coding is skipped according to embodiments;

FIG. 17 illustrates an example of a method of determining whether a texture map is skipped using a maximum texture map distance parameter according to embodiments;

FIG. 18 illustrates an example of a texture map skip status and a reference frame index signaled on a per-submesh basis according to embodiments;

FIG. 19 is a diagram illustrating an example of a relationship between frames of referenced texture maps when texture map coding is skipped on a per-submesh basis according to embodiments;

FIG. 20 is a diagram illustrating another example of a reception apparatus according to embodiments;

FIG. 21 is an example detailed block diagram of a texture map decoder according to embodiments;

FIG. 22 illustrates an example of deriving a texture map skip flag as 0 according to embodiments;

FIG. 23 is a flowchart illustrating an example of deriving a texture map skip flag by a texture map skip flag determiner according to embodiments;

FIG. 24 illustrates an example of texture map skip status and a reference frame index signaled on a sub-mesh basis according to embodiments;

FIG. 25 is a diagram illustrating an example of a frame relationship of a texture map referenced when texture map coding is skipped on a sub-mesh basis according to embodiments;

FIG. 26 illustrates an example of a syntax structure of an atlas frame parameter set (AFPS) according to embodiments;

FIG. 27 is a table showing examples of a texture map skip status and reference direction of afps_texture_skip_refDirection_idx according to embodiments;

FIG. 28 illustrates an example of a syntax structure of an atlas tile header according to embodiments;

FIG. 29 illustrates an example of a syntax structure of an atlas tile data unit according to embodiments;

FIG. 30 is a table showing examples of determining a patch mode according to an identifier when a coding type of a current atlas tile is I_TILE according to embodiments;

FIG. 31 is a table showing examples of determining a patch mode according to an identifier when a coding type of a current atlas tile is P_TILE according to embodiments;

FIG. 32 illustrates an example of a syntax structure of a submesh header according to embodiments;

FIG. 33 illustrates another example of a syntax structure of a submesh header according to embodiments;

FIG. 34 illustrates another example of a syntax structure of an atlas sequence parameter set (ASPS) according to embodiments;

FIG. 35 illustrates another example of a syntax structure of an AFPS according to embodiments;

FIG. 36 is a table showing definitions of afve_texturemap_skip_flag and afve_ref_direction_idx according to embodiments;

FIG. 37 is a diagram illustrating an example of texture map skipping according to embodiments;

FIGS. 38(a) and 38(b) illustrate an example of determining texture map skip status and reference information indices on a frame basis according to embodiments;

FIG. 39 illustrates an example of a syntax structure of an atlas tile layer according to embodiments;

FIG. 40 illustrates an example of a syntax structure of an atlas tile header according to embodiments;

FIG. 41 illustrates an example of a syntax structure of patch information data according to embodiments;

FIG. 42 illustrates an example of a syntax structure of a patch data unit according to embodiments;

FIG. 43 illustrates an example of a syntax structure of an inter patch data unit according to embodiments;

FIG. 44 illustrates an example of semantics of a NAL unit header according to embodiments;

FIG. 45 illustrates an example of a syntax structure of atlas_frame_rbsp( ) according to embodiments;

FIG. 46 is a flowchart illustrating an example of a transmission method according to embodiments; and FIG. 47 is a flowchart illustrating an example of a reception method according to embodiments.

### BEST MODE

Reference will now be made in detail to the preferred embodiments of the present disclosure, examples of which are illustrated in the accompanying drawings. The detailed description, which will be given below with reference to the accompanying drawings, is intended to explain exemplary embodiments of the present disclosure, rather than to show the only embodiments that can be implemented according to the present disclosure. The following detailed description includes specific details in order to provide a thorough understanding of the present disclosure. However, it will be apparent to those skilled in the art that the present disclosure may be practiced without such specific details.

Although most terms used in the present disclosure have been selected from general ones widely used in the art, some terms have been arbitrarily selected by the applicant and their meanings are explained in detail in the following description as needed. Thus, the present disclosure should be understood based upon the intended meanings of the terms rather than their simple names or meanings.

With recent advancements in 3D data modeling and rendering technologies, research on generating and processing 3D data has been actively conducted across various fields, including virtual reality (VR), augmented reality (AR), autonomous driving, computer-aided design (CAD)/computer-aided manufacturing (CAM), and geographic information systems (GIS). 3D data may be represented as a point cloud or a mesh depending on the representation format. A mesh is composed of geometry information indicating the coordinates of each vertex or point, connectivity information indicating connections between vertices, a texture map representing color information about the mesh surface as 2D image data, and texture coordinates indicating the mapping information between the surface of the mesh and the texture map. In the present disclosure, a mesh is defined as a dynamic mesh when at least one of the elements constituting the mesh changes over time, and is defined as a static mesh when it does not change.

Dynamic mesh data involves significantly larger amounts of data of elements to represent the mesh compared to 2D image data. As a result, techniques for efficiently compressing a large amount of mesh data have been developed to store and transmit the data.

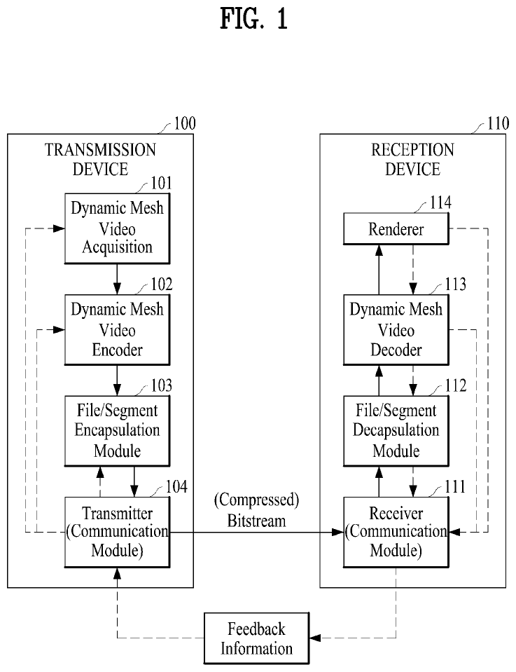

FIG. 1 illustrates a system for providing dynamic mesh content according to embodiments.

The system in FIG. 1 includes a transmission apparatus 100 and a reception apparatus 110. The transmission apparatus 100 may include a mesh video acquisition unit (or part) 101, a mesh video encoder 102, a file/segment encapsulator 103, and a transmitter 104. The reception apparatus 110 may include a receiver 111, a file/segment decapsulator 112, a mesh video decoder 113, and a renderer 114. Each component in FIG. 1 may correspond to hardware, software, a processor, and/or a combination thereof. In the following description, a mesh data transmission apparatus according to embodiments may be interpreted as referring to a 3D data transmission apparatus or transmission apparatus 100, or as referring to a mesh video encoder (hereinafter, encoder) 102. A mesh data reception apparatus according to embodiments may be interpreted as referring to a 3D data reception apparatus or reception apparatus 110, or as referring to a mesh video decoder (hereinafter, decoder) 113.

The system of FIG. 1 may perform video-based dynamic mesh compression and decompression.

With advancements in 3D capture, modeling, and rendering, users are allowed to access 3D content in various forms, such as AR, XR, metaverse, and holograms, across multiple platforms and devices. 3D content is increasingly becoming sophisticated and realistic in its representation of objects to provide immersive experiences for users. However, this requires a substantial amount of data for generation and use of 3D models. Among the various types of 3D content, 3D meshes are widely used for efficient data utilization and realistic object representation. Embodiments include a series of processing steps in a system that uses mesh content.

First, the method of compressing dynamic mesh data starts with the Video-based point cloud compression (V-PCC) standard technique for point cloud data. Point cloud data is data that has color information in the coordinates (X, Y, Z) of vertices (or points). In the present disclosure, vertex coordinates (i.e., position information) are referred to as geometry information, color information about vertices is referred to as attribute information. The geometry information and attribute information are together referred to as vertex information or point cloud data. Mesh data refers to vertex information including inter-vertex connectivity information. Content may be originally created in the form of mesh data. Alternatively, connectivity information may be added to point cloud data, and the point cloud data may be transformed into mesh data.

Currently, the MPEG standards group defines two data types for dynamic mesh data:

Category 1 of mesh data having a texture map as color information, and Category 2 of mesh data having vertex colors as color information.

Mesh coding standards for Category 1 data are currently underway, and standardization for Category 2 data is expected to follow. The overall process for providing a mesh content service may include acquisition, encoding, transmission, decoding, rendering, and/or feedback processes, as shown in FIG. 1.

To provide mesh content services, 3D data acquired through multiple cameras or special cameras may be processed into a mesh data type through a series of steps to generate a mesh video. The generated mesh video may be transmitted through a series of operations, and the receiving side may process the received data back into a mesh video for rendering. Through this process, the mesh video may be provided to the user, allowing the user to utilize the mesh content interactively according to their intent.

As shown in FIG. 1, a mesh compression system may include a transmission apparatus 100 and a reception apparatus 110. The transmission apparatus 100 may encode the mesh video to output a bitstream, which may be delivered to the reception apparatus 110 over a digital storage medium or a network in the form of file or streaming (streaming segments). The digital storage medium may include various storage media such as USB, SD, CD, DVD, Blu-ray, HDD, and SSD.

In the transmission apparatus 100, the encoder may be referred to as a mesh video/image/picture/frame encoding device. In the reception apparatus 110, the decoder may be referred to as a mesh video/image/picture/frame decoding device. A transmitter may be included in the mesh video encoder, and a receiver may be included in the mesh video decoder. The renderer 114 may include a display, and the renderer and/or display may be configured as separate devices or external components. The transmission apparatus 100 and reception apparatus 110 may further include separate internal or external modules/units/components for the feedback process.

Mesh data represents the surface of an object using multiple polygons. Each polygon is defined by vertices in 3D space and connectivity information indicating how the vertices are connected. Additionally, vertex attributes such as color and normal vectors may be included in the data. Mapping information, which allows the surface of the mesh to be mapped onto a 2D plane, may also be included in the attributes of the mesh. The mapping is generally described using a set of parametric coordinate related to mesh vertices, referred to as UV coordinates or texture coordinates, related to related to the vertices of the mesh. A mesh contains a 2D attribute map, which may be used to store high-resolution attribute information such as texture, normal, and displacement. Here, the displacement may be used interchangeably with displacement information or a displacement vector.

The mesh video acquisition unit 101 may include processing 3D object data acquired through a camera or the like into a mesh data type having the attributes described above through a series of operations and generating a video composed of the mesh data. In the mesh video, the attributes of the mesh, such as vertices, polygons, connectivity between vertices, color, and normal, may change over time. A mesh video with attributes and connectivity information that change over time is referred to as a dynamic mesh video.

The mesh video encoder 102 may encode an input mesh video into one or more video streams. A video may contain multiple frames, each of which may correspond to a still image/picture. In the present disclosure, the mesh video may include mesh images/frames/pictures. The term “mesh video” may be used interchangeably with mesh images/frames/pictures. The mesh video encoder 102 may perform a Video-based Dynamic Mesh (V-Mesh) compression procedure. For compression and coding efficiency, the mesh video encoder 102 may perform a series of procedures such as prediction, transformation, quantization, and entropy coding. Encoded data (encoded video/image information) may be output in the form of a bitstream.

The file/segment encapsulation module 103 may encapsulate encoded mesh video data and/or mesh video-related metadata in the form of a file or the like. The mesh video-related metadata may be received from a metadata processor. The metadata processing unit may be included in the mesh video encoder 102, or may be configured as a separate component/module. The file/segment encapsulation module 103 may encapsulate the data into a file format such as ISOBMFF or process the same into forms such as DASH segments. According to embodiments, the file/segment encapsulator 103 may include the mesh video-related metadata in the file format. For example, the mesh video metadata may be included in boxes at various levels in the ISOBMFF file format, or as data on separate tracks in the file. In some embodiments, the file/segment encapsulator 103 may encapsulate the mesh video-related metadata into a file.

The transmission processor may apply processing to the encapsulated mesh video data for transmission based on the file format. The transmission processor may be included in the transmitter 104 or implemented as a separate component/module. The transmission processor may process the mesh video data according to any transmission protocol. The processing for transmission may include processing for delivery over a broadcast network and processing for delivery over a broadband. In some embodiments, the transmission processor may receive mesh video-related metadata from the metadata processor, as well as the mesh video data, and process the same for transmission.

The transmitter 104 may transmit the encoded video/image information or data output in bitstream form to the receiver 111 of the reception apparatus 110 over a digital storage medium or network in the form of a file or streaming. The digital storage medium may include various storage media such as USB, SD, CD, DVD, Blu-ray, HDD, and SSD. The transmitter 104 may include an element to generate a media file through a predetermined file format, and may include an element for transmission over a broadcast/communication network. The receiver 111 may extract the bitstream and deliver the same to a decoding device.

The receiver 111 may receive the mesh video data transmitted by the mesh data transmission apparatus. Depending on the channel for transmission, the receiver 111 may receive the mesh video data over a broadcast network or a broadband network, or may receive the mesh video data over a digital storage medium.

The reception processor may perform processing on the received mesh video data according to the transmission protocol. The reception processor may be included in the receiver 111, or may be configured as a separate component/module. To correspond to the processing performed for transmission on the transmitting side, the reception processor may perform the reverse process to the operations of the transmission processor described above. The reception processor may deliver the acquired mesh video data to the file/segment decapsulator 112 and the acquired mesh video-related metadata to the metadata parser. The mesh video-related metadata acquired by the reception processor may be in the form of a signaling table.

The file/segment decapsulator 112 may decapsulate mesh video data in the form of files received from the reception processor. The file/segment decapsulator 112 may decapsulate the files according to ISOBMFF or the like to acquire a mesh video bitstream or mesh video-related metadata (metadata bitstream). The acquired mesh video bitstream may be delivered to the mesh video decoder 113, and the acquired mesh video-related metadata (metadata bitstream) may be delivered to the metadata processor. The mesh video bitstream may include metadata (metadata bitstream). The metadata processor may be included in the mesh video decoder 113, or may be configured as a separate component/module. The mesh video-related metadata acquired by the file/segment decapsulator 112 may be in the form of boxes or tracks in the file format. The file/segment decapsulator 112 may receive metadata required for decapsulation from the metadata processor, when necessary. The mesh video-related metadata may be delivered to the mesh video decoder 113 for use in the mesh video decoding procedure, or to the renderer 114 for use in the mesh video rendering procedure.

The mesh video decoder 113 may receive the input bitstream and perform the reverse operation corresponding to the operation of the mesh video encoder 102 to decode the video/images. The decoded mesh video/images may be displayed through the display of the renderer 114. The user may view all or a portion of the rendered result through a VR/AR display, a general display, or the like.

The feedback process may include transmitting various kinds of feedback information that may be acquired during the rendering/display operation to the transmitting side or to the decoder on the receiving side. The feedback process may provide interactivity in consuming the mesh video. In some embodiments, the feedback process may include transmitting head orientation information, viewport information indicative of an area the user is currently viewing, and the like. In some embodiments, the user may interact with objects implemented in the VR/AR/MR/autonomous driving environment. In this case, the information related to the interaction may be delivered to the transmitting side or service provider during the feedback process. In some embodiments, the feedback process may be skipped.

The head orientation information may refer to information about the user's head position, angle, movement, etc. Based on this information, information about the area that the user is currently viewing within the mesh video, i.e., viewport information, may be calculated.

The viewport information may be information about the area in the mesh video that the user is currently viewing. Gaze analysis may be performed based on this information to determine how the user consumes the mesh video, how long the user is looking at a particular area of the mesh video, and the like. The gaze analysis may be performed on the receiving side and the result may be delivered to the transmitting side through a feedback channel. A device, such as a VR/AR/MR display, may extract a viewport area based on the user's head position/orientation, the vertical or horizontal FOV supported by the device, etc.

In some embodiments, the feedback information described above may not only be delivered to the transmitter, but may also be consumed on the receiving side. In other words, operations such as decoding and rendering may be performed on the receiving side based on the feedback information described above. For example, based on the head orientation information and/or viewport information, only the mesh video for the area currently being viewed by the user may be preferentially decoded and rendered.

The present disclosure relates to embodiments of dynamic mesh video compression as described above. The methods/embodiments disclosed herein may be applied to the standard of Video-based Dynamic mesh compression (V-Mesh) of the Moving Picture Experts Group (MPEG) or any next-generation video/image coding standard. Dynamic mesh video compression is a method for processing mesh connectivity information and attributes that change over time. It may perform lossy and lossless compression for a variety of applications such as real-time communications, storage, free-viewpoint video, and AR/VR.

The dynamic mesh video compression method described below is based on the V-mesh method of the MPEG.

In the present disclosure, a picture/frame may generally refer to a unit that represents one image at a specific time.

A pixel or pel may refer to the smallest unit that constitutes a picture (or video). Additionally, the term “sample” may be used as a term corresponding to a pixel. A sample may generally indicate a pixel or the value of the pixel in general. It may indicate only the pixel/pixel value of the luma component, or may indicate only the pixel/pixel value of the chroma component, or may indicate only the pixel/pixel value of the depth component.

A unit may represent the basic unit of image processing. The unit may include at least one of a specific area of the picture and information related to the region. In some cases, the term unit may be used interchangeably with terms such as block or area. In general, an MxN block may include a set (or array) of samples (or a sample array) or transform coefficients composed of M columns and N rows.

As described above, the encoding process of FIG. 1 is performed as follows.

In other words, the compression method of Video-based dynamic mesh compression (V-Mesh) may provide a method of compressing dynamic mesh video data based on 2D video codecs such as High Efficiency Video Coding (HEVC) and Versatile Video Coding (VVC). In the V-Mesh compression process, the following data is received as input and compressed.

Input mesh: Includes 3D coordinates of the vertices comprising the mesh, normal information about each vertex, mapping information for mapping the surface of the mesh to a 2D plane, and connectivity between the vertices constituting the surface. The surface of the mesh may be represented by triangles or other polygons, and the connectivity information between the vertices constituting the surface is stored according to a predetermined shape. The input mesh may be stored in the OBJ file format.

Attribute map (Texture map is also used interchangeably hereafter): Contains information about the attributes (color, normals, displacements, etc.) of a mesh and stores the data in the form of a mapping of the surface of the mesh onto a 2D image. Mapping indicating which part (surface or vertex) of the mesh corresponds to each piece of data in the attribute map is based on the mapping information contained in the input mesh. Since the attribute map has data about each frame of the mesh video, it may also be referred to as an attribute map video. The attribute map in the V-Mesh compression method mainly contains the color information about the mesh and is stored in an image file format (PNG, BMP, etc.).

Material library file: Contains the material attribute information used in the mesh, specifically the information that links the input mesh to the corresponding attribute map. It is stored in the Wavefront Material Template Library (MTL) file format.

In the V-Mesh compression method, the following data and information may be generated through the compression process.

Base mesh: Represents the objects in the input mesh using the minimum vertices determined according to the user's criteria by decimating the input mesh through the pre-processing process.

Displacement: Displacement information used to represent the input mesh as similarly as possible using the base mesh, expressed in 3D coordinates.

Atlas information: Metadata needed to reconstruct a mesh using the base mesh, displacement, and attribute map information. It may be generated and utilized in sub-units (sub-mesh, patch, etc.) that constitute the mesh.

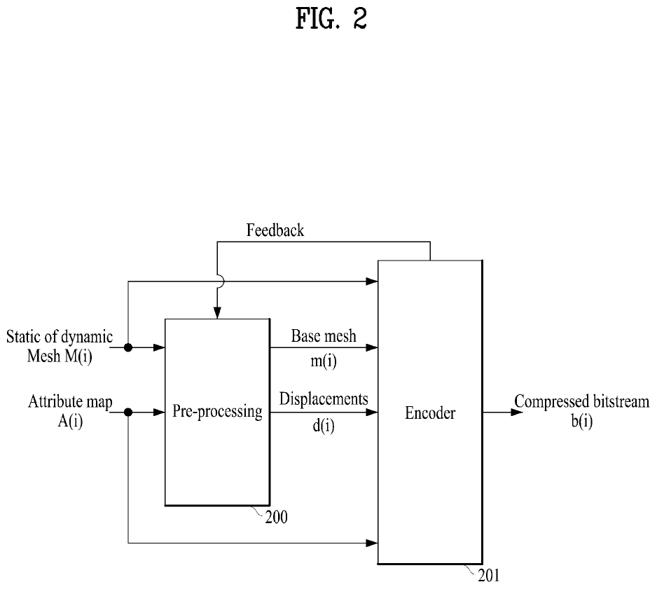

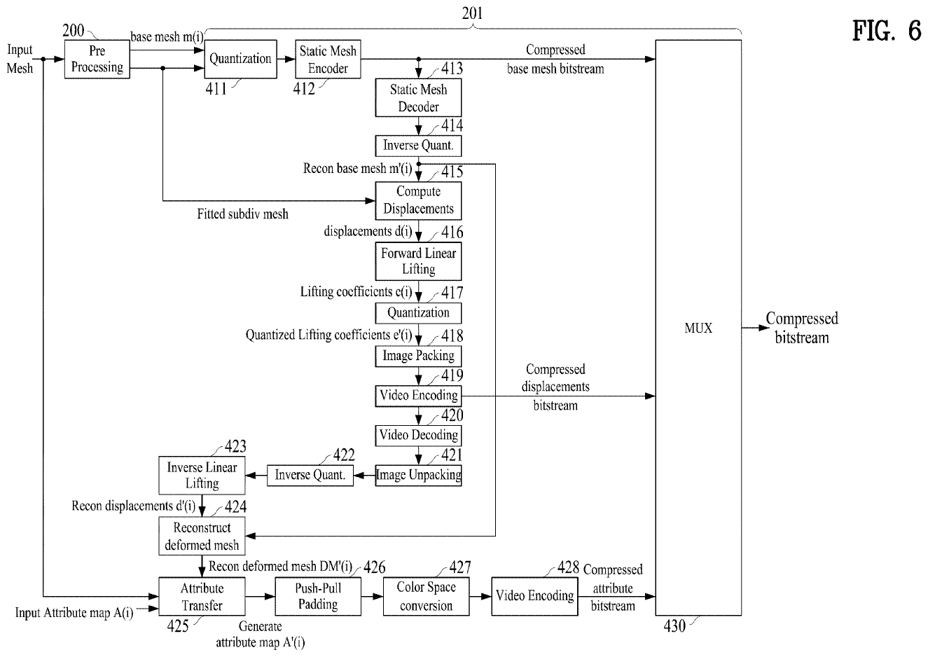

A method of encoding mesh position information (or vertex position information) is described with reference to FIGS. 2 to 7, and a method of reconstructing mesh position information to encode attribute information (attribute map) is described with reference to FIGS. 6 to 10 and the like.

FIG. 2 illustrates a V-MESH compression method according to embodiments.

FIG. 2 illustrates the encoding process of FIG. 1, wherein the encoding process may include a pre-processing process and an encoding process. The mesh video encoder 102 of FIG. 1 may include a pre-processor 200 and an encoder 201, as shown in FIG. 2. Also, the transmission apparatus of FIG. 1 may be broadly referred to as an encoder, and the mesh video encoder 102 of FIG. 1 may be referred to as an encoder. The V-Mesh compression method may include pre-processing 200 and encoding 201, as shown in FIG. 2. The pre-processor 200 of FIG. 2 may be positioned at the front end of the encoder 201 of FIG. 2. The pre-processor 200 and encoder 201 of FIG. 2 may be referred to as a single encoder.

The pre-processor 200 may receive a static of dynamic mesh (M(i)) and/or an attribute map (A(i)). The pre-processor 200 may generate a base mesh m(i) and/or displacements d(i) through pre-processing. The pre-processor 200 may receive feedback information from the encoder 201, and may generate the base mesh and/or displacements based on the feedback information.

The encoder 201 may receive the base mesh m(i), the displacements d(i), the static of dynamic mesh M(i), and/or the attribute map A(i). In the present disclosure, at least one of the base mesh m(i), the displacements d(i), the static of dynamic mesh M(i), and/or the attribute map A(i) may be referred to herein as mesh-related data. The encoder 201 may encode the mesh-related data to generate a compressed bitstream.

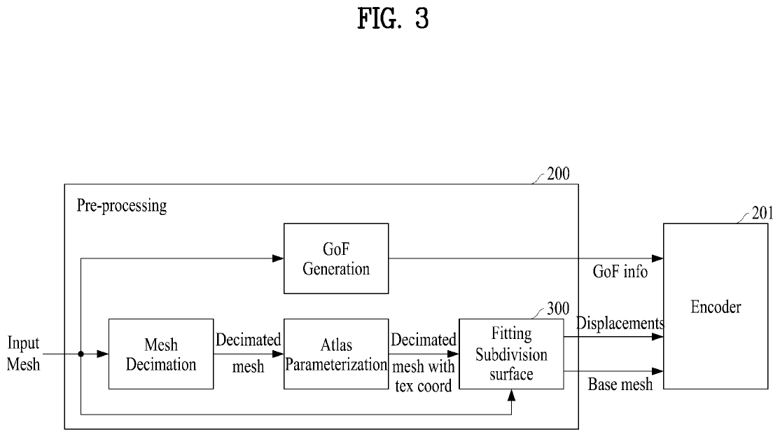

FIG. 3 illustrates pre-processing in V-MESH compression according to embodiments.

FIG. 3 illustrates the configuration and operation of the pre-processor of FIG. 2. In FIG. 3, the input mesh may include a static of dynamic mesh M(i) and/or attribute map A(i). The input mesh may also include 3D coordinates of vertices constituting the mesh, normal information about each vertex, mapping information for mapping the mesh surface to a 2D plane, and connectivity information between the vertices constituting the surface.

FIG. 3 illustrates the process of performing pre-processing on the input mesh. The pre-processing 200 may include four operations: 1) Group of Frame (GoF) generation, 2) mesh decimation, 3) UV parameterization, and 4) fitting subdivision surface (300). According to embodiments, the GoF generation may be referred to as a GoF generation process or a GoF generator, the mesh decimation may be referred to as a mesh simplification process or the mesh decimation part, the UV parameterization may be referred to as a UV parameterization process or the UV parameterization part, and the fitting subdivision surface may be referred to as a fitting subdivision surface process or a fitting subdivision surface part. The pre-processor 200 may generate displacements and/or a base mesh from the received input mesh, and deliver the same to the encoder 201. The pre-processor 200 may deliver GoF information related to the GoF generation to the encoder 201.

Hereinafter, each operation of FIG. 3 is described.

GoF generation: A process of generating a reference structure for the mesh data. When the mesh of the previous frame and the current mesh have the same number of vertices, same number of texture coordinates, same vertex connectivity information, and same texture coordinate connectivity information, the previous frame may be set as a reference frame. In other words, if only the vertex coordinate values are different between the current input mesh and the reference input mesh, the encoder 201 may perform inter frame encoding. Otherwise, it performs intra frame encoding for the frame.

Mesh decimation: A process of simplifying the input mesh to create a simplified mesh, called a base mesh. Vertices to remove may be selected from the original mesh based on user-defined criteria, and then the selected vertices and the triangles connected to the selected vertices may be removed.

In the process of performing mesh decimation, the voxelized input mesh, target triangle ratio (TTR), and minimum triangle component (CCCount) information may be delivered as input, and the decimated mesh may be obtained as output. In the process, connected triangle components that are smaller than the set minimum triangle component (CCCount) may be removed.

UV parameterization: A process of mapping a 3D curved surface into a texture domain for the decimated mesh. Parameterization may be performed using the UVAtlas tool. This process generates mapping information indicating where each vertex of the decimated mesh may be mapped to on the 2D image. The mapping information is expressed and stored as texture coordinates, and the final base mesh is generated through this process.

Fitting subdivision surface (300): A process of performing subdivision on the decimated mesh (i.e., a decimated mesh with texture coordinates). The displacements and base mesh generated by this process are output to the encoder 201. A user-defined method, such as the mid-edge method, may be applied as the subdivision method. A fitting process is performed such that the input mesh and the subdivided mesh become similar to each other. The mesh on which the fitting process is performed will be referred to herein as the fitted subdivided mesh.

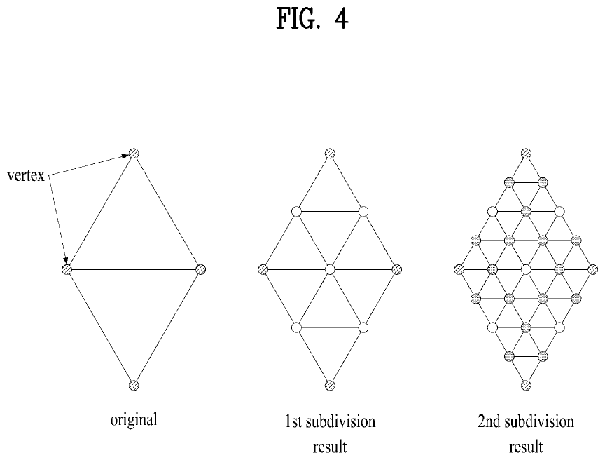

FIG. 4 illustrates a mid-edge subdivision method according to embodiments.

FIG. 4 illustrates a mid-edge subdivision method for the fitting subdivision surface described with reference to FIG. 3. Referring to FIG. 4, the original mesh containing four vertices is subdivided to create sub-meshes. The sub-meshes may be created by creating new vertices in the middle of the edges between the vertices. Then, the fitting process is performed to make the input mesh and the sub-mesh similar to each other, resulting in a fitted subdivided mesh.

Once the fitted subdivided mesh is generated, the displacements are calculated based on this result and the previously compressed and decoded base mesh (hereinafter referred to as the reconstructed base mesh). In other words, the reconstructed base mesh is subdivided in the same way as the fitting subdivision surface. The difference in position between this result and each vertex in the fitted subdivided mesh is the displacement for each vertex. Since the displacement represents a difference in position in 3D space, it is expressed as values in (x, y, z) space in the Cartesian coordinate system. Depending on a user input parameter, the coordinate values of (x, y, z) may be converted to coordinate values of (normal, tangential, bi-tangential) in a local coordinate system.

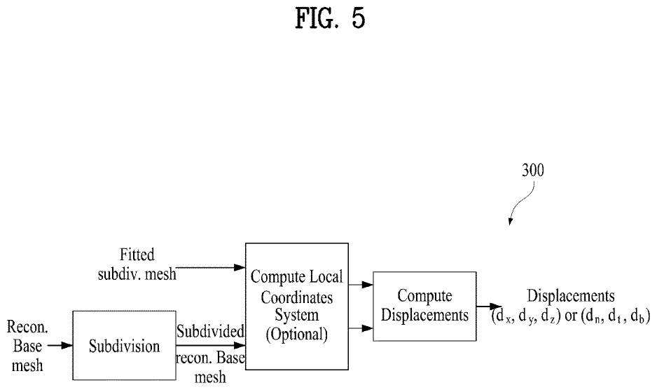

FIG. 5 illustrates a displacement generation process according to embodiments. The displacement generation process of FIG. 5 may be performed by the pre-processor 200, or may be performed by the encoder 201.

FIG. 5 illustrates in detail how displacements are calculated for the fitting subdivision surface 300, as described with reference to FIG. 4.

The encoder and/or pre-processor according to the embodiments may include 1) a subdivider, 2) a local coordinate system calculator, and 3) a displacement vector calculator. The subdivider may perform a subdivision on the reconstructed base mesh to generate a subdivided reconstructed base mesh. Here, the reconstruction of the base mesh may be performed by the pre-processor 200, or may be performed by the encoder 201. The local coordinate system calculator may receive the fitted subdivided mesh and the subdivided reconstructed base mesh, and may transform the coordinate system related to the mesh to a local coordinate system based on the received meshes. The local coordinate system calculation may be optional. The displacement calculator calculates the difference in position between the fitted subdivision mesh and the subdivided reconstructed base mesh. For example, it may generate the difference in position between the vertices in the two input meshes. The difference in position between the vertices is the displacement.

The mesh data transmission method and apparatus according to embodiments may encode the mesh data as follows. Mesh data is a term that includes point cloud data. Point cloud data (which may be referred to as a point cloud for short) according to embodiments may refer to data including vertex coordinates (also referred to as geometry information) and color information (also referred to as attribute information). In addition, a geometry image, an attribute image, an occupancy map, and auxiliary information (also referred to as patch information) generated through patch generation and packing based on vertex coordinates and color information may also be referred to as point cloud data. Therefore, point cloud data including connectivity information may be referred to as mesh data. The terms point cloud and mesh data may be used interchangeably herein.

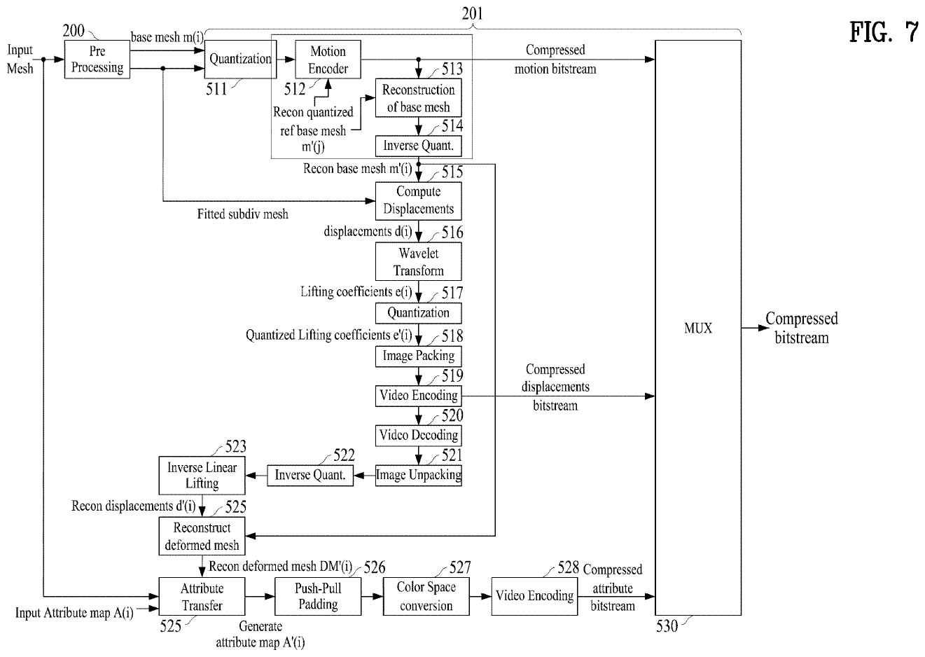

According to embodiments, the V-Mesh compression (reconstruction) method may include intra frame encoding (FIG. 6) and inter frame encoding (FIG. 7).

Based on the results of the GoF generation described above, intra frame encoding or inter frame encoding is performed. In the intra encoding, the data to be compressed may be a base mesh, displacements, an attribute map, and the like. In the inter encoding, the data to be compressed may be displacements, an attribute map, and a motion field between the reference base mesh and the current base mesh.

FIG. 6 illustrates an intra-frame encoding process in a V-MESH compression method according to embodiments. Each component for the intra-frame encoding process of FIG. 6 corresponds to hardware, software, a processor, and/or a combination thereof.

The encoding process of FIG. 6 details the encoding of the mesh video encoder 102 of FIG. 1. That is, it represents the configuration of the mesh video encoder 102 when the encoding of FIG. 1 is intra-frame encoding. The encoder of FIG. 6 may include a pre-processor 200 and/or an encoder 201. The pre-processor 200 and encoder 201 of FIG. 6 may correspond to the pre-processor 200 and encoder 201 of FIG. 3.

The pre-processor 200 may receive an input mesh and perform the pre-processing described above. A base mesh and/or a fitted subdivided mesh may be generated through the pre-processing.

The quantizer 411 of the encoder 201 may quantize the base mesh and/or the fitted subdivided mesh. The static mesh encoder 412 may encode the static mesh (i.e., the quantized base mesh) and generate a bitstream containing the encoded base mesh (i.e., a compressed base mesh bitstream). The static mesh decoder 413 may decode the encoded static mesh (i.e., the encoded base mesh). The inverse quantizer 414 may inversely quantize the quantized static mesh (i.e., base mesh) and output a reconstructed (restored) base mesh. The displacement calculator 415 may generate a displacement or displacements based on the reconstructed static mesh (i.e., base mesh) and the fitted subdivided mesh. According to embodiments, the displacement calculator 415 subdivides the reconstructed base mesh and then calculates a displacement, which is the difference in position of each vertex between the subdivided base mesh and the fitted subdivided mesh. In other words, the displacement is a displacement vector that is the difference in position between the vertices in the two meshes when the fitted subdivided mesh is similar to the original mesh. The forward linear lifter 416 may perform a lifting transform on the input displacements to generate lifting coefficients (also referred to as a transform coefficient). The quantizer 417 may quantize the lifting coefficients. The image packer 418 may pack the image based on the quantized lifting coefficients. The video encoder 419 may encode the packed image. That is, the quantized lifting coefficients are packed into a frame as a 2D image by the image packer 418, compressed by the video encoder 419, and output as a displacement bitstream (i.e., a compressed displacement bitstream).

The video decoder 420 decodes the compressed displacement bitstream. The image unpacker 421 may perform unpacking on the decoded displacement frame to output quantized lifting coefficients. The inverse quantizer 422 may inversely quantize the quantized lifting coefficients. The inverse linear lifting unit 423 applies inverse lifting to the inversely quantized lifting coefficients to generate reconstructed displacements. The mesh reconstructor 424 restores the reconstructed and deformed mesh based on the reconstructed displacements output from the inverse linear lifting unit 423 and the reconstructed base mesh (also referred to as the subdivided reconstructed base mesh) output from the inverse quantizer 414. The reconstructed and deformed mesh is referred to herein as the reconstructed deformed mesh.

The attribute transfer 425 receives an input mesh and/or an input attribute map and regenerates an attribute map based on the reconstructed deformed mesh. The attribute map refers to a texture map corresponding to attribute information among the mesh data components. In the present disclosure, the terms attribute map and texture map may be used interchangeably. The push-pull padding unit 426 may pad data to the attribute map based on a push-pull method. The color space converter 427 may convert the space of the color components of the attribute map.

For example, the attribute map may be converted from an RGB color space to a YUV color space. The video encoder 428 may encode the attribute map to output a compressed attribute bitstream.

The multiplexer 430 may multiplex the compressed base mesh bitstream, the compressed displacement bitstream, and the compressed attribute bitstream to generate a compressed bitstream.

In FIG. 6, the displacement calculator 415 may be included in the pre-processor 200. Additionally, at least one of the quantizer 411, the static mesh encoder 412, the static mesh decoder 413, or the inverse quantizer 414 may be included in the pre-processor 200.

As described in FIG. 6, the intra frame encoding method includes base mesh encoding (also referred to as static mesh encoding). That is, when intra frame encoding is performed on the current input mesh frame, the base mesh generated during the pre-processing of the pre-processor 200 may be quantized by the quantizer 411 and then encoded by the static mesh encoder 412 using a static mesh compression technique. In the V-Mesh compression method, for example, the Draco technique is applied to encode the base mesh, and the vertex position information, mapping information (texture coordinates), vertex connectivity information, and the like related to the base mesh are subject to compression.

The encoder in FIG. 6 compresses the base mesh, displacements, and attributes in a frame to generate a bitstream, while the encoder in FIG. 7 compresses the motion, displacements, and attributes between the current frame and a reference frame to generate a bitstream.

FIG. 7 illustrates an inter-frame encoding process in a V-MESH compression method according to embodiments. Each component for the inter-frame encoding process of FIG. 7 corresponds to hardware, software, a processor, and/or a combination thereof.

The encoding process of FIG. 7 details the encoding of FIG. 1 in detail. That is, it represents the configuration of the encoder when the encoding of FIG. 1 is inter-frame encoding. The encoder of FIG. 7 may include a pre-processor 200 and/or an encoder 201. The pre-processor 200 and encoder 201 of FIG. 7 may correspond to the pre-processor 200 and encoder 201 of FIG. 3.

For the components of the encoding operation of FIG. 7 that correspond to the encoding operation of FIG. 6, refers to the description of FIG. 6. That is, the operations of the quantizer 511, displacement calculator 515, wavelet transformer 516, quantizer 517, image packer 518, video encoder 519, video decoder 520, image unpacker 521, inverse quantizer 522, and inverse wavelet transformer 523, mesh reconstructor 524, attribute transfer 525, push-pull padding 526, color space converter 527, video encoder 528, and multiplexer 530 in FIG. 7 are the same as or similar to the operations of the quantizer 411, static mesh encoder 412, static mesh decoder 413, and inverse quantizer 414, displacement calculator 415, forward linear lifting unit 416, quantizer 417, image packer 418, video encoder 419, video decoder 420, image unpacker 421, inverse quantizer 422, inverse linear lifting unit 423, and mesh reconstructor 424, attribute transfer 425, push-pull padding 426, color space converter 427, video encoder 428, and multiplexer 430 in FIG. 6 described above, and are therefore not described in detail in relation to FIG. 7 to avoid redundancy.

In FIG. 7, for inter-frame-based encoding, the motion encoder 512 may obtain and encode a motion vector between the reconstructed quantized reference base mesh and the quantized current base mesh, and output a compressed motion bitstream. The motion encoder 512 may be referred to as a motion vector encoder. The base mesh reconstructor 513 may reconstruct a base mesh based on the reconstructed quantized reference base mesh and the encoded motion vectors. The reconstructed base mesh is inversely quantized by the inverse quantizer 514 and output to the displacement calculator 515.

In FIG. 7, the displacement calculator 515 may be included in the pre-processor 200. Additionally, at least one of the quantizer 511, motion encoder 512, base mesh reconstructor 513, or inverse quantizer 514 may be included in the pre-processor 200.

As described with reference to FIG. 7, the inter-frame encoding method may include motion field encoding (also referred to as motion vector encoding). Inter frame encoding may be performed when the reference mesh and the current input mesh have a one-to-one correspondence of vertices, and only the position information about the vertices differs therebetween. When inter frame encoding is performed, the base mesh may not be compressed. Instead, the difference between the vertices of the reference base mesh and the current base mesh, i.e., the motion field (or motion vector) may be computed and encoded. The reference base mesh is the result of quantizing the decoded base mesh data and is determined by the reference frame index determined in the GoF generation. The motion field may be encoded as it is. Alternatively, a predicted motion field may be calculated by averaging the motion fields of the reconstructed vertices among the vertices connected to the current vertex, and a residual motion field, which is the difference between the value of the predicted motion field and the value of the motion field of the current vertex, may be encoded. The value of the residual motion field may be encoded using entropy coding. Except for the motion field encoding in the inter frame encoding, the process of encoding the displacements and attribute map is the same as the structure of the intra frame encoding method except for the base mesh encoding.

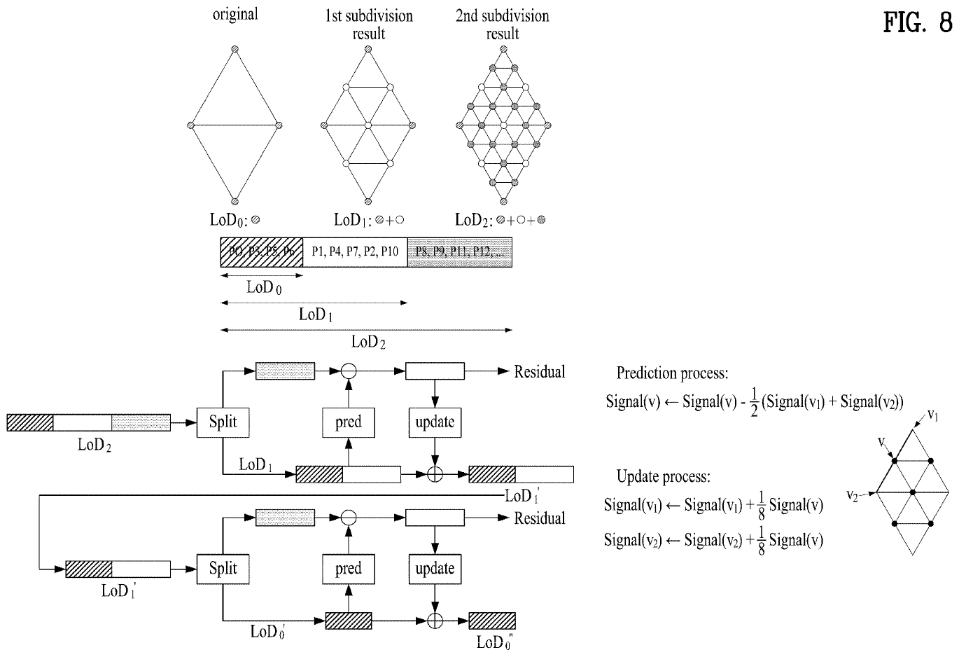

FIG. 8 illustrates a lifting transform process for displacements according to embodiments.

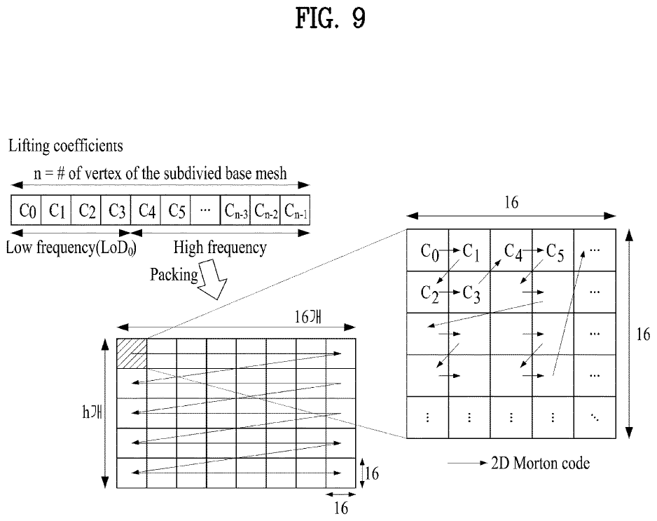

FIG. 9 illustrates a process of packing transform coefficients (also referred to as lifting coefficients) into a 2D image according to embodiments.

FIGS. 8 and 9 illustrate the process of transforming displacements and packing transform coefficients in the encoding process of FIGS. 6 and 7, respectively.

An encoding method according to the embodiments includes displacement encoding.

After base mesh encoding and/or motion field encoding, a reconstructed base mesh may be generated through reconstruction and inverse quantization, and a displacement may be calculated between a result of subdivision of the reconstructed base mesh and a fitted subdivided mesh generated through the fitting subdivision surface (see 415 in FIG. 6 or 515 in FIG. 7). A data transform process, such as a wavelet transform, may be applied to the displacement information for effective encoding (see 416 in FIG. 6, or 516 in FIG. 7).

FIG. 8 illustrates the process of transforming displacement information by the forward linear lifting unit 416 of FIG. 6 or the wavelet transformer 516 of FIG. 7 using the lifting transform. For example, a linear wavelet-based lifting transform may be performed. The transform coefficients generated through the transform process are quantized by the quantizer 417 (or 517) and then packed into a 2D image by the image packer 418 (or 518), as shown in FIG. 9. The transform coefficients may be organized into blocks, one block for every 256 (=16×16) units. Each block may be packed in a z-scan order. The number of rows in a block is fixed to 16, but the number of columns in the block may be determined by the number of vertices in the subdivided base mesh. Within a block, the transform coefficients may be sorted with the Morton code and packed. For the packed images, a displacement video may be generated per GoF. The displacement video may be encoded by the video encoder 419 (or 519) using a conventional video compression codec.

Referring to FIG. 8, the base mesh (original) may include vertices and edges for LoDO. A first subdivision mesh generated by splitting (or subdividing) the base mesh includes vertices generated by further splitting (or subdividing) the edges of the base mesh. The first subdivision mesh contains vertices for LoDO and vertices for LoD1. LoD1 includes subdivided vertices and vertices from the base mesh (LoDO). The first subdivision mesh may be split (or subdivided) to generate a second subdivision mesh. The second subdivision mesh contains LoD2. LoD2 includes a base mesh vertex (LoDO), LoD1 containing vertices further split (or subdivided) from LoDO, and LoD2 containing vertices further split (or subdivided) from LoD1. LoD is a level of detail that indicates how detailed the mesh data content is. As the index of the level increases, the distance between vertices is shortened, and the level of detail rises. In other words, as the value of LoD decreases, the detail of the mesh data content is degraded. As the value of LoD increases, the detail of the mesh data content is enhanced. LoD N contains the vertices contained in LoD N-1. In the case where the mesh (or vertex) is further split through subdivision, the mesh may be encoded based on a prediction and/or updating method, taking into account the previous vertices v1 and v2, and the subdivided vertex v. Instead of encoding the information for the current LoD N as it is, a residual with respect to previous LoD N-1 may be generated. Thus, the mesh may be encoded using the residual to reduce the size of the bitstream. The prediction process refers to the operation of predicting the current vertex v from the previous vertices v1 and v2. Since neighboring subdivision meshes have similar data, this property may be exploited for efficient encoding. The current vertex position information is predicted from the residual for the previous vertex position information, and the previous vertex position information is updated through the residual. In the present disclosure, vertex and point may be used interchangeably.

The LoDs may be defined in the subdivision of the base mesh. According to embodiments, the subdivision of the base mesh may be performed by the pre-processor 200 or may be performed by a separate component/module.

Referring to FIG. 9, a vertex has a transform coefficient (also referred to as a lifting coefficient) generated through lifting transform. The transform coefficient of the vertex related to the lifting transform may be packed into an image by the image packer 418 (or 518) and then encoded by the video encoder 419 (or 519).

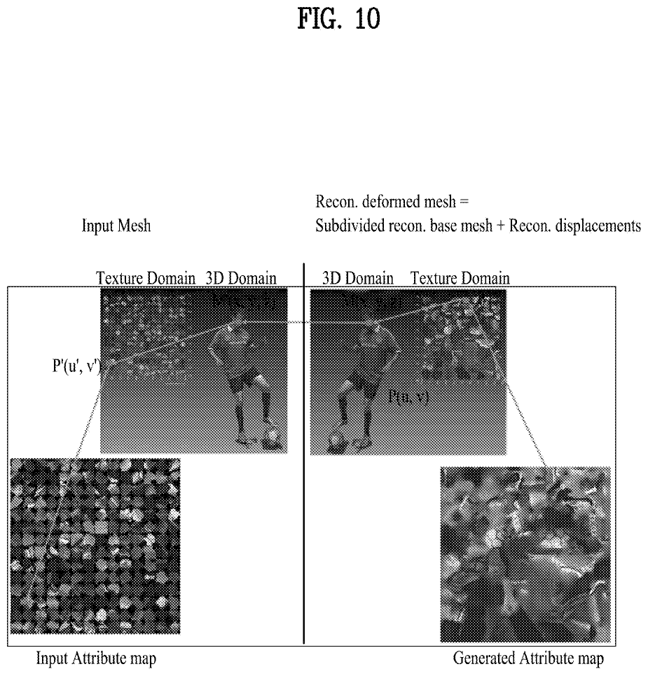

FIG. 10 illustrates an attribute transfer process in a V-MESH compression method according to embodiments.

According to embodiments, FIG. 10 illustrates a detailed operation of the attribute transfer 425 (or 525) in the encoding of FIGS. 6, 7, etc.

The encoding according to the embodiments includes attribute map encoding. According to embodiments, the attribute map encoding may be performed by the video encoder 428 of FIG. 6 or the video encoder 528 of FIG. 7.

According to embodiments, in the present disclosure, the encoder compresses information about the input mesh through base mesh encoding (i.e., intra-encoding), motion field encoding (i.e., inter-encoding), and displacement encoding. The input mesh compressed in the encoding process is reconstructed through base mesh decoding (intra frame), motion field decoding (inter frame), and displacement video decoding, and the reconstructed deformed mesh (hereinafter referred to as Recon. deformed mesh), which is the result of the reconstruction, is used to compress the input attribute map, as shown in FIGS. 6 and 7. The Recon. deformed mesh has position information about vertices, texture coordinates, and corresponding connectivity information, but does not have color information corresponding to the texture coordinates.

Therefore, as shown in FIG. 10, in the V-Mesh compression method, a new attribute map having color information corresponding to the texture coordinates of the recon. deformed mesh is regenerated through the attribute transfer process of the attribute transfer 425 (or 525).

According to embodiments, the attribute transfer 425 (or 525) first checks, for every point P(u, v) in the 2D texture domain, whether the corresponding vertex is within a texture triangle of the Recon. deformed mesh. When the corresponding vertex is in the texture triangle T, the attribute transfer calculates the barycentric coordinates (α, β, γ) of P(u, v) according to the triangle T. Then, it calculates the 3D coordinates M(x, y, z) of P(u, v) based on the 3D vertex positions of the triangle T and (α, β, γ). The vertex coordinates M′(x′, y′, z′) that corresponds to the closest position to the calculated M(x, y, z) and a triangle T′ containing this vertex are searched for in the input mesh domain. Then, the barycentric coordinates (α′, β′, γ′) of M′(x′, y′, z′) in the triangle T′ are calculated. The texture coordinates (u′, v′) are calculated based on the texture coordinates corresponding to the three vertices of triangle T′ and (α′, β′, γ′), and the color information corresponding to the coordinates are searched for in the input attribute map.

The color information found in this way is then assigned to the (u, v) pixel position in the new input attribute map. If P(u, v) does not belong to any triangle, the pixel at the position in the new input attribute map be filled with a color value using a padding algorithm, such as the push-pull algorithm of the push-pull padding 426 (or 526).

The new attribute map generated by the attribute transfer 425 (or 525) is bundled into GoFs to construct an attribute map video, which is compressed using a video codec of the video encoder 428 (or 528).

A reference relationship between the input mesh, the input attribute map, the reconstructed deformed mesh, and the reconstructed attribute map is shown may be seen from FIG. 10.

The decoding process of FIG. 1 may perform the reverse of the encoding process of FIG. 1. Specifically, the decoding process is performed as disclosed below.

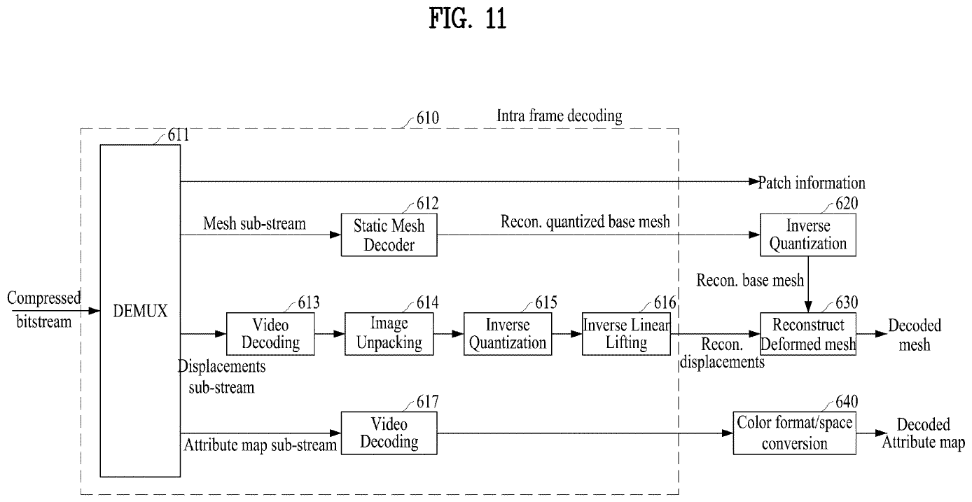

FIG. 11 shows the intra-frame decoding (or intra decoding) process of the V-Mesh technology according to embodiments.

FIG. 11 illustrates the configuration and operation of the mesh video decoder 113 of the reception apparatus of FIG. 1. Additionally, FIG. 11 illustrates that the mesh data may be reconstructed by performing a reverse process to the intra-frame encoding process of FIG. 6.

Each component for the intra-frame decoding process of FIG. 11 corresponds to hardware, software, and/or a combination thereof.

First, the bitstream (i.e., compressed bitstream) received and input to the demultiplexer 611 of the intra-frame decoder 610 may be separated into a mesh sub-stream, a displacement sub-stream, an attribute map sub-stream, and a sub-stream containing patch information about the mesh, such as V-PCC/V3C. The term V-PCC (Video-based Point Cloud Compression) used in the present disclosure may have the same meaning as V3C (Visual Volumetric Video-based Coding). The two terms may be used interchangeably. Accordingly, in the present disclosure, the term V-PCC may be interpreted as V3C.

According to embodiments, the mesh sub-stream may be input to and decoded by a static mesh decoder 612, the displacement sub-stream may be input to and decoded by the video decoder 613, and the attribute map sub-stream may be input to and decoded by the video decoder 617.

According to embodiments, the mesh sub-stream may be decoded through the decoder 612 of a static mesh codec used in the encoding such as, for example, Google Draco, to reconstruct connectivity information, vertex geometry information, vertex texture coordinates, and the like related to the result of the decoding, a recon. quantized base mesh, e.g., reconstructed base mesh.

According to embodiments, the displacement sub-stream may be decoded into a displacement video through the decoder 613 of the video compression codec used in the encoding. Then, image unpacking is performed by the image unpacker 614, inverse quantization is performed by the inverse quantizer 615, and inverse transform is performed by the inverse linear lifting unit 616 to reconstruct the displacement information about each vertex (i.e., Recon. displacements).

According to embodiments, the base mesh reconstructed by the static mesh decoder 612 is inversely quantized by the inverse quantizer 620 and output to the mesh reconstructor 630. The mesh reconstructor 630 reconstructs a reconstructed deformed mesh (i.e., a decoded mesh) based on the reconstructed displacements output from the inverse linear lifting unit 616 and the reconstructed base mesh output from the inverse quantizer 620. In other words, the inversely quantized reconstructed base mesh is combined with the reconstructed displacement information to generate a final decoded mesh. In the present disclosure, the final decoded mesh is referred to as a reconstructed deformed mesh.

According to embodiments, the attribute map sub-stream is decoded by the decoder 617 corresponding to the video compression codec used in the encoding, and then a final attribute map (i.e., a decoded attribute map) is reconstructed by the color transformer 640 through color format transform, color space conversion, and the like.

According to embodiments, the reconstructed decoded mesh and decoded attribute map may be utilized at the receiving side as final mesh data that may be utilized by a user.

Referring to FIG. 11, the received compressed bitstream includes patch information, a mesh sub-stream, a displacement sub-stream, and an attribute map sub-stream. The term sub-stream is interpreted as referring to a partial bitstream included in the bitstream. The bitstream contains patch information (data), mesh information (data), displacement information (data), and attribute map information (data).

As described above, the decoder of FIG. 11 performs intra-frame decoding as follows. The static mesh decoder 612 decodes the mesh sub-stream to generate a reconstructed quantized base mesh, and the inverse quantizer 620 applies the quantization parameters of the quantizer in reverse to generate a reconstructed base mesh. The video decoder 613 decodes the displacement sub-stream, the image unpacker 614 unpacks the image of the decoded displacement video, and the inverse quantizer 615 inversely quantizes the quantized image. The inverse linear lifting unit 616 applies a lifting transform in the reverse process of the encoder to generate a reconstructed displacement. The mesh reconstructor 630 generates a reconstructed deformed mesh based on the reconstructed base mesh and the reconstructed displacement. The video decoder 617 decodes the attribute map sub-stream, and the color transformer 640 transforms the color format and/or space of the decoded attribute map to generate a decoded attribute map.

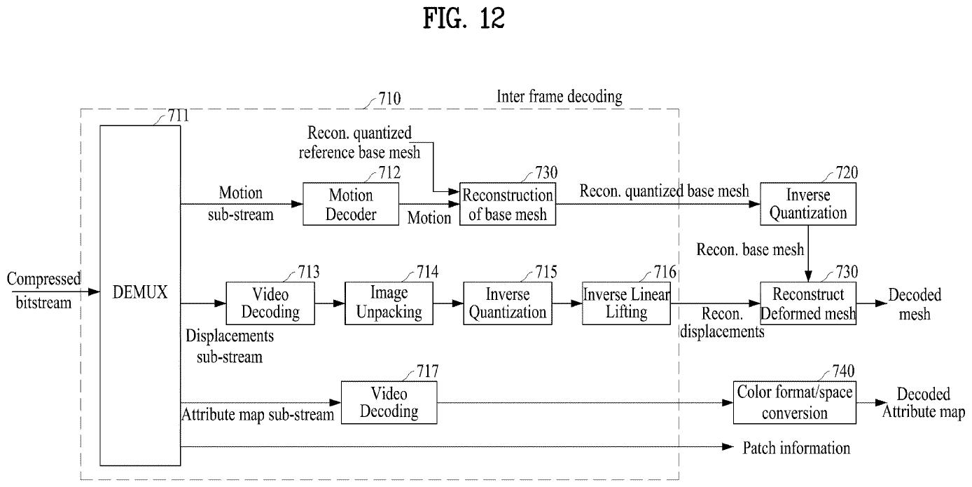

FIG. 12 illustrates an inter-frame decoding (or inter-decoding) process of V-Mesh technology.

FIG. 12 illustrates the configuration and operation of the mesh video decoder 113 of the reception apparatus of FIG. 1. In FIG. 12, mesh data may be reconstructed by performing a reverse process to the inter-frame encoding process of FIG. 7. Each component for the intra-frame decoding process of FIG. 12 corresponds to hardware, software, and/or a combination thereof.

First, the bitstream received and input to the demultiplexer 711 of the intra-frame decoder 710 may be separated into a motion sub-stream (also referred to as a motion vector sub-stream), a displacement sub-stream, an attribute map sub-stream, and a sub-stream containing patch information about the mesh, such as V3C/V-PCC.

According to embodiments, the motion sub-stream may be input to and decoded by the motion decoder 712, the displacement sub-stream may be input to and decoded by the video decoder 713, and the attribute map sub-stream may be input to and decoded by the video decoder 717.

According to embodiments, the motion sub-stream is decoded by the motion decoder 712 through entropy decoding and inverse prediction to reconstruct motion information (also referred to as motion vector information). The base mesh reconstructor 718 combines the reconstructed motion information with a pre-reconstructed and stored reference base mesh to generate a reconstructed quantized base mesh for the current frame. The inverse quantizer 720 applies inverse quantization to the reconstructed quantized base mesh to generate a reconstructed base mesh. The video decoder 713 decodes the displacement sub-stream, the image unpacker 714 unpacks the image of the decoded displacement video, and the inverse quantizer 715 inversely quantizes the quantized image. The inverse linear lifting unit 716 applies a lifting transform in the reverse process of the encoder to generate a reconstructed displacement. The mesh reconstructor 730 generates a reconstructed deformed mesh, i.e., a final decoded mesh, based on the reconstructed base mesh and the reconstructed displacement.

According to embodiments, the video decoder 717 decodes the attribute map sub-stream in the same way as the intra-decoding, and the color transformer 740 transforms the color format and/or space of the decoded attribute map to generate a decoded attribute map. The decoded mesh and decoded attribute map may be utilized at the receiving side as the final mesh data that may be utilized by the user.

Referring to FIG. 12, the bitstream contains motion information (also referred to as motion vectors), displacements, and an attribute map. The process of FIG. 12 further includes decoding the inter-frame motion information because inter-frame decoding is performed. A reconstructed base mesh is generated by decoding the motion information and generating a reconstructed quantized base mesh for the motion information based on the reference base mesh. For the operations in FIG. 12 that are the same as those in FIG. 11, refer to the description of FIG. 11.

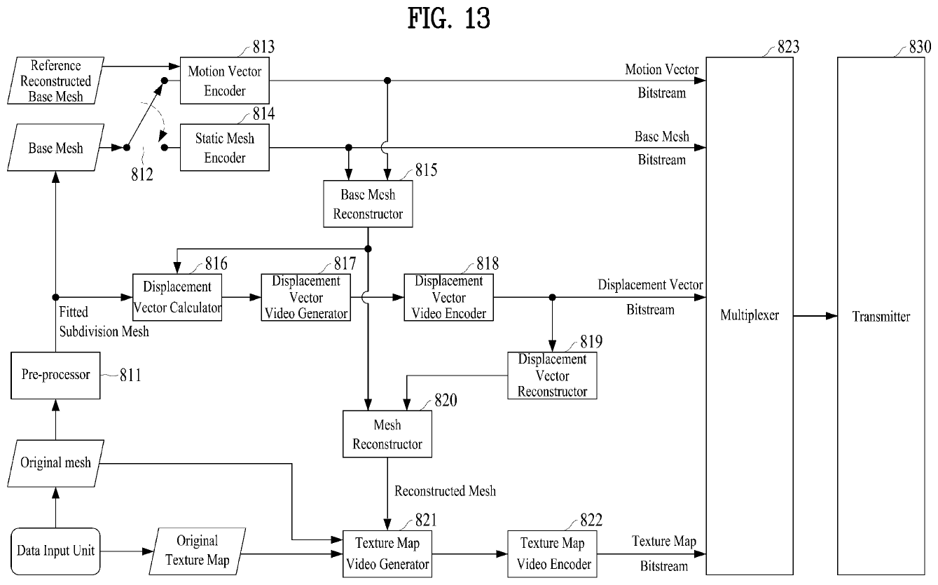

FIG. 13 illustrates a mesh data transmission apparatus according to embodiments.

FIG. 13 corresponds to the transmission apparatus 100 or mesh video encoder 102 of FIG. 1, the encoder (pre-processor and encoder) of FIGS. 2, 6, or 7, and/or the corresponding transmission encoding device. Each component of FIG. 13 corresponds to hardware, software, a processor, and/or a combination thereof.

The process of operations at the transmitting end for compressing and transmitting dynamic mesh data using a V-Mesh compression technique may be configured as shown in FIG. 13. The transmission apparatus of FIG. 13 may perform intra-frame encoding (also referred to as intra-encoding or intra-picture encoding) and/or inter-frame encoding (also referred to as inter-encoding or inter-picture encoding).

The pre-processor 811 receives the original mesh and generates a decimated mesh (or base mesh) and a fitted subdivided (or subdivision) mesh. The decimation may be performed based on a target number of vertices or a target number of polygons constituting the mesh.

Parameterization may be performed on the decimated mesh to generate texture coordinates and texture connectivity information per vertex. For example, the parameterization is a process of mapping a 3D curved surface into a texture domain for the decimated mesh. When the parameterization is performed using the UVAtlas tool, mapping information indicating where each vertex of the decimated mesh may be mapped to on the 2D image is generated. The mapping information is expressed and stored as texture coordinates, and the final base mesh is generated through this process. The mesh information may be quantized from a floating-point form to a fixed-point form. The result is the base mesh, which may be output to a motion vector encoder 813 or a static mesh encoder 814 through a switching unit 812. The pre-processor 811 may perform a mesh subdivision on the base mesh to generate additional vertices. Depending on the subdivision method, vertex connectivity information including the additional vertices, texture coordinates, and connectivity information about the texture coordinates may be generated. The pre-processor 811 may generate a fitted subdivided mesh by adjusting vertex positions such that the subdivided mesh becomes similar to the original mesh.

According to embodiments, when inter-frame encoding (inter-encoding) is performed on the mesh frame, the base mesh is output to the motion vector encoder 813 through the switching unit 812. When intra-frame encoding (intra-encoding) is performed on the mesh frame, the base mesh is output to the static mesh encoder 814 through the switching unit 812. The motion vector encoder 813 may be referred to as a motion encoder.

For example, when intra-encoding (intra-frame encoding) is performed on the mesh frame, the base mesh may be compressed through the static mesh encoder 814. In this case, the connectivity information, vertex geometry information, vertex texture information, normal information, and the like related to the base mesh may be encoded. The base mesh bitstream generated through the encoding is transmitted to the multiplexer 823.

As another example, when inter-encoding (inter-frame encoding) is performed on the mesh frame, the motion vector encoder 813 may receive as input a base mesh and a reference reconstructed base mesh (or a reconstructed quantized reference base mesh), compute a motion vector between the two meshes, and encode the value thereof. Further, the motion vector encoder 813 may perform connectivity information-based prediction using the previously encoded/decoded motion vector as a predictor, and encode a residual motion vector, which is obtained by subtracting the predicted motion vector from the current motion vector. The motion vector bitstream generated by the encoding is transmitted to the multiplexer 823.

The base mesh reconstructor 815 may receive the base mesh encoded by the static mesh encoder 814 or the motion vector encoded by the motion vector encoder 813, and may generate a reconstructed base mesh. For example, the base mesh reconstructor 815 may perform static mesh decoding on the base mesh encoded by the static mesh encoder 814 to reconstruct the base mesh. In this case, quantization may be applied before the static mesh decoding, and inverse quantization may be applied after the static mesh decoding. In another example, the base mesh reconstructor 815 may reconstruct the base mesh based on the reconstructed quantized reference base mesh and the motion vector encoded by the motion vector encoder 813. The reconstructed base mesh is output to the displacement calculator (or displacement vector calculator) 816 and the mesh reconstructor 820.

The displacement calculator 816 may perform mesh subdivision on the reconstructed base mesh. The displacement calculator 816 may calculate a displacement vector, which is the value of the difference in vertex positions between the subdivided reconstructed base mesh and the fitted subdivision (or subdivided) mesh generated by the pre-processor 811. In this case, displacement vectors as many as vertices in the subdivided mesh may be calculated. The displacement calculator 816 may transform the displacement vectors calculated in the 3D Cartesian coordinate system to a local coordinate system based on the normal vector of each vertex.

The displacement vector video generator 817 may include a linear lifting part, a quantizer, and an image packer. That is, in displacement vector video generator 817, the linear lifting unit may transform the displacement vectors for effective encoding. According to embodiments, the transform may be lifting transform, wavelet transform, or the like. In addition, the quantizer may perform quantization on the transformed displacement vector values, i.e., the transform coefficients. In this case, different quantization parameters may be applied to the axes of the transform coefficients, respectively. The quantization parameters may be derived by an agreement between the encoder/decoder. After transform and quantization, the displacement vector information may be packed into a 2D image by the image packer. The displacement vector video generator 817 may generate a displacement vector video by grouping the packed 2D images for each frame. A displacement vector video may be generated for each group of frames (GoF) of the input mesh.

The displacement vector video encoder 818 may encode the generated displacement vector video using a video compression codec. The generated displacement vector video bitstream is transmitted to the multiplexer 823.

The displacement vector reconstructor 819 may include a video decoder, an image unpacker, an inverse quantizer, and an inverse linear lifting part. That is, in the displacement vector reconstructor 819, the encoded displacement vector is decoded by the video decoder, image unpacking is performed by the image unpacker, inverse quantization is performed by the inverse quantizer, and inverse transform is performed by the inverse linear lifting unit to reconstruct displacement vectors. The reconstructed displacement vectors are output to the mesh reconstructor 820. The mesh reconstructor 820 reconstructs a deformed mesh based on the base mesh reconstructed by the base mesh reconstructor 815 and the displacement vectors reconstructed by the displacement vector reconstructor 819. The reconstructed mesh (also referred to as the reconstructed deformed mesh) has reconstructed vertices, inter-vertex connectivity information, texture coordinates, and inter-texture coordinate connectivity information.

The texture map video generator 821 may re-generate a texture map based on the texture map (or attribute map) of the original mesh and the reconstructed deformed mesh output from the mesh reconstructor 820. According to embodiments, the texture map video generator 821 may assign the vertex-by-vertex color information in the texture map of the original mesh to the texture coordinates of the reconstructed deformed mesh. According to embodiments, the texture map video generator 821 may generate a texture map video by grouping the frame-level regenerated texture maps into GoFs.

The generated texture map video may be encoded by the texture map video encoder 822 using a video compression codec. A texture map video bitstream generated through the encoding is transmitted to the multiplexer 823.

The multiplexer 823 multiplexes the motion vector bitstream (in the case of, for example, inter-encoding), the base mesh bitstream (in the case of, for example, intra-encoding), the displacement vector bitstream, and the texture map bitstream into a single bitstream. The single bitstream may be transmitted to the receiving side through the transmitter 824. Alternatively, for the motion vector bitstream, the base mesh bitstream, the displacement vector bitstream, and the texture map bitstream, a file with one or more track data may be generated or the bitstreams may be encapsulated into segments and transmitted to the receiving side through the transmitter 824.

Referring to FIG. 13, the transmitter (encoder) may encode the mesh in an intra-frame or inter-frame manner. According to intra-encoding, the transmission apparatus may generate a base mesh, displacement vectors (or displacements), and a texture map (or attribute map).

According to inter-encoding, the transmission apparatus may generate a motion vector (or motion), displacement vectors (or displacements), and a texture map (or attribute map). The texture map acquired from the data input unit is generated and encoded based on the reconstructed mesh. The displacements are generated and encoded based on the differences in vertex positions between the base mesh and the segmented (or subdivided) mesh. More specifically, the displacement is a difference in position between the fitted subdivided mesh and the subdivided reconstructed base mesh, i.e., the difference in vertex position between the two meshes. The base mesh is generated by decimating the original mesh through pre-processing and encoding the decimated mesh. For the motion, a motion vector is generated for the mesh in the current frame based on the reference base mesh in the previous frame.

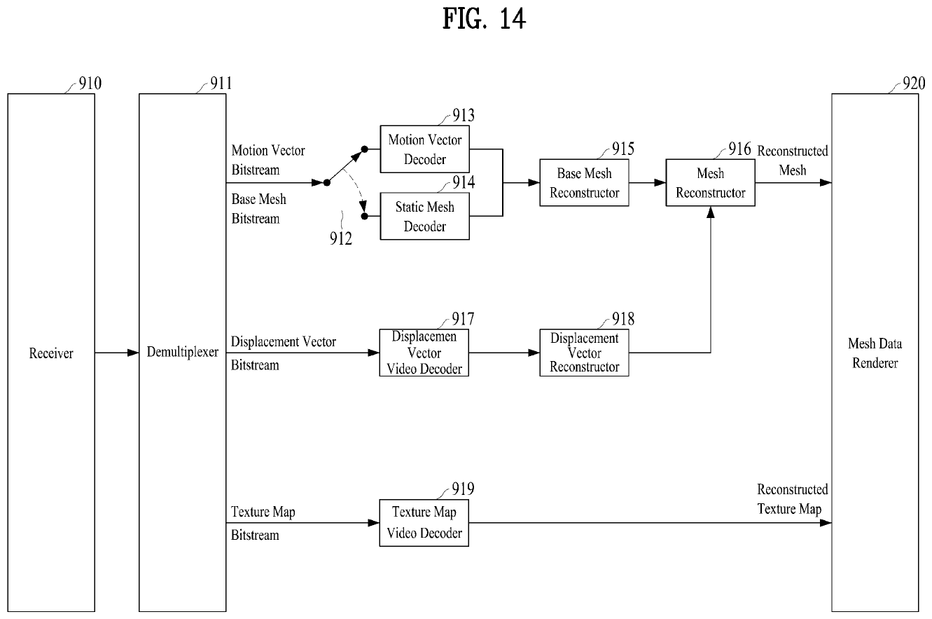

FIG. 14 illustrates a mesh data reception apparatus according to embodiments.

FIG. 14 corresponds to the reception apparatus 110 or mesh video decoder 113 of FIG. 1, the decoder of FIG. 11 or 12, and/or a corresponding reception decoding device. Each component of FIG. 14 corresponds to hardware, software, a processor, and/or a combination thereof. The reception (decoding) operation of FIG. 14 may follow a reverse process to the corresponding process of the transmission (encoding) operation of FIG. 13.

The bitstream of mesh data received by the receiver 910 is subjected to file/segment decapsulation and then demultiplexed by the demultiplexer 911 into a compressed motion vector bitstream (e.g., inter-decoding) or base mesh bitstream (e.g., intra-decoding), a displacement vector bitstream, and a texture map bitstream. For example, when the current mesh is inter-frame encoded (i.e., inter-encoded), the motion vector bitstream is received, demultiplexed, and then output to the motion vector decoder 913 through the switching unit 912. In another example, when the current mesh is intra-frame encoded (i.e., intra-encoded), the base mesh bitstream is received, demultiplexed, and output to the static mesh decoder 914 through the switching unit 912. Here, the motion vector decoder 913 may be referred to as a motion decoder.

According to embodiments, in the case where inter-frame encoding is applied to the current mesh based on the frame header information, the motion vector decoder 913 may decode the motion vector bitstream. According to embodiments, the motion vector decoder 913 may use the previously decoded motion vector as a predictor and add the same to the residual motion vector decoded from the bitstream to reconstruct the final motion vector.

According to embodiments, in the case where intra-frame encoding is applied to the current mesh based on the frame header information, the static mesh decoder 914 may decode the base mesh bitstream to reconstruct connectivity information, vertex geometry information, texture coordinates, normal information, and the like related to the base mesh.

According to embodiments, the base mesh reconstructor 915 may reconstruct the current base mesh based on the decoded motion vectors or the decoded base mesh. For example, in the case where inter-frame encoding is applied to the current mesh, the base mesh reconstructor 915 may add the decoded motion vectors to the reference base mesh and perform inverse quantization to generate a reconstructed base mesh. In another example, in the case where intra-frame encoding is applied to the current mesh, the base mesh reconstructor 915 may perform inverse quantization on the base mesh decoded by the static mesh decoder 914 to generate a reconstructed base mesh.

According to embodiments, the displacement vector video decoder 917 may decode the displacement vector bitstream as a video bitstream using a video codec.

According to embodiments, the displacement vector reconstructor 918 extracts displacement vector transform coefficients from the decoded displacement vector video, and applies inverse quantization and inverse transform to the extracted displacement vector transform coefficients to reconstruct displacement vectors. To this end, the displacement vector reconstructor 918 may include an image unpacker, an inverse quantizer, and an inverse linear lifting part. If the reconstructed displacement vectors are values in a local coordinate system, inverse transform to the Cartesian coordinate system may be performed.

The mesh reconstructor 916 may subdivide the reconstructed base mesh to generate additional vertices. Through the subdivision, vertex connectivity information including the additional vertices, texture coordinates, and connectivity information about the texture coordinates may be generated. In this case, the mesh reconstructor 916 may combine the subdivided reconstructed base mesh with the reconstructed displacement vectors to generate a final reconstructed mesh (also referred to as a reconstructed deformed mesh).

According to embodiments, the texture map video decoder 919 may decode the texture map bitstream as a video bitstream using a video codec to reconstruct a texture map. The reconstructed texture map has color information about each vertex in the reconstructed mesh, and the texture coordinates of each vertex may be used to obtain the color value of the vertex from the texture map.

According to embodiments, the mesh reconstructed from the mesh reconstructor 916 and the texture map reconstructed from the texture map video decoder 919 are presented to the user through a rendering process in the mesh data renderer 920.

Referring to FIG. 14, the reception apparatus (decoder) may decode the mesh in an intra-frame or inter-frame manner. According to intra-decoding, the reception apparatus may receive a base mesh, displacement vectors (or displacements), and a texture map (or attribute map), and render mesh data based on the reconstructed mesh and reconstructed texture map. According to inter-decoding, the reception apparatus may receive a motion vector (or motion), the displacement vectors (or displacements), a texture map (or attribute map), and render mesh data based on the reconstructed mesh and the reconstructed texture map.

A mesh data transmission apparatus and method according to embodiments may pre-process mesh data, encode the pre-processed mesh data, and transmit a bitstream containing the encoded mesh data. A point mesh data reception apparatus and method according to embodiments may receive a bitstream containing mesh data and decode the mesh data. The mesh data transmission/reception method/apparatus according to embodiments may be referred to as a method/apparatus according to embodiments. The mesh data transmission/reception method/apparatus may also be referred to as a 3D data transmission/reception method/apparatus or point cloud data transmission/reception method/apparatus.

As described above, in the V-Mesh method, the displacement information generated during the encoding process is converted into a video, which is then compressed using an existing 2D video codec. In addition, the texture map (equivalent to an attribute map) of the input mesh data is also processed into a video, which is compressed using an existing 2D video codec. In this case, the V-DMC encoder/decoder may perform inter-frame prediction and/or intra-frame prediction during encoding and/or decoding. Here, inter-frame prediction is referred to as inter prediction, and intra-frame prediction is referred to as intra prediction. When inter-frame prediction is performed by the V-DMC encoder/decoder, currently inter prediction is performed only for the base mesh, while inter prediction is skipped for displacement information (also referred to as displacements) and texture maps. For example, in the case of inter prediction for the base mesh, prediction is performed using the base mesh of a reference frame and motion vectors. In contrast, for the displacement information and texture maps, encoding/decoding is performed using intra prediction, that is, an intra coding method.

However, applying inter prediction only to the base mesh in performing inter prediction may be a less efficient approach. Accordingly, in order to achieve more efficient compression, and in particular to improve efficiency in inter-frame prediction, the present disclosure proposes a method of skipping coding of a current texture map when the similarity between a reference texture map and the current texture map is high. In addition, when texture map coding skip is applied only on a frame basis, there may be cases where most regions are similar but some regions are different, resulting in failure to skip texture map coding. To enable efficient compression through skipping of texture map coding even in such cases, the present disclosure proposes a method of texture map skipping in units such as submesh, patch, and tile.

As described above, when the similarity between a reference texture map and a current texture map of a dynamic mesh is high, the present disclosure allows coding of current texture map to be skipped. In this case, the unit forming the basis of skipping texture map coding may be a frame, a submesh, a patch, a tile, or the like. In other words, in the present disclosure, by skipping texture maps, which account for a significantly large proportion of V-DMC bitstream data, the number of bits for texture maps to be transmitted and encoding/decoding complexity may be reduced. In other words, according to the present disclosure, by improving the compression efficiency of the texture maps, which account for the largest portion of bits among the main components of V-DMC data, namely the base mesh, displacement vectors, and texture maps, the overall compression efficiency of the V-DMC codec the present disclosure may be improved.

Furthermore, in order to apply the texture map coding skip method in a V-DMC codec, the present disclosure proposes a high level syntax signaling method based on an atlas stream. In particular, the present disclosure proposes a method of applying the texture map skipping method on a frame, submesh, patch, or tile basis in the V-DMC codec, as well as a signaling method, syntax, and semantics based on the atlas stream. According to embodiments, a flag indicating whether the texture map skipping method is used and a flag indicating the presence of skipped texture maps within a sequence may be signaled through an atlas sequence parameter set (ASPS). In addition, in the present disclosure, a flag indicating whether texture map skipping is applied on a frame basis and reference information for deriving skipped texture maps may be signaled at atlas-stream-based syntax transmission positions (such as atlas frame parameter set, tile header, patch data unit, and NAL unit header).

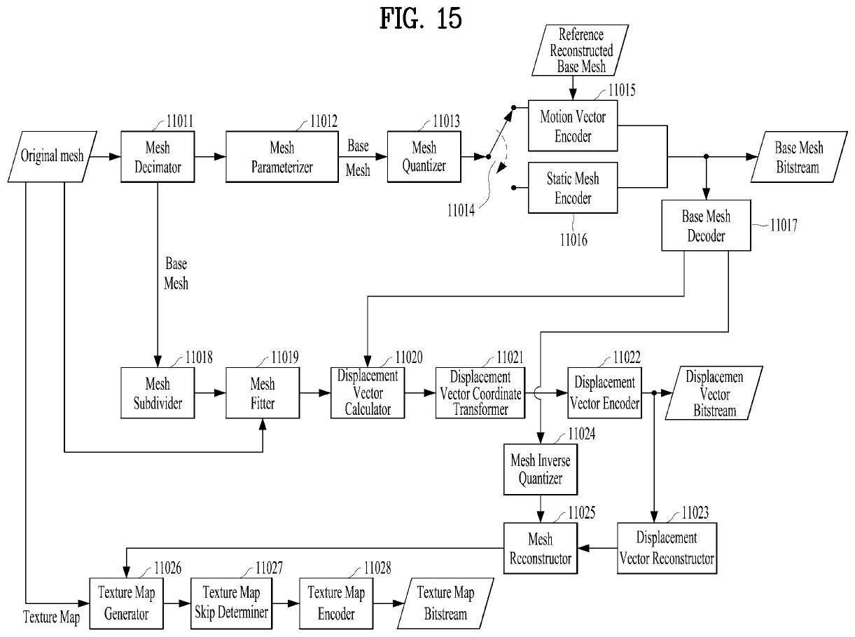

FIG. 15 illustrates a transmission apparatus according to the embodiments. The transmission apparatus of FIG. 15 may be referred to as a mesh data transmission apparatus, an encoder, an encoder of a transmission apparatus, a V-Mesh encoder, or a dynamic mesh encoder.

FIG. 15 corresponds to the transmission device 100 or mesh video encoder 102 of FIG. 1, the encoder (pre-processor and encoder) of FIGS. 2, 6, or 7, the transmission apparatus of FIG. 13, and/or the corresponding transmission encoding apparatus. Each component of FIG. 15 corresponds to hardware, software, a processor, and/or a combination thereof. In FIG. 15, the order in which the blocks are executed may be changed. Some blocks may be omitted, and some blocks may be newly added.

In the present disclosure, the transmitting operation process for compression and transmission of dynamic mesh data using the V-Mesh compression technique may be performed as illustrated in FIG. 15. The transmission apparatus of FIG. 15 may support both an intra-frame encoding (or intra encoding or intra-screen encoding) process and/or an inter-frame encoding (or inter encoding or inter-screen encoding) process.

In FIG. 15, the mesh decimator 11011 simplifies the input original mesh using a mesh simplification algorithm to generate a base mesh (also referred to as a simplified base mesh or simplified mesh). The mesh simplification may be performed based on the number of target vertices or the number of target polygons constituting the mesh. For example, decimation or the like may be used as a mesh simplification algorithm for simplifying the original mesh.

Specifically, the decimation may be a process of selecting vertices to be removed from the original mesh based on a certain reference point, and then removing the selected vertices and triangles connected to the selected vertices.

In other words, the mesh decimator 11011 may simplify the input mesh to a target number of vertices or a target number of faces. The simplification may be performed using various methods, such as triangle collapse and edge collapse.

According to embodiments, the base mesh simplified by the mesh decimator 11011 is provided to the mesh parameterizer 11012 and the mesh subdivider 11018.

The mesh parameterizer 11012 performs an operation of mapping a 3D surface to a texture domain for the decimated mesh. That is, the mesh parameterizer 11012 generates texture coordinate information and texture connectivity information related to the input mesh. In one embodiment, the mesh parameterizer 11012 may perform parameterization using a UV Atlas tool. In this operation, mapping information indicating a position to which each vertex of the decimated mesh may be mapped to in the 2D image is generated. The mapping information is expressed and stored as texture coordinates, and the final base mesh is generated through this operation. In other words, the mesh parameterizer 11012 performs parameterization to generate texture coordinates (UV coordinates) and texture connectivity information per vertex of the input mesh (i.e., the decimated mesh or decimated base mesh).

The final base mesh (also referred to as a base mesh with a texture map) generated by the parameterizer 11012 is input to the mesh quantizer 11013 to be quantized.

According to embodiments, the mesh quantizer 11013 may quantize the mesh information (e.g., geometry information (x, y, z) and/or texture coordinates (u, v), normal information (nx, ny, nz), etc.) in floating point form to fixed-point form. That is, the mesh quantizer 11013 may quantize the vertex coordinates and texture coordinates of the base mesh.

In some embodiments, quantization of a specific component may be skipped.

The mesh subdivider 11018 subdivides the base mesh obtained through decimation by the mesh decimator 11011. The mesh subdivider 11018 may perform mesh subdivision on the base mesh to generate additional vertices. Depending on the subdivision method, vertex connectivity information including the additional vertices, texture coordinates, and connectivity information about the texture coordinates may be generated. In this case, the geometry information connectivity information, texture coordinate connectivity information, and texture coordinates may be generated through implicit derivation depending on the subdivision method. According to embodiments, the mesh subdivider 11018 may perform the subdivision using a method such as mid-edge, Loop, or Catmul& Clark.

In addition, the mesh subdivider 11018 may perform mesh subdivision n times according to a user parameter or an agreement between the encoder and the decoder. According to embodiments, when the vertex of the base mesh is defined as R₀, the vertices newly generated by performing subdivision once are defined as R₁, . . . , and the vertices generated by performing subdivision n times are defined as Rₙ, LODₙmay be defined as follows.

LoDₙ=R₀∪R₁∪, . . . , ∪Rₙ

According to embodiments, the mesh fitter 11019 may generate a fitted subdivided mesh by performing fitting by adjusting vertex positions such that the mesh subdivided by the mesh subdivider 11018 becomes similar to the original mesh. That is, the mesh fitter 11019 performs vertex position adjustment to ensure that the subdivided mesh becomes similar to the original mesh. According to embodiments, the mesh decimator 11011, the mesh parameterizer 11012, the mesh subdivider 11018, and the mesh fitter 11019 may be omitted. When the corresponding operations are skipped, the original mesh may be provided as an input to the mesh quantizer 11013.

In this case, coordinate information related to the original mesh may be provided as an input to a displacement vector calculator 11020. According to embodiments, the displacement vector encoding process (i.e., the displacement vector calculator 11020, the displacement vector coordinate transformer 11021, and the displacement vector encoder 11022) may be omitted.

In the present disclosure, the combination of the mesh decimator 11011, the mesh parameterizer 11012, the mesh subdivider 11018, and the mesh fitter 11019 may be referred to as a pre-processor. According to embodiments, the pre-processor may further include a displacement vector calculator 11020.

According to embodiments, the base mesh quantized by the mesh quantizer 11013 may be output to a motion vector encoder 11015 or a static mesh encoder 11016 through a switching part 11014.

According to embodiments, when inter-frame encoding (inter encoding) is performed on the mesh frame, the base mesh is output to the motion vector encoder 11015 through the switching part 11014. When intra-frame encoding (intra encoding) is performed on the mesh frame, the base mesh is output to the static mesh encoder 11016 through the switching part 11014. The motion vector encoder 11015 may be referred to as a motion encoder.

In one example, when intra encoding (intra-frame encoding) is performed on the mesh frame, the base mesh may be compressed by the static mesh encoder 11016. In this case, the connectivity information, vertex geometry information, vertex texture information, normal information, and the like related to the base mesh may be encoded. That is, vertex coordinates, vertex connectivity information, texture coordinates, texture connectivity information, and the like related to the mesh may be encoded by the static mesh encoder 11016. The base mesh bitstream generated through the encoding is transmitted to the multiplexer (not shown).

In another example, when inter encoding (inter-frame encoding) is performed on the mesh frame, the motion vector encoder 11015 may receive a base mesh and a reference reconstructed base mesh (or a reconstructed quantized reference base mesh) as input, calculate a motion vector between the two meshes, and encode the value thereof. Further, the motion vector encoder 11015 may perform connectivity information-based prediction using the previously encoded/decoded motion vector as a predictor, and perform entropy encoding on a motion vector difference (also referred to as a residual motion vector), which is obtained by subtracting the predicted motion vector from the current motion vector. The motion vector bitstream generated through the encoding is transmitted as the base mesh bitstream to the multiplexer (not shown). That is, in the case of intra-frame encoding, the static mesh bitstream is input to the multiplexer as the base mesh bitstream.

In FIG. 15, the base mesh decoder (also referred to as a base mesh rescontructor) 11017 may receive the base mesh encoded by the static mesh encoder 11016 or the motion vectors encoded by the motion vector encoder 11015, and generate a reconstructed base mesh. The base mesh decoder 11017 reconstructs the base mesh based on the encoding type of the current mesh (inter-frame encoding or intra-frame encoding). For example, the base mesh decoder 11017 may reconstruct the base mesh by performing static mesh decoding on the base mesh encoded by the static mesh encoder 11016. In this case, quantization may be applied before the static mesh decoding, and inverse quantization may be applied after the static mesh decoding. In other words, when intra-frame encoding is performed, inverse quantization may be performed on the base mesh quantized by the mesh quantizer 11013 to reconstruct the current base mesh. As another example, the base mesh decoder 11017 may reconstruct the base mesh based on the reconstructed quantized reference base mesh and the motion vectors encoded by the motion vector encoder 11015. In other words, when inter-frame encoding is performed, motion vectors may be decoded using a motion vector decoding method, and then the decoded motion vectors may be applied (i.e., added) to the reference reconstructed base mesh to generate the current base mesh. In the case where the motion vectors have not been quantized, the motion vector reconstruction process may be skipped, and the motion vectors calculated by the motion vector encoder 11015 may be used to reconstruct the current base mesh. The reconstructed base mesh is output to the displacement vector calculator 11020 and the mesh inverse quantizer 11024.

According to embodiments, the displacement vector calculator 11020 may perform mesh subdivision on the reconstructed base mesh. Further, the displacement vector calculator 11020 may calculate a displacement vector, which is the value of the difference in vertex position between the subdivided reconstructed base mesh and the fitted subdivision (or subdivided) mesh generated by the mesh fitter 11019. In this case, the displacement vectors may be calculated as many times as the number of vertices in the subdivided mesh. In other words, the displacement vectors corresponding to the number of vertices in the subdivided mesh may be calculated by the displacement vector calculator 11020.

According to embodiments, the displacement vector coordinate transformer 11021 may output vertex displacement vectors calculated in a 3D Cartesian coordinate system (i.e., (x, y, z) space) (also referred to as a canonical coordinate system), as they are, or may transform the same into a local coordinate system (i.e., normal, tangential, and bi-tangential coordinates) based on a normal vector of each vertex. In this case, the normal vector may be calculated for each subdivided vertex based on geometry information and connectivity information related to neighboring vertices. According to embodiments, only the normal component among the normal, tangential, and bi-tangential components of the local coordinate system may be encoded.

Depending on an agreement between the encoder and the decoder, encoding may always be performed only on the normal component when coordinate transformation is applied, or the encoder may determine and signal a 1-bit flag. In this case, the normal vector may be calculated for each subdivided vertex based on geometry information and/or connectivity information related to neighboring vertices.

Further, whether the displacement vector coordinate transform is performed by the displacement vector coordinate transformer 11021 may be determined by an agreement between the encoder (i.e., the transmission apparatus)/the decoder (i.e., the reception apparatus), or may be determined by signaling a coordinate transform flag (e.g., asps_vmc_ext_displacement_coordinate_system) on a per-sequence, group-of-frames (GOF), frame, or submesh basis. As an example, the displacement vector coordinate transform flag asps_vmc_ext_displacement_coordinate_system, which is information for identifying whether displacement vector coordinate transform is performed, may be signaled in signaling information (e.g., an Atlas Sequence Parameter Set (ASPS)) and transmitted to the reception apparatus. For example, when the value of the syntax element (also referred to as a field) asps_vmc_ext_displacement_coordinate_system is 0, it may indicate that the canonical coordinate system is used. When the value of the element is 1, it may indicate that transformation to the local coordinate system has been performed.

According to embodiments, displacement vectors in the Cartesian coordinate system or displacement vectors transformed into the local coordinate system by the displacement vector coordinate transformer 11021 are encoded into a displacement vector bitstream (also referred to as a displacement vector video bitstream) by the displacement vector encoder 11022. In one embodiment, the displacement vector encoder 11022 may encode the displacement vectors in the Cartesian coordinate system or the displacement vectors transformed into the local coordinate system into a displacement vector bitstream using a 2D video encoder such as H.264, HEVC, or VVC.

In other words, the displacement vector encoder 11022 may encode displacement vectors or displacement vector coefficients (also referred to as displacement vector transform coefficients). In the present disclosure, the displacement vector encoder 11022 may perform encoding using a video codec-based encoder, a zero run-length encoder, an arithmetic encoder, or the like. For example, when the encoding method is video codec-based encoding, the displacement vector encoder 11022 may pack displacement vectors or displacement vector coefficients into a frame for encoding. That is, the displacement vector coefficients may be packed into a 2D image and then encoded using a 2D video codec (i.e., a video compression codec), or may be encoded using zero run-length encoding or arithmetic encoding to generate a displacement vector video bitstream.

According to embodiments, the displacement vector video bitstream encoded and generated by the displacement vector encoder 11022 is transmitted to a multiplexer (not shown). According to embodiments, regarding the method of selecting encoding by the displacement vector encoder 11022, a displacement vector encoder agreed upon between the encoder (i.e., the transmitting side) and the decoder (i.e., the receiving side) may be used. Alternatively, the encoder on the transmitting side may analyze the characteristics of the displacement vector and transmit the type of the selected displacement vector encoder to the decoder on the receiving side.

According to embodiments, the displacement vector reconstruction unit 11023 may reconstruct displacement vectors by performing an inverse process of displacement vector encoding on displacement vectors or displacement vector coefficients encoded by the displacement vector encoder 11022. That is, depending on the encoding method, for example, for example, when video codec-based encoding is used, the displacement vector reconstructor 11023 may perform inverse packing (also referred to as unpacking) of displacement vectors.

More specifically, the displacement vector reconstructor 11023 may decode, using a 2D video decoder, a bitstream into which a 2D image/video is packed and which is encoded by a 2D video encoder, and perform inverse packing. Then, inverse quantization and inverse transform may be performed on the unpacked quantized transform coefficients to calculate reconstructed displacement vectors. That is, the displacement vector reconstructor 11023 may additionally perform inverse quantization and inverse transform depending on whether quantization and transform has been performed during displacement vector encoding.

According to embodiments, the mesh inverse quantizer 11024 may inverse-quantize vertex coordinates or texture coordinates of the reconstructed base mesh through an inverse process of quantization. When the quantization is skipped by the mesh quantizer 11013, the inverse quantization may also be skipped by the mesh inverse quantizer 11024.

According to embodiments, the mesh reconstruction unit 11025 may reconstruct a mesh based on the reconstructed displacement vectors output from the displacement vector reconstructor 11023 and the reconstructed base mesh (or inverse-quantized reconstructed base mesh) output from the mesh inverse quantizer 11024. More specifically, the mesh reconstructor 11025 may subdivide the reconstructed base mesh output from the mesh inverse quantizer 11024 and add the reconstructed displacement vectors from the displacement vector reconstructor 11023 to generate a reconstructed deformed mesh. According to embodiments, the mesh reconstructed by the mesh reconstructor 11025 (also referred to as a reconstructed mesh or reconstructed deformed mesh) may include reconstructed vertices, connectivity between vertices, texture coordinates, and connectivity between texture coordinates. The reconstructed mesh (also referred to as reconstructed deformed mesh) generated by the mesh reconstructor 11025 is provided to the texture map generator 11026.

According to embodiments, the texture map generator 11026 may regenerate a texture map of the current mesh based on the texture map (also referred to as an attribute map) of the original mesh, and the reconstructed mesh from the mesh reconstructor 11025. That is, the texture map generator 11026 may generate the texture map of the reconstructed mesh based on the texture map of the original mesh and the relationship between the original mesh and the reconstructed mesh. In other words, the texture map generator 11026 generates the texture map of the reconstructed mesh based on the texture coordinates and connectivity information related to the reconstructed mesh and the relationship between the original mesh and the texture map of the original mesh.

According to embodiments, the texture map generator 11026 may assign per-vertex color information contained in the texture map of the original mesh to the texture coordinates of the reconstructed base mesh (or reconstructed deformed mesh). According to embodiments, the texture map generator 11026 may group regenerated texture maps on a per-GoF basis to generate a texture map (also referred to as a texture map video).

According to embodiments, the texture map skip determiner 11027 determines whether to skip encoding of the current texture map. In one embodiment of the present disclosure, when similarity between a reference texture map and the current texture map is high, encoding of the current texture map may be skipped. Here, skipping the encoding of the current texture map includes skipping encoding of the current texture map as well as skipping transmission of the current texture map to the reception apparatus. A method of determining whether to skip encoding of the current texture map will be described in detail later.

A texture map determined not to be skipped by the texture map skip determiner 11027 may be encoded by the texture map encoder 11028. For example, the texture map encoder 11028 may encode the texture map using a 2D video codec-based encoder, a zero run-length encoder, or an entropy coding-based arithmetic encoder. In addition, the texture map encoder 11028 may further perform color space transformation of the texture map. A texture map substream (or texture map video bitstream) generated through texture map encoding is transmitted to a multiplexer (not shown).

According to embodiments, types of the texture map encoder 11028 may include a video encoder (e.g., VVC, HEVC, etc.) and an entropy-coding-based encoder. Regarding the method of selecting the texture map encoder 11028, a texture map encoder agreed upon between the encoder (i.e., the transmitting side)/the decoder (i.e., the receiving side) may be used.

Alternatively, information on the type of the texture map encoder selected by the encoder on the transmitting side may be transmitted to the decoder on the receiving side.

According to embodiments, the multiplexer (not shown) may multiplex the input base mesh bitstream, displacement vector bitstream, and texture map bitstream into a single bitstream to be transmitted to the reception apparatus. Alternatively, the base mesh bitstream, displacement vector bitstream, and texture map bitstream may be encapsulated into files/segments to be transmitted to the reception apparatus.

According to embodiments, the bitstream multiplexed by the multiplexer may be transmitted over a network or stored in a digital storage medium. Here, the network may include a broadcast network and/or a communication network, and the digital storage medium may include various storage media such as USB, SD, CD, DVD, Blu-ray, HDD, and SSD.

Next, a method of determining, by the texture map skip determiner 11027, whether texture map coding is skipped and a method of signaling related information will be described.

According to embodiments, the texture map skip determiner 11027 may determine whether to skip coding of the texture map generated by the texture map generator 11026 through the following processes.

According to embodiments, whether encoding/decoding of the texture map is to be skipped by the texture map skipping determiner 11027 may be determined by explicitly signaling a texture map skip flag (texture_skip_flag), or may be implicitly derived according to conditions defined in the same manner by the encoder/the decoder.

In addition, in the present disclosure, a flag asve_textureSkip_enable_flag indicating whether a texture map skipping technique (i.e., method) is used in the V-DMC codec may be signaled through an Atlas Sequence Parameter Set (ASPS), thereby transmitting to the reception apparatus information on whether the texture map skipping method is applied to the corresponding content or sequence. In the present disclosure, the signaling may be performed by the texture map skip determiner 11027 or by a separate block or module such as a signaling processor (not shown).

For example, when the value of asve_textureSkip_enable_flag is 1, a parameter related to texture map skipping may be parsed. In this case, if there is a skipped texture map within the corresponding sequence, asve_textureSkip_present_flag may be signaled as 1. Otherwise, the flag may be signaled as 0.

According to embodiments, criteria for determining, by the texture map skip determiner 11027, whether a texture map is skipped may include similarity between a current texture map and a reference texture map, an estimated number of generated bits, and a distance between the current texture map and the reference texture map.

Further, the unit of skipping of texture information (i.e., texture map) may be a frame, a patch, a submesh, a tile, or a slice. That is, depending on the unit of skipping of the texture map determined by the texture map skip determiner 11027, such as a frame, patch, slice, submesh, or tile, the texture map skip flag (texture_skip_flag) indicating whether to skip the texture map may be determined.

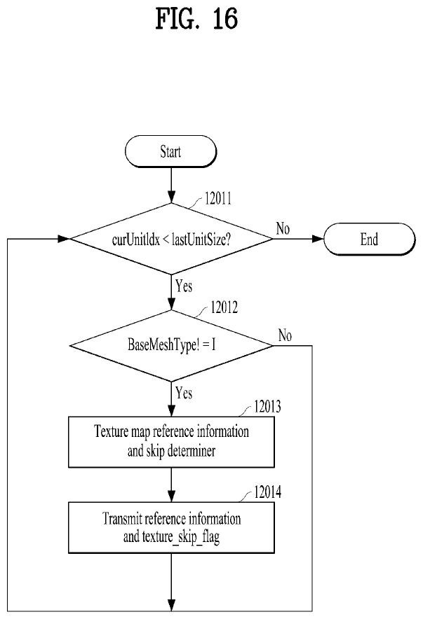

FIG. 16 is a flowchart illustrating an example of a method of determining whether texture map coding is skipped according to embodiments. That is, FIG. 16 illustrates an example of a method of determining, by the texture map skip determiner 11027, whether texture map coding is skipped. In the method, some operations may be skipped or some operations may be added.

According to embodiments, when it is determined in operation 12011 that curUnitIdx is less than lastUnitSize, the procedure proceeds to operation 12012 to determine whether texture map coding is skipped. Otherwise, the procedure of determining whether texture map coding is skipped is terminated. That is, the comparison between curUnitIdx and lastUnitSize in operation 12011 is intended to determine whether texture map coding is skipped on a group of frames (GoF) basis. For example, when a GoF includes 30 frames, curUnitIdx may be an index that increases from 0, 1, 2, . . . , to 29, and lastUnitSize may indicate the number of frames in the GoF, that is, 30. In other words, this is an example of determining whether texture map coding is skipped on a frame-by-frame basis within a GoF.

When it is determined in operation 12011 that curUnitIdx is less than lastUnitSize, it is checked whether the base mesh type is I (operation 12012). When the base mesh type is I, the procedure for determining whether to skip the texture map of the current frame is not performed (namely, texture map coding is not skipped). Otherwise (for example, when the base mesh type is P or skip), the procedure proceeds to operation 12013 to determine whether texture map coding is skipped for the current frame. Operation 12013 may be referred to as a texture map reference information and skip determiner. Although the present disclosure describes that texture map coding is not skipped when the base mesh type is I, this is merely one embodiment. That is, even when the base mesh type is I, texture map coding may be skipped.

According to embodiments, in the present disclosure, the texture map skip flag (texture_skip_flag) may be transmitted only when the type of the current mesh or base mesh is a type for inter-frame prediction. When the type of the current mesh is a type for intra-frame prediction, transmission of the texture_skip_flag may be skipped, and the texture_skip_flag may be implicitly derived as 0.

According to embodiments, when the type of the current mesh is a mesh type for inter-frame prediction, texture map reference information and texture map skip information may be determined through the texture map reference information and skip determiner (i.e., operation 12013).

According to embodiments, when the current mesh satisfies the condition for flag transmission, whether texture map coding is skipped may be determined by comparing various metrics based on the current texture map and the reference texture map.

According to embodiments, when a difference between a PSNR calculated based on the current texture map and a PSNR calculated based on the reference texture map is less than a threshold THPSNR, the texture map reference information and skip determiner (i.e., operation 12013) may determine that the texture map skip flag is 1 (i.e., texture_skip_flag=1), and skip encoding of the current texture map. In other words, the difference between the PSNR of the current texture map and the PSNR of the reference texture map being less than THPSNR indicates that similarity between the current texture map and the reference texture map is high. This means that the current texture map is sufficiently similar to the reference texture map and thus it is unnecessary to encode the current texture map.

Herein, the PSNR may include point cloud-based luminance and/or chrominance PSNR between the original mesh and a mesh constructed through the current or reference texture map and reconstructed geometry information.

In addition, the texture map reference information and skip determiner (i.e., operation 12013) may determine whether texture map coding is skipped by measuring a weighted PSNR by assigning weights to units such as submeshes or tiles or to specific regions.

Next, a unit of skipping of texture map coding is described.

According to embodiments, texture map skip information may be signaled and determined on a per-frame, per-patch, per-submesh, per-tile, or per-slice basis, or may be implicitly derived by the encoder/decoder based on the same rule.

According to embodiments, the texture map skip flag (texture_skip_flag) determined on a per-frame, per-patch, per-submesh, per-tile, or per-slice basis may be transmitted to the reception apparatus for all encoding/decoding types, or may be transmitted to the reception apparatus only for specific types.

For example, when skipping of the texture map coding is determined on a per-frame basis, a frame-level texture map skip flag (afps_vdmc_texture_skip_flag) may be transmitted. That is, the frame-level texture map skip flag (afps_vdmc_texture_skip_flag) may be a flag indicating whether a texture map is skipped on a per-frame basis.

For example, when whether to skip the texture map coding is determined on a per-patch basis, a patch-level texture map skip flag (atdu_vdmc_texture_skip_flag) may be transmitted.

That is, the patch-level texture map skip flag (atdu_vdmc_texture_skip_flag) may be a flag indicating whether a texture map is skipped on a per-patch basis.

For example, when whether to skip the texture map coding is determined on a per-submesh basis, a submesh-level texture map skip flag (smh_vdmc_texture_skip_flag) may be transmitted. That is, the submesh-level texture map skip flag (smh_vdmc_texture_skip_flag) may be a flag indicating whether a texture map is skipped on a per-submesh basis.

For example, when whether to skip the texture map coding is determined on a per-tile basis, a tile-level texture map skip flag (ath_vdmc_texture_skip_flag) may be transmitted. That is, the tile-level texture map skip flag (ath_vdmc_texture_skip_flag) may be a flag indicating whether to skip the texture map on a per-tile basis.

According to embodiments, the texture map reference information and skip determiner (i.e., operation 12013) may determine information about a referenced texture map used to generate the skipped texture map as follows.

According to embodiments, information about the referenced texture map may be an index of the reference texture map, a reference texture map list, or reference rule information. In the present disclosure, information about the referenced texture map may be used interchangeably with reference texture map information.

According to embodiments, the reference texture map information may be determined by explicitly signaling the same reference texture map information by the encoder/decoder and/or whether to skip the map may be implicitly derived based on conditions defined in the same manner by the encoder/decoder.

When the reference texture map information (also referred to as reference information) is explicitly signaled, a flag indicating reference texture direction information (such as past or future) may be determined.

According to embodiments, after selecting a direction of the reference texture map, information about the direction of the referenced texture map may be transmitted to the decoder (i.e., the reception apparatus). Alternatively, the same direction may be implicitly derived by the encoder/decoder.

In this case, the direction of the texture map to be referenced may be toward a previous texture map with respect to the current texture map index (when the index is less than the current texture map index), or toward a subsequent texture map (when the index is greater than the current texture map index) on the time axis.

According to embodiments, when a Picture Order Count (POC) gap between the reference texture map in the previous texture map direction and the current texture map is greater than a specific threshold, whether to reference a reference texture map in the subsequent texture map direction may be preferentially determined, and then reference texture direction information may be signaled. Alternatively, when the POC gap is greater than the specific threshold, whether to reference a future texture map may be determined and reference texture direction information may be implicitly derived according to the same rule between the encoder/decoder.

According to embodiments, when a unit such as a frame, submesh, tile, slice, or patch is of a P type, previous texture maps may be used as reference texture maps. When it is of a B type, previous texture maps or future texture maps may be selected.

According to embodiments, after performing comparison using texture maps in both directions, a direction of a texture map to be referenced may be selected, and information about the direction may be determined by explicit signaling or may be implicitly derived by the encoder/decoder based on the same conditions.

According to embodiments, when the information about the referenced texture map is an index of the referenced texture map, the similarity between the current texture map and reference texture maps may be measured to determine a texture map having high similarity as the reference texture map, or the reference texture map index may be determined, considering the texture map order.

According to embodiments, when the information about the referenced texture map is referenced rule information, a texture map located at a constant interval among texture maps in a forward encoding order may be used as the reference texture map, and information about the specific interval may be determined by explicit signaling, or reference information may be implicitly derived by the encoder/decoder using the same interval.

According to embodiments, the encoder/decoder may determine whether a texture is skipped based on the same maximum texture map distance parameter (max_skip_texturemap_distance), and the maximum texture map distance parameter (max_skip_texturemap_distance) may be transmitted to the decoder (i.e., the reception apparatus). Alternatively, whether a texture map is skipped may be implicitly derived by the decoder as the encoder/decoder uses the same maximum texture map distance parameter.

In the present disclosure, the maximum texture map distance parameter (max_skip_texturemap_distance) may be a parameter for deriving whether a texture map is skipped.

According to embodiments, when coding of an N-th texture map is skipped, and all texture maps located within a maximum distance from the skipped texture map on the time axis are consecutively skipped, the texture skip flag (texture_skip_flag) for the (N+max_skip_texturemap_distance)-th texture map may be determined to be 0.

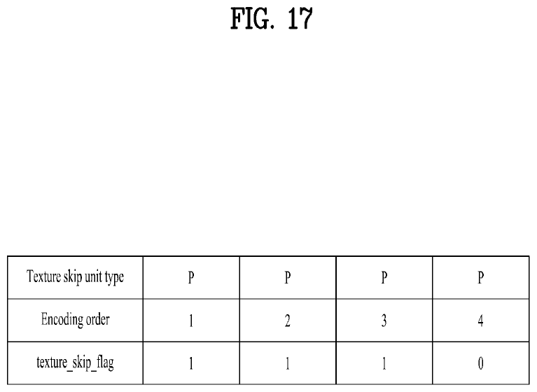

FIG. 17 illustrates an example of determining whether a texture map is skipped using a maximum texture map distance parameter according to embodiments. FIG. 17 illustrates an embodiment of determining a texture skip flag when the value of the maximum texture map distance parameter (max_skip_texturemap_distance) is 3.

Referring to FIG. 17 as an example, when the first, second, and third texture maps in the encoding order are skipped, the fourth texture map, which is a texture map located after the maximum texture map distance parameter interval from the first skipped texture map on the time axis, may not be skipped, and the texture skip flag (texture_skip_flag) may be determined to be 0. In this case, the texture skip flag (texture_skip_flag) may not be separately transmitted.

For example, when whether a texture map is skipped is determined on a per-submesh basis, texture maps of submeshes that satisfy the condition for skipping the texture map may be skipped on a frame-by-frame basis. When the determination is performed per GOP (or GOF), i.e., two or more frames, texture maps of submeshes that satisfy the texture map skipping condition may be skipped if the total number of submeshes per frame is the same within the group and the texture maps of the submeshes have the same height and same width.

In addition, as a method of skipping the texture map of a submesh, a skipped texture map region may be filled with a specific value according to embodiments.

Further, when texture maps are skipped on a per-submesh basis, a flag (smh_texture_skip_flag) indicating whether a texture map is skipped on a per-submesh basis may be signaled, or may be derived by the encoder/decoder according to the same rule.

When a flag (afps_vdmc_texture_skip_flag) indicating whether a texture map is skipped on a per-frame basis is 0, whether a texture map is skipped may be determined on a per-submesh basis through afps_vdmc_sm_skip_enable_flag.

For example, when afps_vdmc_sm_skip_enable_flag is 0, a submesh-level texture skip flag (smh_texture_skip_flag) for the corresponding frame may be derived as 0 and may not be signaled.

For example, when afps_vdmc_sm_skip_enable_flag is 1, index information (e.g., refDirection_idx) indicating the direction of a reference texture map and index information (e.g., ref_texture_idx) indicating the index of the reference texture map may be signaled.

When texture map coding is skipped on a per-submesh basis, texture maps referenced by the skipped texture maps of submeshes within the same frame may reference submesh texture maps of different frame indices.

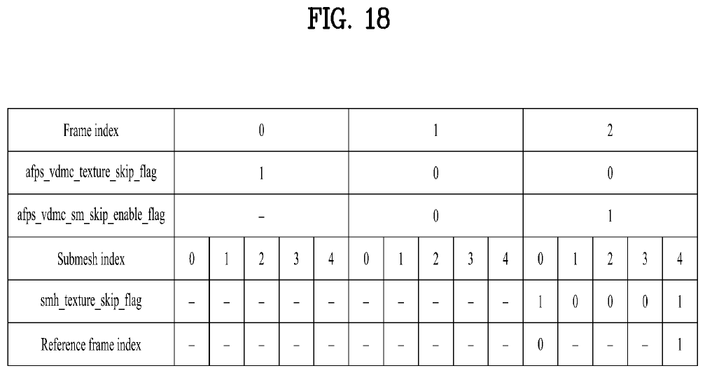

FIG. 18 illustrates an example of a texture map skip status and a reference frame index signaled on a per-submesh basis according to embodiments. In particular, FIG. 18 illustrates an example in which texture maps referenced have different frame indices on a submesh basis.

More specifically, FIG. 18 illustrates an example in which each frame includes five submeshes, and for a texture map having a frame index of 2, texture maps of submeshes with submesh indices 0 and 4 are respectively skipped (i.e., smh_texture_skip_flag for submesh indices 0 and 4 is 1). In this case, a texture map referenced by the submesh with index 0 may have a frame index of 0, and a texture map referenced by the submesh with index 4 may have a frame index of 1, such that texture maps of different frames may be referenced.

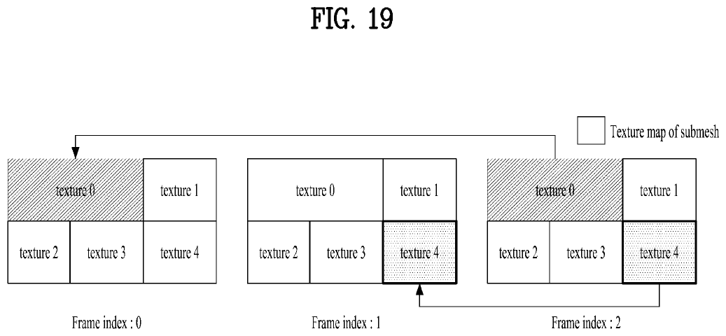

FIG. 19 is a diagram illustrating an example of a relationship between frames of referenced texture maps when texture map coding is skipped on a per-submesh basis according to embodiments. FIG. 19 is a visualization example of FIG. 18. Accordingly, as in FIG. 18, coding of texture maps of submeshes corresponding to submesh indices 0 and 4 among the submeshes included in the frame with index 2 is skipped.

That is, among the five submeshes included in the frame with frame index 2, the texture map referenced by the texture map (texture 0) of the submesh corresponding to submesh index 0 is the texture map (texture 0) of the submesh index 0 in the frame with frame index 0, and the texture map referenced by the texture map (texture 4) of the submesh corresponding to submesh index 4 is the texture map (texture 4) of the submesh index 4 in the frame with frame index 1. In other words, once a reference frame is determined, the texture map of the submesh at the same position within the reference frame is referenced.

As described above, when the texture map skip determiner 11027 determines whether texture map coding is to be performed and the signaling thereof among the texture maps generated by the texture map generator 11026, the texture map encoder 11028 skips encoding of texture maps for which texture_skip_flag is 1. That is, encoding and transmission of texture maps for which texture_skip_flag is 1 are skipped.

Then, texture maps for which texture_skip_flag is 0 may be encoded by the texture map encoder 11028 through a 2D video encoder or the like.

According to embodiments, when the color space of a texture map to be encoded is RGB 4:4:4, encoding may be performed after converting the color space to a color space such as YUV 4:2:0, YUV 4:4:4, YUV 4:0:0, or YCgCo.

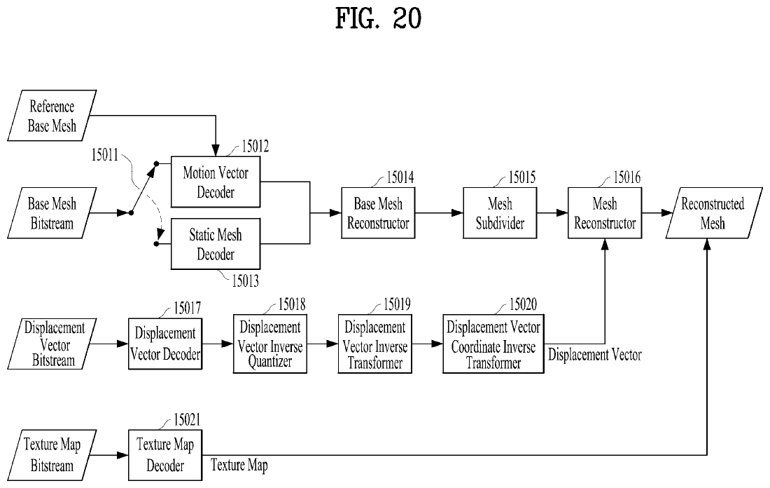

FIG. 20 illustrates a reception apparatus according to embodiments. In the present disclosure, the reception apparatus of FIG. 20 may be referred to as a mesh data reception apparatus, a decoder, a decoder of a reception apparatus, a V-Mesh decoder, or a dynamic mesh decoder.

FIG. 20 corresponds to the reception apparatus 110 or the mesh video decoder 113 of FIG. 1, the decoder of FIG. 11 or 12, the reception apparatus of FIG. 14, and/or a corresponding reception decoding apparatus. Each component of FIG. 20 corresponds to hardware, software, a processor, and/or a combination thereof. The reception (decoding) operation of FIG. 20 may follow the reverse process of the corresponding transmission (encoding) operation of FIG. 15. In FIG. 20, the execution order of blocks may be changed, some blocks may be omitted, and some blocks may be newly added.

FIG. 20 may largely include a base mesh decoder, a displacement information decoder, and a texture map decoder. According to embodiments, the base mesh decoder may include a switching unit 15011, a motion vector decoder 15012, a static mesh decoder 15013, a base mesh reconstructor 15014, a mesh subdivider 15015, and a mesh reconstructor 15016. According to embodiments, the displacement information decoder may include a displacement vector decoder 15017, a displacement vector inverse quantizer 15018, a displacement vector inverse transformer 15019, and a displacement vector coordinate inverse transformer 15020.

According to embodiments, the bitstream of the mesh data received by the receiver (not shown) may be subjected to file/segment decapsulation, and may then be demultiplexed into a base mesh bitstream, a displacement vector bitstream, and a texture map bitstream by a demultiplexer (not shown). In the case where inter-frame encoding (i.e., inter encoding) has been applied to the current mesh, the base mesh bitstream may be a motion vector bitstream.

According to embodiments, the base mesh bitstream may be provided to the motion vector decoder 15012 or the static mesh decoder 15013 via the switching part 15011.

For example, in the case where inter-frame encoding (i.e., inter encoding) has been applied to the current mesh, the base mesh bitstream, i.e., the motion vector bitstream, is received, demultiplexed, and then output to the motion vector decoder 15012 via the switching part 15011. In another example, in the case where intra-frame encoding (i.e., intra encoding) has been applied to the current mesh, the base mesh bitstream is received, demultiplexed, and then output to the static mesh decoder 15013 via the switching part 15011. Here, the motion vector decoder 15012 may be referred to as a motion decoder.

According to embodiments, the motion vector decoder 15012 may decode the motion vector bitstream on a per-vertex or per-subgroup basis.

According to embodiments, the motion vector decoder 15012 may reconstruct the final motion vector by adding the decoded motion vector difference (i.e., the residual motion vector) from the bitstream to the previously decoded motion vector used as a predictor. That is, the motion vector decoder 15012 may decode motion vector differences (or residual motion vectors) at the vertex or subgroup (or sub-block) level from the motion vector bitstream, perform prediction based on connectivity information using previously decoded motion vectors as predictors, and add the residual motion vectors to the predicted information to decode the motion vectors.

According to embodiments, the static mesh decoder 15013 may decode the base mesh bitstream to restore connectivity information, vertex geometry information, texture coordinates (i.e., attribute geometry information), normal information, and the like related to the base mesh.

According to embodiments, the base mesh reconstructor 15014 may reconstruct the current base mesh based on the decoded motion vectors or decoded base mesh. For example, in the case where inter-frame encoding has been applied to the current mesh, the base mesh reconstructor 15014 may add the decoded (or reconstructed) motion vectors to the reference base mesh and perform inverse quantization to generate the reconstructed base mesh (i.e., the current base mesh). In another example, in the case where intra-frame encoding has been applied to the current mesh, the base mesh reconstructor 15014 may perform inverse quantization on the decoded (or reconstructed) base mesh output by the static mesh decoder 15013 to generate the reconstructed base mesh (i.e., the current base mesh).

According to embodiments, the mesh subdivider 15015 may subdivide the base mesh to generate additional vertices. Depending on the subdivision method, the geometry connectivity information, texture coordinate connectivity information, and texture coordinates may be implicitly derived to generate vertices.

According to embodiments, the mesh subdivider 15015 may perform subdivision using methods such as mid-edge, Loop, and Catmul& Clark.

According to embodiments, the mesh subdivider 15015 may perform mesh subdivision n times according to a user parameter or an agreement between the encoder and the decoder.

According to embodiments, when the vertex of the base mesh is defined as R₀, the vertices newly generated by performing subdivision once are defined as R₁, . . . , and the vertices generated by performing subdivision n times are defined as Rₙ, LODₙ may be defined as follows.

LoDₙ=Rₒ∪R₁∪, . . . , ∪Rₙ

According to embodiments, the displacement vector decoder 15017 may perform video-codec-based decoding on a demultiplexed displacement vector bitstream as a video bitstream, or may perform zero run-length decoding, or arithmetic decoding. In the present disclosure, the displacement vector decoder may be used interchangeably with a displacement vector transform decoder with the same meaning.

According to embodiments, the displacement vector decoder 15017 may decode displacement vectors by performing a reverse process of the displacement vector encoding method at the transmitting side to reconstruct the displacement vectors.

According to embodiments, the displacement-vector-coefficient inverse quantizer 15018 may inverse-quantize the displacement vector coefficients reconstructed by the displacement vector decoder 15017. According to embodiments, the displacement vector transform coefficients may be quantized using different quantization parameters for each axis. In this case, the displacement-vector-coefficient inverse quantizer 15018 may derive a quantization parameter or a scaling parameter based on an encoder/decoder agreement to determine a quantization rate for each LoD level.

According to embodiments, the displacement vector inverse transformer 15019 may perform an inverse transform, corresponding to the transform performed by the encoder of the transmission apparatus, on the inverse-quantized displacement vector coefficients and output displacement vectors. According to embodiments, an inverse lifting transform, an inverse wavelet transform, or the like may be performed.

When the inverse lifting transform is performed, the vertex Rk at the k-th subdivision level may be predicted as follows. Displacement vector prediction at the k-th subdivision level may be performed using a subdivision-vertex displacement vector of Rt as a predictor (where t<k or t<=k).

According to embodiments, in performing displacement vector prediction, an average or a distance-based weighted average prediction may be performed using n nearest vertices among vertices having a lower subdivision level than the current vertex, based on connectivity information.

According to embodiments, prediction may be performed based on displacement vectors of n vertices used to generate the current vertex in the mesh subdivision operation.

In addition, when the inverse lifting transform is performed, a process of updating displacement vectors of vertices used for prediction by the encoder may be performed using a parsed residual signal.

According to embodiments, the displacement-vector coordinate inverse transformer 15020 may parse a coordinate system transform flag (asps_vmc_ext_displacement_coordinate_system or applyLocalCoord) included in signaling information on a per-sequence, per-GOF, per-frame, or per-submesh basis. When the value of the flag is 1, the inverse transformer may inversely transform the inverse-quantized (or inverse-transformed) reconstructed displacement vectors from a local coordinate system (n, t, b) to a canonical coordinate system (x, y, z).

Further, a normal vector per vertex may be calculated based on reconstructed vertex position information related to the reconstructed base mesh. For vertices additionally generated through the subdivision operation, normal values of the newly generated vertices may be assigned by performing interpolation based on the calculated normal vectors of vertices of the reconstructed base mesh.

In this case, interpolation may be performed by calculating an average or a distance-based weighted sum of the normal information related to the base mesh used for subdivision.

Alternatively, for subdivided vertices on the same plane, the normal information related to the base mesh may be used.

Then, tangential and bi-tangential vectors orthogonal to the normal vector may be calculated based on the calculated per-vertex normal vectors, and inverse transformation of the displacement vector coordinate system may be performed using Equation 1 below. In Equation 1 below, dispn[0], dispn[1], and dispn[2] represent the results of the normal, tangential, and bi-tangential components obtained by performing inverse transformation and inverse quantization. In this case, based on the property that the normal, tangential, and bi-tangential components are mutually orthogonal, the displacement vector of the bi-tangential component may be calculated through a cross product of the final displacement vectors of the normal component and the tangential component. Alternatively, the displacement vector of the bi-tangential component may be derived and calculated using a method such as Linear Regression or Multiple Regression.

[Equation 1]

\vec{disp_{xyz}}=dispₙ[0]*\vec{n}+dispₙ[1]*\vec{t}+dispₙ[2]*\vec{b}

According to embodiments, coordinate system inverse transform may always be performed without transmitting a flag.

The output of the displacement vector coordinate inverse transformer 15020 is provided to the mesh reconstructor 15016.

That is, the encoder of the transmission apparatus may transform vertex displacement vectors calculated in the (x, y, z) space into a (normal, tangential, bi-tangential) coordinate system (also referred to as a local coordinate system) based on a normal vector of each vertex. In this case, the normal vector may be calculated for each subdivided vertex based on geometry information and connectivity information related to neighboring vertices.

According to embodiments, the mesh reconstructor 15016 reconstructs a mesh based on the mesh subdivided by the mesh subdivider 15015 and the reconstructed displacement vectors output from the displacement vector coordinate inverse transformer 15020.

According to embodiments, a received and demultiplexed texture map bitstream is input to a texture map decoder 15021. According to embodiments, the texture map decoder 15021 may decode texture maps using a video codec (e.g., a 2D scalable decoder). That is, the texture map decoder 15021 may reconstruct texture maps by applying 2D scalable decoding to the texture maps. In addition, the texture map decoder 15021 may generate texture maps skipped at the transmitting side based on the received reference texture map information included in signaling information.

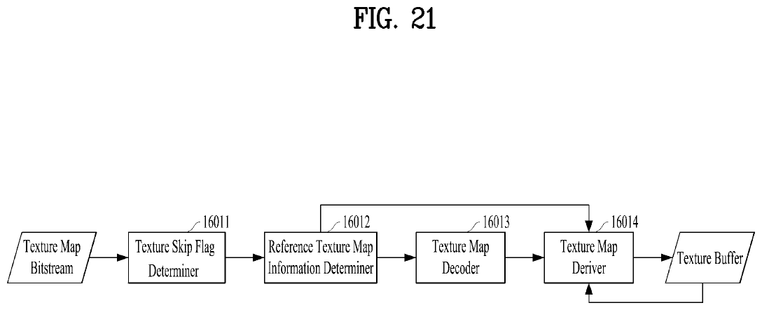

FIG. 21 is an example detailed block diagram of a texture map decoder according to embodiments.

In FIG. 21, the texture map decoder 15021 may include a texture map skip flag determiner 16011, a reference texture map information determiner 16012, a texture map decoder 16013, and a texture map deriver 16014. Each component in FIG. 21 corresponds to hardware, software, a processor, and/or a combination thereof. In FIG. 21, the execution order of the blocks may be changed, some blocks may be omitted, and some blocks may be newly added.

According to embodiments, the texture map decoder 15021 may parse asve_textureSkip_enable_flag signaled and received in an atlas sequence parameter set (ASPS). When the value of the flag is 1, it may be determined that a texture map skipping method (or technique) is applied to the corresponding content or sequence, and a parameter related to texture map skipping may be parsed.

According to embodiments, the texture map decoder 15021 may parse asve_textureSkip_present_flag signaled and received in the ASPS to determine whether there is a skipped texture map in the current sequence. When the value of asve_textureSkip_present_flag is 1, it may be determined that there is a skipped texture map and that a reconstruction process needs to be performed.

In FIG. 21, the texture map skip flag determiner 16011 may determine, by parsing, a 1-bit flag texture_skip_flag indicating whether textures (also referred to as a texture map) for each unit determined by the encoder are skipped.

According to embodiments, the texture map decoding and the texture map skipping may be performed on a per-frame basis, a per-patch basis, a per-submesh basis, a per-tile basis, or a per-slice basis.

In FIG. 21, the reference texture map information determiner 16012 determines reference texture map information for texture maps determined to be skipped by the encoder of the transmission apparatus (that is, texture maps whose coding and transmission are skipped). In this case, the reference structure may be determined explicitly or implicitly.

In the case where the reference structure is explicitly determined by parsing, reference information may be determined through a 1-bit flag indicating the direction of a reference texture (past or future), and a flag or index indicating a picture order count (POC) difference between the current texture map and the reference texture map.

According to embodiments, a flag or index indicating the direction of the reference texture may be parsed from signaling information as information indicating whether the reference texture map is a past texture map or a future texture map with respect to the current texture map, and/or information indicating whether texture maps in both directions are used may be parsed from the signaling information.

According to embodiments, when the current mesh is a P-type mesh for which unidirectional prediction is performed, the flag indicating the direction of the reference texture may be omitted.

According to embodiments, when texture map skipping is performed by always referencing a texture map having the smallest POC difference from the current texture map according to an agreement between the encoder and the decoder, the flag or index indicating the POC difference may be omitted.

According to embodiments, when the POC gap between the reference texture map in the previous texture map direction and the current texture map is greater than a specific threshold, reference texture direction information may be implicitly derived as a future direction according to the same rule between the encoder and the decoder.

According to embodiments, when the frame type of the current mesh is an I-type mesh that does not reference a mesh of a temporally different frame, texture map skipping is not performed, and thus the texture map skip flag determiner 16011, the reference texture map information determiner 16012, and the texture map deriver 16014 may be omitted, and the texture map skip flag (texture_skip_flag) may be derived to be 0 According to embodiments, the texture map decoder 16013 may reconstruct texture maps by decoding a received texture map bitstream as a video bitstream using a video codec (e.g., a 2D scalable decoder). In this case, since texture maps skipped at the transmitting side are not contained in the received texture map bitstream, they are not reconstructed by the texture map decoder 16013.

Texture maps not reconstructed by the texture map decoder 16013, that is, texture maps not transmitted because coding has been skipped at the transmitting side, are generated by the texture map deriver 16014 based on a reference texture map and/or signaling information.

That is, for texture maps for which texture_skip_flag is 1, the operation of generating a current texture map based on a reference texture map may be performed by the texture map deriver 16014.

In this case, when a single texture map is referenced, the reference texture map may be used as the current texture map according to reference information (also referred to as reference texture map information, or information about a referenced texture map). That is, a single reference texture map is derived as the current texture map skipped by the texture map encoder of the transmission apparatus.

In deriving the current texture map by referencing multiple texture maps, the current texture map may be derived by averaging the multiple texture maps or by performing a distance (POC)-based weighted summation of the multiple texture maps.

In the present disclosure, flags according to the unit of texture map skipping may include afps_vdmc_texture_skip_flag, atdu_texture_skip_flag, smh_texture_skip_flag, and ath_texture_skip_flag.

afps_vdmc_texture_skip_flag may be a flag indicating whether a texture map is skipped (namely, whether texture map coding is skipped) on a per-frame basis.

atdu_texture_skip_flag may be a flag indicating whether a texture map is skipped on a per-patch basis.

smh_texture_skip_flag may be a flag indicating whether a texture map is skipped on a per-submesh basis.

ath_texture_skip_flag may be a flag indicating whether a texture map is skipped on a per-tile basis.

The texture map skip flag determiner 16011, the reference texture map information determiner 16012, and the texture map deriver 16014 included in the texture map decoder 15021 of FIG. 21 are described in detail below.

### Texture Map Skip Flag Determiner 16011

The encoder/the decoder may derive whether a texture map is skipped using the same maximum texture map distance parameter (max_skip_texturemap_distance).

The maximum texture map distance parameter (max_skip_texturemap_distance) is a parameter for deriving whether a texture map is skipped. By omitting the texture map skip flag (texture_skip_flag), bits to be signaled may be saved.

According to embodiments, when an N-th texture map is skipped, and all texture maps located within a maximum inter-frame distance with respect to the skipped texture map on the time axis are skipped, the texture skip flag (texture_skip_flag) for the (N+max_skip_texturemap_distance)-th texture map may be determined to be 0.

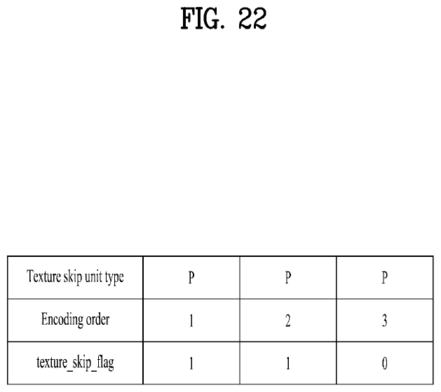

FIG. 22 illustrates an example of deriving a texture map skip flag as 0 according to embodiments. That is, FIG. 22 illustrates an embodiment in which the texture map skip flag is derived as 0 according to the maximum texture map distance parameter. For example, when the maximum texture map distance parameter (max_skip_texturemap_distance) is set to 2, and the first and second texture maps in encoding order are skipped, the flag texture_skip_flag for the third texture map may be derived as 0 by the maximum texture map distance parameter (max_skip_texturemap_distance).

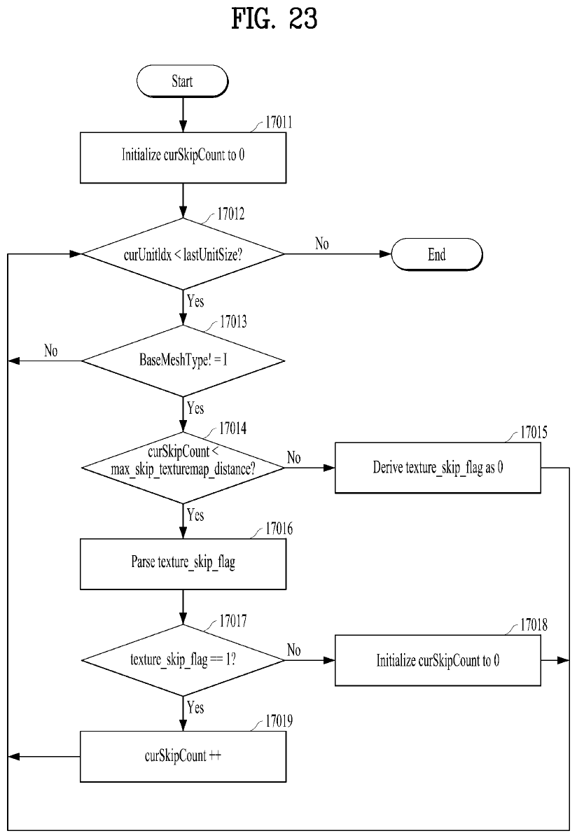

FIG. 23 is a flowchart illustrating an example of deriving a texture map skip flag by a texture map skip flag determiner according to embodiments. That is, FIG. 23 illustrates an embodiment in which whether a texture map is skipped is implicitly derived by the maximum texture map distance parameter (max_skip_texturemap_distance), and specific operations (or steps) may be added or skipped.

First, the number of consecutively skipped texture maps, curSkipCount, is initialized to 0 (operation 17011).

Then, it is checked whether curUintIdx is less than lastUnitSize (operation 17012). When it is determined that curUnitIdx is less than lastUnitSize, the procedure proceeds to operation 17013 to determine the texture map skip flag. Otherwise, the procedure of determining the texture map skip flag is terminated. That is, the comparison between curUnitIdx and lastUnitSize in operation 17012 is intended to determine the texture map skip flag on a per-GoF basis. For example, when a GoF includes 30 frames, curUnitIdx may be an index that increases from 0, 1, 2, . . . , to 29, and lastUnitSize may indicate the number of frames in the GoF, that is, 30.

When it is determined in operation 17012 that curUnitIdx is less than lastUnitSize, it is checked whether the base mesh type is I (operation 17013). When the base mesh type is I, the procedure for determining the texture map skip flag is not performed. Otherwise (for example, when the base mesh type is P or skip), the procedure proceeds to operation 17014 to determine the texture map skip flag.

In operation 17014, it is checked whether curSkipCount is greater than or equal to the maximum texture map distance parameter (max_skip_texturemap_distance).

When curSkipCount is greater than or equal to the maximum texture map distance parameter (max_skip_texturemap_distance), the texture map skip flag of the corresponding texture map is derived as 0 (operation 17015).

When curSkipCount is less than the maximum texture map distance parameter (max_skip_texturemap_distance), texture_skip_flag may be obtained through a texture map skip flag parser (not shown) or a texture map skip flag deriver (not shown) (operation 17016).

Then, it is checked whether texture_skip_flag is 1 (operation 17017). When texture_skip_flag is 1, curSkipCount may be incremented by 1 (operation 17019). When texture_skip_flag is 0, curSkipCount may be initialized to 0 (operation 17018).

### Texture Map Deriver 16014

According to embodiments, when whether a texture map is skipped is determined on a per-submesh basis, the texture map deriver 16014 may derive skipped texture maps of submeshes on a per-frame basis. When skipping is performed per unit of two or more frames, such as GOP, the skipped texture maps of submeshes may be derived if the total number of submeshes per frame is the same within the group and the texture maps of the submeshes have the same height and same width.

In this case, the texture maps of sub-meshes skipped at the transmitting side may be derived from the texture map information related to a submesh referenced based on reference information (i.e., reference texture map information) determined by the reference texture map information determiner 16012.

According to embodiments, when reference direction information is used and indicates the past or the future, the nearest past or future texture map with respect to the current texture map may be used as the reference texture map to derive the current texture map to have the same value as the reference texture map.

According to embodiments, when the reference direction information indicates bidirectional, the nearest past and future texture maps with respect to the current texture map may be used as reference texture maps to derive the average of the two texture maps as the current texture map. Alternatively, the current texture map may be derived by performing weighted averaging based on the POC difference between the past texture map and the future texture map with respect to the current texture map.

According to embodiments, when reference texture map index information is used, the texture map corresponding to the reference texture map index may be used as the reference texture map to derive the current texture map to have the same value as the reference texture map.

Further, when texture maps are skipped on a per-submesh basis at the transmitting side, the texture map deriver 16014 may receive a parsed flag (smh_texture_skip_flag) indicating whether a texture map is skipped on a per-submesh basis, or may derive the same according to the same rule between the encoder and the decoder.

When a flag (afps_vdmc_texture_skip_flag) indicating whether a texture map is skipped on a per-frame basis is 0, the texture map deriver 16014 may receive afps_vdmc_sm_skip_enable_flag through parsing to determine whether the skip flag is parsed on a per-submesh basis.

In this case, when afps_vdmc_sm_skip_enable_flag is 0, the submesh-level texture skip flag (smh_texture_skip_flag) for the corresponding frame may be derived as 0 and may not be parsed.

Further, the index of the referenced submesh may be derived to be the same as the index of the skipped submesh, or may be derived in the same manner as the reference structure of the base mesh, or may be parsed.

When smh_texture_skip_flag is 1, an index refDirection_idx indicating the direction of the reference texture map may be parsed, and/or ref_texture_idx indicating the index of the reference texture map may be parsed.

According to embodiments, when texture maps are skipped on a per-submesh basis, the texture maps referenced by the skipped texture maps of submeshes within the same frame may reference submesh texture maps of different frame indices.

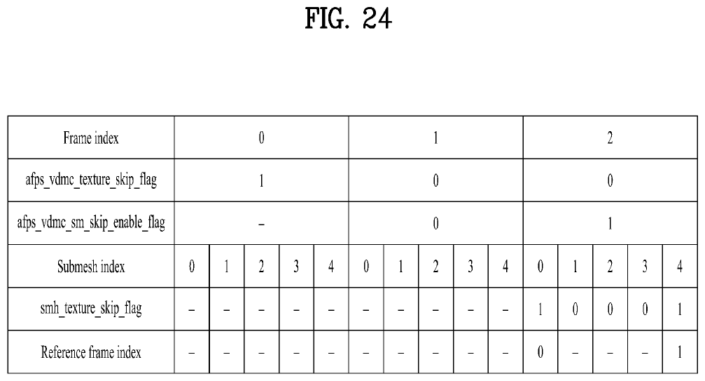

FIG. 24 illustrates an example of a texture map skip status and a reference frame index signaled on a per-submesh basis according to embodiments. In particular, FIG. 24 illustrates an example in which texture maps referenced have different frame indices on a submesh basis.

More specifically, FIG. 24 illustrates an example in which each frame includes five submeshes, and for a texture map having a frame index of 2, texture maps of submeshes with submesh indices 0 and 4 are respectively skipped (i.e., smh_texture_skip_flag for submesh indices 0 and 4 is 1). In this case, a texture map referenced by the submesh with index 0 may have a frame index of 0, and a texture map referenced by the submesh with index 4 may have a frame index of 1, such that texture maps of different frames may be referenced.

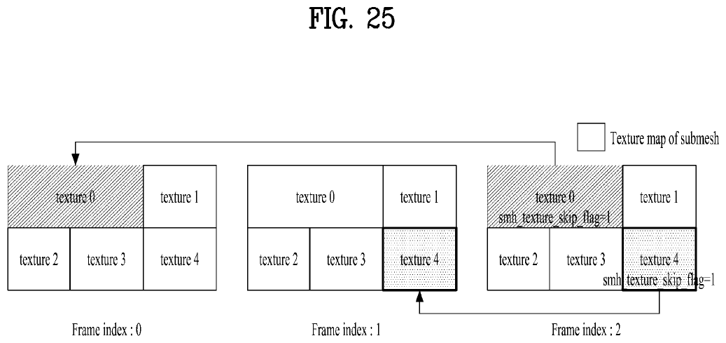

FIG. 25 is a diagram illustrating an example of a relationship between frames of referenced texture maps when texture map coding is skipped on a per-submesh basis according to embodiments. FIG. 25 is a visualization example of FIG. 24. Accordingly, as in FIG. 24, coding of texture maps of submeshes corresponding to submesh indices 0 and 4 among the submeshes included in the frame with index 2 is skipped.

That is, among the five submeshes included in the frame with frame index 2, the texture map referenced by the texture map (texture 0) of the submesh corresponding to submesh index 0 is the texture map (texture 0) of the submesh index 0 in the frame with frame index 0, and the texture map referenced by the texture map (texture 4) of the submesh corresponding to submesh index 4 is the texture map (texture 4) of the submesh index 4 in the frame with frame index 1. In other words, once a reference frame is determined, the texture map of the submesh at the same position within the reference frame is referenced.

According to embodiments, signaling information may be generated by a metadata processor (which may also be referred to as a metadata generator) (not shown) in the transmission apparatus (or the encoder of the transmission apparatus), and may be provided to corresponding blocks in the transmission apparatus and/or to the reception apparatus (or the decoder of the reception apparatus). A metadata parser (not shown) of the reception apparatus may parse the received signaling information and provide the same to the corresponding blocks. According to embodiments, each block of the reception apparatus may perform each operation based on the signaling information.

As described above, the unit of skipping of texture information (i.e., texture maps) may be a frame, a patch, a submesh, a tile, or a slice. That is, depending on the unit of skipping of texture maps, such as a frame, a patch, a slice, a submesh, or a tile, the location at which the texture map skip flag (texture_skip_flag) indicating whether a texture map is skipped is signaled may be determined.

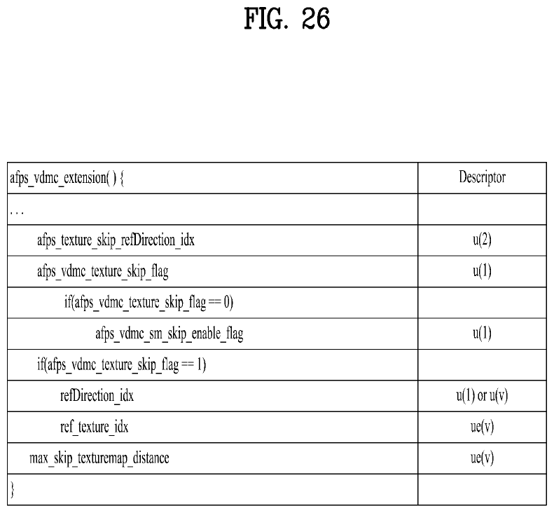

FIG. 26 illustrates an example of a syntax structure of an atlas frame parameter set (AFPS) in signaling information in a bitstream according to embodiments. In particular, FIG. 26 illustrates an example of an Atlas frame parameter set vdmc extension RBSP Syntax & Semantics. That is, when the unit of skipping of a texture map is a frame, afps_vdmc_extension( ) in FIG. 26 may be extended from the AFPS to include parameters (i.e., information) related to texture map skipping.

In this case, the texture map decoder 1521 of the reception apparatus may receive the texture map skip status and reference information each parsed on a per-frame basis, or may receive a single parsed index.

As an example, when a single index is parsed, afps_texture_skip_refDirection_idx may be parsed.

As another example, when the status and reference information are each parsed, a afps_vdmc_texture_skip_flag flag indicating whether a texture map is skipped may be parsed on a per-frame basis. Then, when the flag is 0, an afps_vdmc_sm_skip_enable_flag flag indicating whether texture map skipping is enabled may be parsed on a per submesh basis within the frame. In addition, when afps_vdmc_texture_skip_flag is 1, refDirection_idx indicating the direction of a reference texture map may be parsed, and/or ref_texture_idx indicating the index of the reference texture map may be parsed.

More specifically, in FIG. 26, afps_texture_skip_refDirection_idx is an index indicating both the texture map skip status and the reference texture map direction information (i.e., on a per-frame basis).

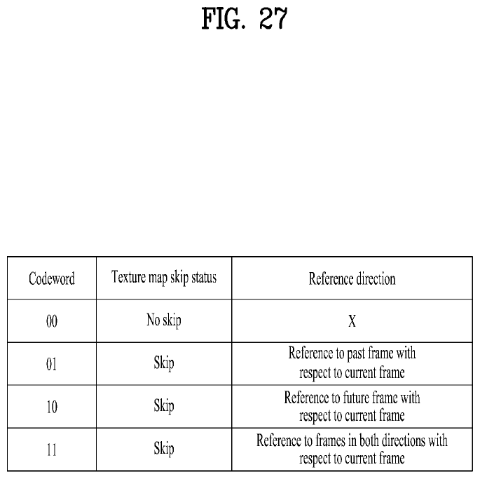

FIG. 27 is a table showing embodiments of a texture map skip status and reference direction of afps_texture_skip_refDirection_idx according to embodiments. That is, FIG. 27 may illustrate an embodiment of codewords and meanings of the codewords for signaling the texture map skip status and reference direction information using a 2-bit index (texture_skip_refDirection_idx).

As an example, when the value of afps_texture_skip_refDirection_idx is 00, the texture map is not skipped and there is no reference direction.

As another example, when the value of afps_texture_skip_refDirection_idx is 01, it indicates that the texture map may be skipped and a past frame with respect to the current frame may be referenced.

As another example, when the value of afps_texture_skip_refDirection_idx is 10, it indicates that the texture map may be skipped and a future frame with respect to the current frame may be referenced.

As another example, when the value of afps_texture_skip_refDirection_idx is 11, it indicates that the texture map may be skipped and frames in both directions with respect to the current frame may be referenced.

afps_vdmc_texture_skip_flag is a flag indicating whether a texture map is skipped on a per-frame basis.

afps_vdmc_sm_skip_enable_flag is a flag indicating whether parsing of the texture map skip flag is enabled on a per-submesh basis.

refDirection_idx is an index indicating reference texture map direction information.

According to embodiments, when the reference texture map direction information indicates whether the reference texture map is a past texture map or a future texture map with respect to the current texture map, refDirection_idx may be u(1). Additionally/alternatively, when the information indicates bidirectional reference of both a past texture map and a future texture map, refDirection_idx may be u(v). Here, u(1) indicates a value represented by 1 bit, and u(v) indicates a value represented by v bits, where v may be any number greater than 1.

ref_texture_idx indicates the reference texture frame index.

max_skip_texturemap_distance indicates the maximum distance between a current texture map and a skipped texture map in determining whether a texture map is skipped.

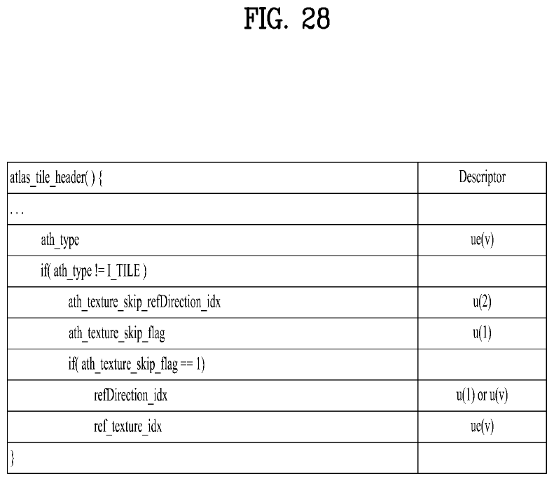

FIG. 28 illustrates an example of a syntax structure of an atlas tile header according to embodiments. That is, when the unit of texture map skipping is a tile, atla_tile_header( ) in FIG. 28 may include parameters (i.e., information) related to texture map skipping.

In this case, the texture map decoder 1521 of the reception apparatus may receive the texture map skip status and reference information each parsed on a per-tile basis, or may receive a single parsed index.

As an example, when a single index is parsed, ath_texture_skip_refDirection_idx may be parsed.

As another example, when the status and reference information are each parsed, an ath_vdmc_texture_skip_flag flag indicating whether a texture map is skipped may be parsed on a per-tile basis. When the flag is 1, refDirection_idx indicating the direction of a reference texture map may be parsed, and/or ref_texture_idx indicating the index of the reference texture map may be parsed.

More specifically, in FIG. 28, ath_type indicates the coding type of the current atlas tile. For example, among the values of ath_type, 0 may indicate P_TILE; 1 may indicate I_TILE; and 2 may indicate SKIP TILE.

ath_texture_skip_refDirection_idx is an index indicating both the texture map skip status and the reference texture map direction information (i.e., on a per-atlas tile basis). For details of the texture map skip status and the reference texture map direction information, which will not be described below to avoid redundancy, refer to the description of FIG. 27.

ath_texture_skip_flag is a flag indicating whether a texture map is skipped on a per-tile basis.

refDirection_idx is an index indicating reference texture map direction information.

ref_texture_idx is a reference texture frame index.

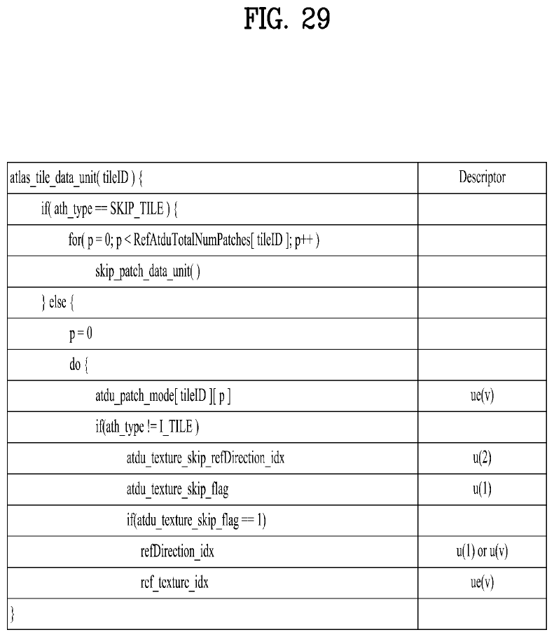

FIG. 29 illustrates an example of a syntax structure of an atlas tile data unit according to embodiments. Specifically, when the unit of texture map skipping is a patch, atlas_tile_data_unit(tileID) in FIG. 29 may include parameters (i.e., information) related to texture map skipping.

In this case, the texture map decoder 1521 of the reception apparatus may receive the texture map skip status and reference information each parsed on a per-patch basis, or may receive a single parsed index.

As an example, when a single index is parsed, ath_texture_skip_refDirection_idx may be parsed.

As another example, when the status and reference information are each parsed, a atdu_vdmc_texture_skip_flag flag indicating whether a texture map is skipped may be parsed on a per-patch basis. When the flag is 1, refDirection_idx indicating the direction of a reference texture map may be parsed, and/or ref_texture_idx indicating the index of the reference texture map may be parsed.

More specifically, in FIG. 29, atdu_patch_mode[tileID][p] indicates a patch mode of a patch with index p in the current tileID.

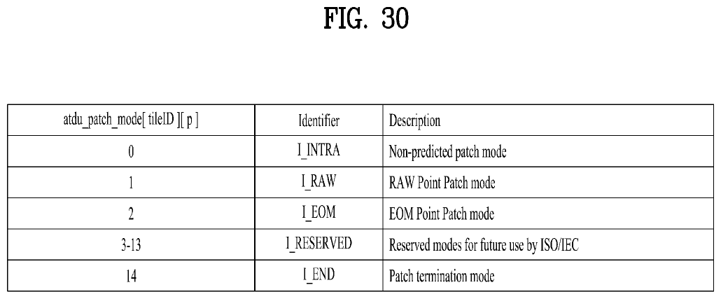

FIG. 30 is a table showing examples of determining a patch mode according to an identifier when a coding type of a current atlas tile is I_TILE according to embodiments. For example, among the values of atdu_patch_mode[tileID][p], 0 may indicate an I_INTRA mode (i.e., a non-predicted patch mode); 1 may indicate an I_RAW mode (i.e., a RAW point patch mode); and 2 may indicate an I_EOM mode (i.e., an EOM point patch mode).

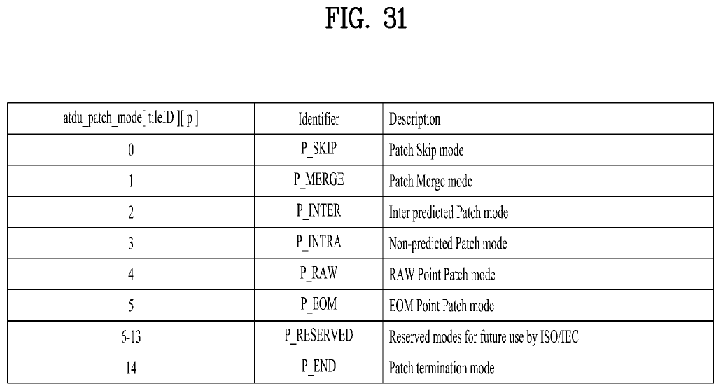

FIG. 31 is a table showing examples of determining a patch mode according to an identifier when a coding type of a current atlas tile is P_TILE according to embodiments. For example, among the values of atdu_patch_mode[tileID][p], 0 may indicate a P_SKIP mode (i.e., a patch skip mode), 1 may indicate a P_MERGE mode (i.e., a patch merge mode), and 2 may indicate a P_INTER mode (i.e., an inter predicted patch mode).

In addition, when the coding type of the current atlas tile is not I_TILE, the atlas tile data unit may contain information related to texture map skipping (e.g., atdu_texture_skip_flag, refDirection_idx, and ref_texture_idx).

atdu_texture_skip_flag is a flag indicating whether a texture map is skipped on a per-patch basis.

refDirection_idx is an index indicating reference texture map direction information.

ref_texture_idx is a reference texture frame index.

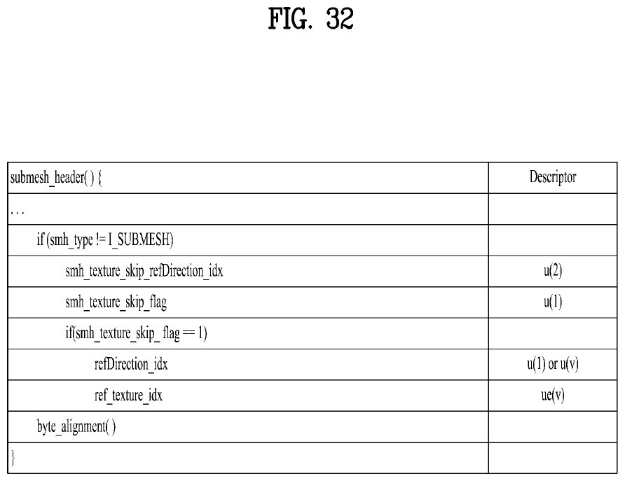

FIG. 32 illustrates an example of a syntax structure of a base mesh submesh header according to embodiments. Specifically, when the unit of texture map skipping is a submesh, submesh_header( ) in FIG. 32 may include parameters (i.e., information) related to texture map skipping.

In this case, the texture map decoder 1521 of the reception apparatus may receive the texture map skip status and reference information each parsed on a per-submesh basis, or may receive a single parsed index.

As an example, when a single index is parsed, smh_texture_skip_refDirection_idx may be parsed.

As another example, when the status and reference information are each parsed, an smh_vdmc_texture_skip_flag flag indicating whether a texture map is skipped may be parsed on a per-submesh basis. When the flag is 1, refDirection_idx indicating the direction of a reference texture map may be parsed, and/or ref_texture_idx indicating the index of the reference texture map may be parsed.

More specifically, in FIG. 32, smh_texture_skip_refDirection_idx is an index indicating both the texture map skip status and the reference texture map direction information (i.e., on a per-submesh basis). For details of the texture map skip status and the reference texture map direction information, which will not be described below to avoid redundancy, refer to the description of FIG. 27.

smh_texture_skip_flag is a flag indicating whether a texture map is skipped on a per-submesh basis.

refDirection_idx is an index indicating reference texture map direction information.

ref_texture_idx is a reference texture frame index.

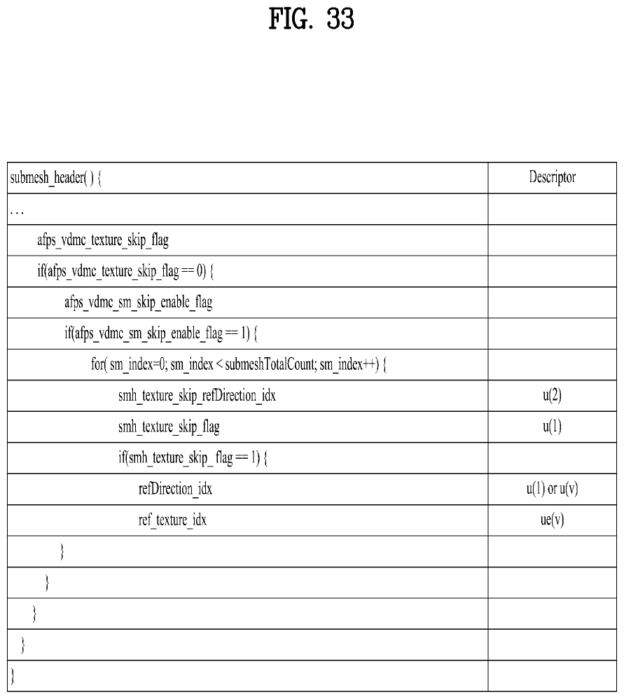

FIG. 33 illustrates another example of a syntax structure of a base mesh submesh header according to embodiments. Specifically, when the unit of texture map skipping is a submesh, submesh_header( ) in FIG. 33 may include parameters (i.e., information) related to texture map skipping.

In FIG. 33, afps_vdmc_texture_skip_flag is a flag indicating whether a texture map is skipped on a per-frame basis.

afps_vdmc_sm_skip_enable_flag is a flag indicating whether parsing of the texture map skip flag is enabled on a per-submesh basis.

sm_index is a submesh index.

smh_texture_skip_refDirection_idx is an index indicating both the texture map skip status and the reference texture map direction information (i.e., on a per-submesh basis). For details of the texture map skip status and the reference texture map direction information, which will not be described below to avoid redundancy, refer to the description of FIG. 27.

smh_texture_skip_flag is a flag indicating whether a texture map is skipped on a per-submesh basis.

refDirection_idx is an index indicating reference texture map direction information.

ref_texture_idx is a reference texture frame index.

Next, a description is provided of the operations of the transmission apparatus and the reception apparatus when information about texture map skipping is signaled on a per-frame, per-tile, per-patch, or per-submesh basis, as illustrated in FIGS. 26 to 33. Here, the transmission apparatus may be any one of the transmission apparatus 100 or mesh video encoder 102 of FIG. 12, the encoder (pre-processor and encoder) of FIGS. 2, 6, or 7, the transmission apparatus of FIG. 13, or the transmission apparatus of FIG. 15. In the present disclosure, the transmission apparatus of FIG. 15 is described as an example. In addition, the reception apparatus may be any one of the reception apparatus 110 or mesh video decoder 113 of FIG. 1, the decoder of FIG. 11 or 12, the reception apparatus of FIG. 14, or the reception apparatus of FIG. 20. In the present disclosure, the reception apparatus of FIG. 20 is described as an example.

Specifically, in the transmission apparatus, an original mesh to be transmitted is generated as a base mesh through the mesh decimator 11011 and the mesh parameterizer 11012. The generated base mesh is quantized by the mesh quantizer 11013. In the case of an inter frame, motion vectors from a previous reference reconstructed base mesh are calculated and encoded by the motion vector encoder 11015. In the case of an intra frame, the base mesh is transmitted as a base mesh bitstream through the static mesh encoder 11016. In addition, the mesh decimated through the mesh decimator is subdivided and fitted through the mesh subdivider 11018 and the mesh fitter 11019. The displacement vector calculator 11020 calculates displacement vectors between the subdivided and fitted mesh data and the reconstructed mesh data from the previously encoded base mesh. To efficiently encode the calculated displacement vectors, the displacement vector coordinate transformer 11021 may transform the displacement vector coordinate system into a local coordinate system. Then, the displacement vectors are transformed into displacement vector coefficients and quantized by the displacement vector transformer in the displacement vector encoder 11022. 2D images packed through a displacement vector coefficient packer are encoded using a 2D video encoder such as H.264, HEVC, or VVC to generate a displacement vector bitstream.

The texture map generator 11026 generates a new texture map having color information corresponding to texture coordinates of the reconstructed mesh. The texture map is encoded through a 2D video encoder and transmitted as a texture bitstream.

In the present disclosure, during the operation of generating the texture map and encoding the same into a texture map bitstream, the texture map skip determiner 11027 may determine whether to skip coding of the texture map, and only texture maps excluding the texture maps for which coding is determined to be skipped are encoded. Here, the texture maps for which coding is determined to be skipped are neither coded nor transmitted.

In the present disclosure, after a texture map is generated based on reconstructed mesh data, the texture map skip determiner 11027 may determine whether to encode/decode the texture map. In this regard, whether to encode/decode the texture map may be determined by explicitly signaling a texture map skip flag (texture_skip_flag), or whether to skip the coding may be implicitly derived according to conditions defined in the same manner by the encoder/decoder. In addition, when reference texture map information (i.e., reference information) is explicitly signaled, refDirection_idx indicating reference texture direction information (such as past or future) may be determined and signaled, and/or ref_texture_idx indicating a reference texture map index may be signaled. Further, the encoder/decoder may determine whether a texture map is skipped based on the same maximum texture map distance parameter (max_skip_texturemap_distance), and the maximum texture map distance parameter may be transmitted to the decoder. Alternatively, whether a texture map is skipped may be derived at the decoder (i.e., the texture map decoder) based on the same maximum texture map distance parameter shared between the encoder and the decoder.

According to embodiments, criteria for determining whether a texture map is skipped may include similarity between a current texture map and a reference texture map, an estimated number of generated bits, and a distance between the current texture map and the reference texture map. In addition, the unit of skipping of texture information (i.e., texture map) may be a frame, a submesh, a patch, a tile, or a slice. Depending on the unit of texture map skipping, a texture map skip flag may be signaled as afps_vdmc_texture_skip_flag (on a frame basis), smh_texture_skip_flag (on a submesh basis), atdu_texture_skip_flag (on a patch basis), or ath_texture_skip_flag (on a tile basis).

As described above, among the texture maps generated by the texture map generator 11026, encoding of texture maps for which texture_skip_flag is determined as 1 by the texture map skip determiner 11027 may be skipped. In contrast, texture maps for which texture_skip_flag is 0 may be encoded by the texture map encoder 11028 using a 2D video encoder or the like.

Then, the base mesh bitstream, displacement vector bitstream, and texture bitstream generated through the entire process described above in the transmission apparatus are multiplexed into a single bitstream through a multiplexer and transmitted to the reception apparatus through a transmitter.

The reception apparatus receives the bitstream transmitted by the transmission apparatus and decodes the base mesh bitstream, displacement vector bitstream, and texture map bitstream, respectively, through a demultiplexer.

First, the base mesh bitstream is decoded through the motion vector decoder 15012 in the case of an inter frame, or through the static mesh decoder 15013 in the case of an intra frame.

The decoded base mesh undergoes mesh subdivision through the base mesh reconstructor 15014 and the mesh subdivider 15015.

The displacement vector bitstream is decoded by the displacement vector decoder 15017 in reverse order of encoding and displacement vector coefficients are restored. The restored displacement vector coefficients are inverse-quantized and inverse-transformed through the displacement vector inverse quantizer 15018 and the displacement vector inverse transformer 15019. Then, the displacement vector coordinate inverse transformer 15020 inverse transforms the coordinate system of the inverse-transformed displacement vectors from a local coordinate system to a Cartesian coordinate system to reconstruct mesh geometry information together with base mesh data.

The mesh reconstructor 15016 may reconstruct final geometry information by calculating the vertex geometry information related to the reconstructed mesh by adding reconstructed displacement vectors to vertices generated through the subdivision operation of the mesh subdivider 15015.

A texture map is reconstructed from the texture map bitstream by the texture map decoder 15021. The operation process of the texture map decoder 15021 according to the present disclosure is described in more detail below.

Specifically, when the texture map bitstream is input to the texture map decoder 15021, first, the texture skip flag determiner 16011 may first determine whether the texture map is skipped based on a parsed 1-bit flag, texture_skip_flag, indicating whether the texture maps of each unit determined by the transmission apparatus are skipped. Here, depending on the texture skip unit, the texture map skip flag may be parsed as afps_vdmc_texture_skip_flag (on a frame basis), smh_texture_skip_flag (on a submesh basis), atdu_texture_skip_flag (on a patch basis), or ath_texture_skip_flag (on a tile basis).

According to embodiments, when the texture map skip unit is a frame, the texture map skip status and reference information may each be parsed respectively on a per-frame basis, or may be parsed as a single index. When they are parsed as a single index, afps_texture_skip_refDirection_idx may be parsed. When the status and reference information are each parsed, afps_vdmc_texture_skip_flag indicating whether a texture map is skipped on a per-frame basis may be parsed. Then, when the flag is 0, an afps_vdmc_sm_skip_enable_flag flag indicating whether texture map skipping is enabled may be parsed on a per-submesh basis within the frame. When afps_vdmc_texture_skip_flag is 1, refDirection_idx indicating the direction of a reference texture map may be parsed, and/or ref_texture_idx indicating the index of the reference texture map may be parsed.

According to embodiments, when the texture map skip unit is a tile, the texture map skip status and reference information may each be parsed on a per-tile basis, or may be parsed as a single index. When they are parsed as a single index, ath_texture_skip_refDirection_idx may be parsed. When the status and reference information are each parsed, ath_texture_skip_flag indicating whether a texture map is skipped on a per-tile basis may be parsed. Then, when the flag is 1, refDirection_idx indicating the direction of a reference texture map may be parsed, and/or ref_texture_idx indicating the index of the reference texture map may be parsed.

According to embodiments, when the texture map skip unit is a patch, the texture map skip status and reference information may each be parsed on a per-patch basis, or may be parsed as a single index. When the status and reference information are each parsed, atdu_texture_skip_flag indicating whether a texture map is skipped on a per-patch basis may be parsed. Then, when the flag is 1, refDirecion_idx indicating the direction of a reference texture map may be parsed, and/or ref_texture_idx indicating the index of the reference texture map may be parsed.

According to embodiments, when the texture map skip unit is a submesh, the texture map skip status and reference information may each be parsed on a per-submesh basis, or may be parsed as a single index. When they are parsed as a single index, smh_texture_skip_refDirection_idx may be parsed. When the status and reference information are each parsed, smh_texture_skip_flag indicating whether a texture map is skipped on a per-submesh basis may be parsed. Then, when the flag is 1, refDirection_idx indicating the direction of a reference texture map may be parsed, and/or ref_texture_idx indicating the index of the reference texture map may be parsed. Alternatively, when the status and reference information are each parsed, afps_vdmc_texture_skip_flag may be parsed from an atlas frame parameter set (AFPS). Then, when the flag is 0, an afps_vdmc_sm_skip_enable_flag flag indicating whether texture map skipping is enabled may be parsed on a per-submesh basis within the frame. When afps_vdmc_sm_skip_enable_flag is 1, an smh_texture_skip_flag indicating whether a texture map is skipped for each submesh within the frame may be parsed. When smh_texture_skip_flag is 1, refDirection_idx indicating the direction of a reference texture map may be parsed and/or ref_texture_idx indicating the index of the reference texture map may be parsed.

In addition, the encoder/decoder may derive whether a texture map is skipped based on the same maximum texture map distance parameter (max_skip_texturemap_distance). The maximum texture map distance parameter (max_skip_texturemap_distance) may be a parameter for deriving whether a texture map is skipped. By omitting the texture map skip flag, bits to be signaled may be saved. When the number of consecutively skipped texture maps, curSkipCount, is greater than or equal to the maximum texture map distance parameter (max_skip_texturemap_distance), the texture map skip flag of the corresponding texture map may be derived as 0. When curSkipCount is less than max_skip_texturemap_distance, texture_skip_flag may be obtained through a texture skip flag parser or a texture skip flag deriver. When texture_skip_flag is 1, curSkipCount may be incremented by 1. When texture_skip_flag is 0, curSkipCount may be initialized to 0.

Once the texture map is reconstructed through the above-described process, a final reconstructed mesh is generated together with the previously reconstructed geometry information.

As described above, according to the present disclosure, when the similarity between a reference texture map and a current texture map is high, coding of the current texture map may be skipped. In this case, the unit of skipping of texture map coding may be a frame, a submesh, a patch, a tile, or a slice. That is, texture map coding may be skipped by determining similarity on the skip unit. In general, among the main components of mesh data, namely a base mesh, displacement vectors, and texture maps, texture maps occupy a large portion of the bit capacity, typically accounting for about 60% to 80% depending on mesh content and transmission conditions. The present disclosure may achieve significant bit savings and an advantage in terms of transmission speed by skipping coding and transmission of a portion of texture maps that occupy a large portion of bits.

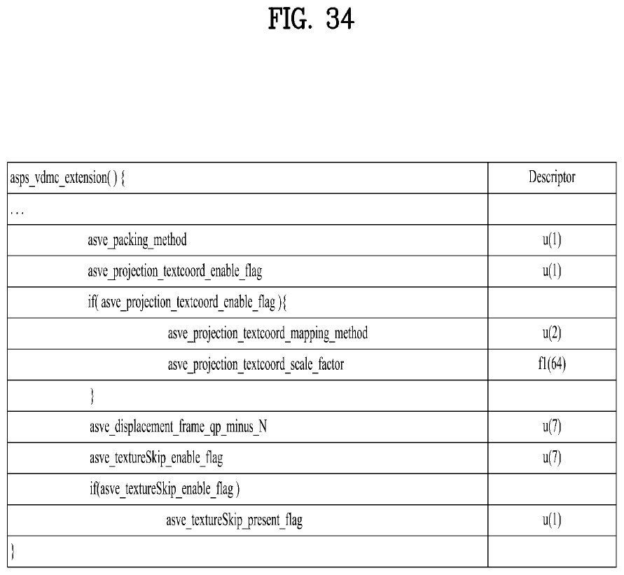

FIG. 34 illustrates another example of a syntax structure of an atlas sequence parameter set (ASPS) in signaling information in a bitstream according to embodiments. In particular, FIG. 34 illustrates an example of atlas sequence parameter set vdmc extension RBSP syntax & semantics. Specifically, asps_vdmc_extension( ) in FIG. 34 may include flags indicating whether a texture map skipping method is used on a per-sequence basis and whether there are frames skipped within the sequence. In other words, in the present disclosure, the flags indicating whether a texture map skipping method is used on a per-sequence basis and whether there are frames skipped within the sequence may signaled through an atlas sequence parameter set vdmc extension and transmitted to the reception apparatus.

In FIG. 34, asve_textureSkip_enable_flag is a flag for determining whether a texture map skipping method is enabled on a per-sequence basis. When the value of asve_textureSkip_enable_flag is 1, the texture map skipping method may be performed. When the value of asve_textureSkip_enable_flag is 0, it indicates that the texture map skipping method is not used.

asve_textureSkip_present_flag is a flag indicating whether there is a skipped frame within a sequence. When the value of asve_textureSkip_present_flag is 1, it indicates that there is a skipped frame in the sequence. When the value of asve_textureSkip_present_flag is 0, it indicates that there are no skipped frames in the sequence.

According to embodiments of the present disclosure, a flag texturemap_skip_flag indicating that a texture map is skipped on a per-frame basis and information about a reference direction (ref_direction_idx) of the skipped texture map may be signaled through one of an AFPS, a tile header, a patch unit header, and a NAL unit header and be transmitted to the reception apparatus. Here, textureSkip_present_flag may have the same meaning as texture_skip_flag in FIGS. 26 to 33, and ref_direction_idx may have the same meaning as refDirection_idx in FIGS. 26 to 33.

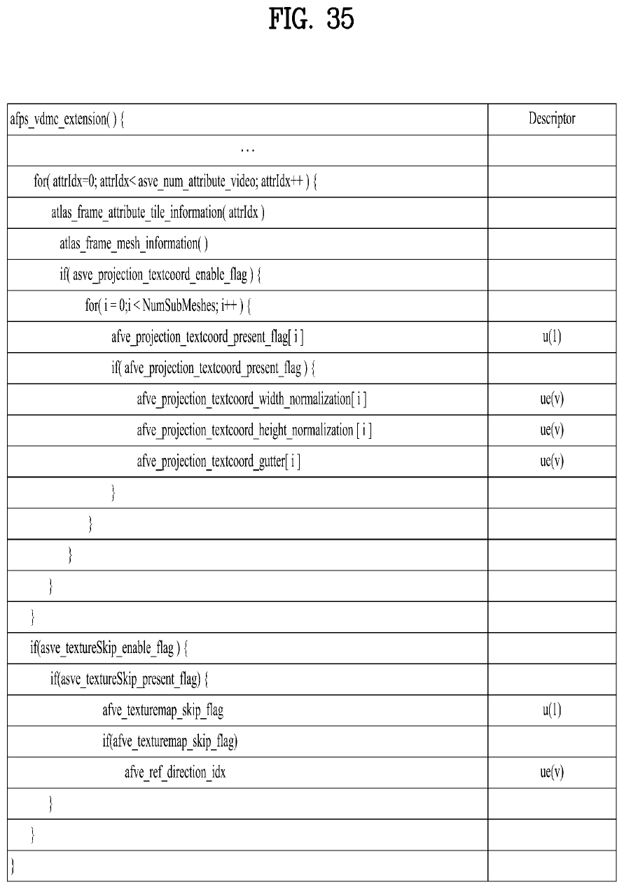

FIG. 35 illustrates another example of a syntax structure of an AFPS in signaling information in a bitstream according to embodiments. In particular, FIG. 35 illustrates an example of atlas frame parameter set vdmc extension RBSP syntax & semantics. That is, afps_vdmc_extension( ) in FIG. 35 may include a flag texturemap_skip_flag indicating that a texture map is skipped on a per-frame basis and information about a reference direction (ref_direction_idx) of the skipped texture map. In other words, information indicating that a texture map referencing the atlas frame parameter set V-DMC extension is skipped and information about the reference direction of the skipped texture map may be signaled.

In FIG. 35, afve_texturemap_skip_flag is a flag indicating that the texture map of the current frame is skipped. When the value of afve_texturemap_skip_flag is 1, it indicates a frame in which the texture map is skipped. When the value of afve_texturemap_skip_flag is 0, it indicates that the frame is not a frame in which the texture map is skipped.

afve_ref_direction_idx indicates reference direction information related to the skipped texture map.

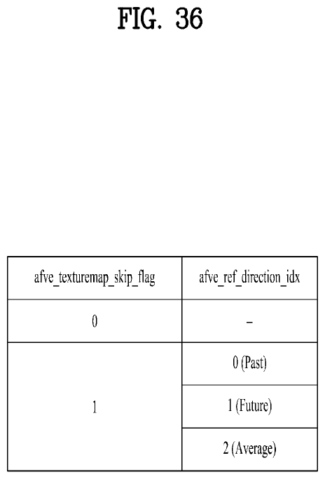

FIG. 36 is a table showing definitions of afve_texturemap_skip_flag and afve_ref_direction_idx according to embodiments.

For example, afve_ref_direction_idx equal to 0 indicates that only a past frame is referenced. afve_ref_direction_idx equal to 1 indicates that only a future frame is referenced. afve_ref_direction_idx equal to 2 indicates that frames in both directions are referenced.

When the value of afve_texturemap_skip_flag is 0, the value of afve_ref_direction_idx may be absent or may be filled with a predefined value.

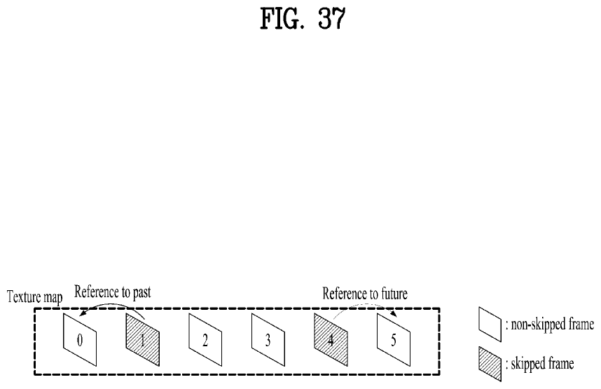

FIG. 37 is a diagram illustrating an example of texture map skipping according to embodiments. That is, the figure illustrates an example of syntax information when related information is signaled through an AFPS in a case where texture map coding is skipped.

Referring to FIG. 37, frames 0, 2, 3, and 5 correspond to non-skip frames, and frames 1 and 4 correspond to skipped frames. In this case, FIG. 37 shows that the texture map decoder of the reception apparatus references a past frame (frame 0) when generating a frame with frame index 1, and references a future frame (frame 5) when generating a frame with frame index 4.

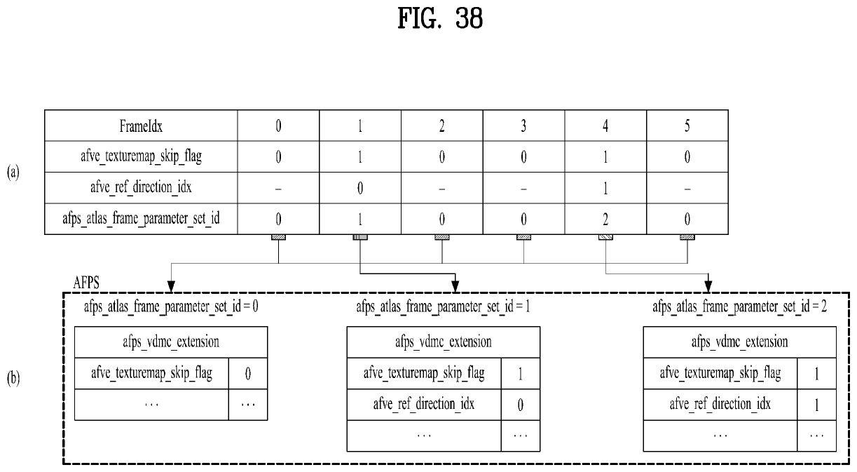

FIGS. 38(a) and 38(b) illustrate an example of determining texture map skip status and reference information indices on a frame basis according to embodiments. In particular, FIG. 38(a) is a table showing an example of a texture map skip status and reference information determined on a per-frame basis, and FIG. 38(b) shows an example of syntax information according to an atlas frame parameter set identifier (atlas_frame_parameter_set_id).

Referring to FIG. 38(a) as an example, when frame 1 and frame 4 are skipped (frameIdx is 1 and 4), afve_texturemap_skip_flag for the frames may be determined as 1. In this case, when a past frame is referenced for frame 1, afve_ref_direction_idx may be determined as 0.

When a future frame is referenced for frame 4, afve_ref_direction_idx may be determined as 1.

For frames 0, 2, 3, and 5, which are non-skipped frames, afve_texturemap_skip_flag may be determined as 0.

FIG. 38(b) illustrates an example of added AFPSs according to combinations selected from the texture map skip status and reference information.

For example, a case where the texture map is not skipped (afve_texturemap_skip_flag=0) may be mapped to AFPS ID 0. A case where the texture map is skipped (afve_texturemap_skip_flag=1) and the reference index is 0 may be mapped to AFPS ID 1. A case where the texture map is skipped (afve_texturemap_skip_flag=1) and the reference index is 1 may be mapped to AFPS ID 2.

As illustrated in FIGS. 37, 38(a), and 38(b), syntax information varies depending on whether texture map coding is skipped and the texture map reference direction. Each time the syntax information changes, the value of afps_atlas_frame_parameter_set_id may be incremented by one, and new syntax information may be signaled so as to be distinguished. For example, in the afps_frame_tile_information syntax, if there is no matching set among previously generated AFPSs, a new AFPS may be added.

According to embodiments, information about whether texture map coding is skipped and reference information for frame derivation may be signaled and transmitted through an atlas tile header on a per-tile basis.

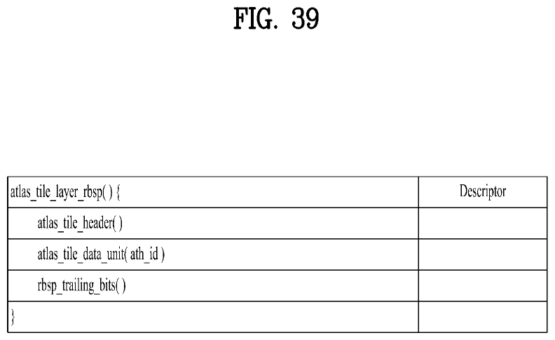

FIG. 39 illustrates an example of a syntax structure of an atlas tile layer according to embodiments. According to embodiments, the atlas tile layer may include an atlas tile header (atlas_tile_header( )) and an atlas tile data unit (atlas_tile_data_unit( )).

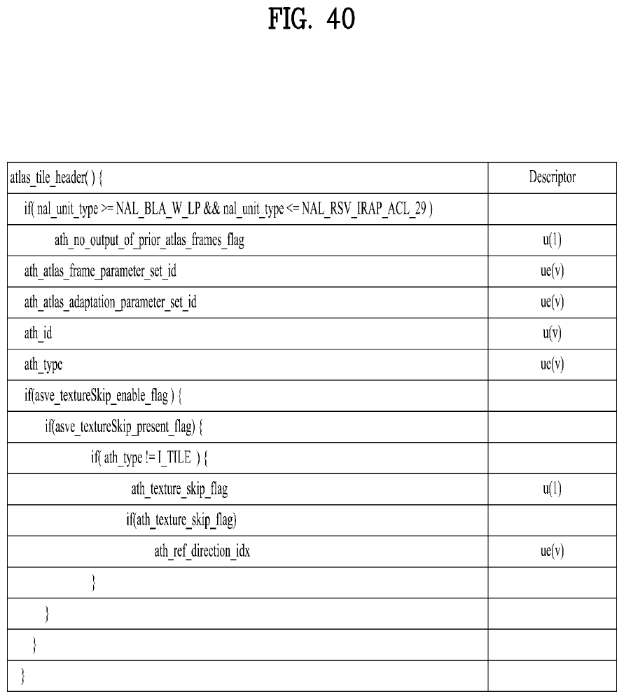

FIG. 40 illustrates an example of a syntax structure of an atlas tile header (atlas_tile_header( )) according to embodiments.

In FIG. 40, ath_texture_skip_flag is a flag indicating whether a texture map is skipped.

For example, ath_texture_skip_flag equal to 1 indicates that the texture map is skipped, and ath_texture_skip_flag equal to 0 indicates that the texture map is not skipped.

ath_ref_direction_idx is an index indicating a reference direction in deriving a skipped texture map. For example, ath_ref_direction_idx equal to 0 indicates that a texture map in a past direction is referenced. ath_ref_direction_idx equal to 1 indicates that a texture map in a future direction is referenced. ath_ref_direction_idx equal to 2 indicates that texture maps in both directions are referenced.

According to embodiments, the texture map skip status and reference information for frame derivation may be signaled and transmitted through a patch data unit and/or an inter patch data unit on a per-patch basis.

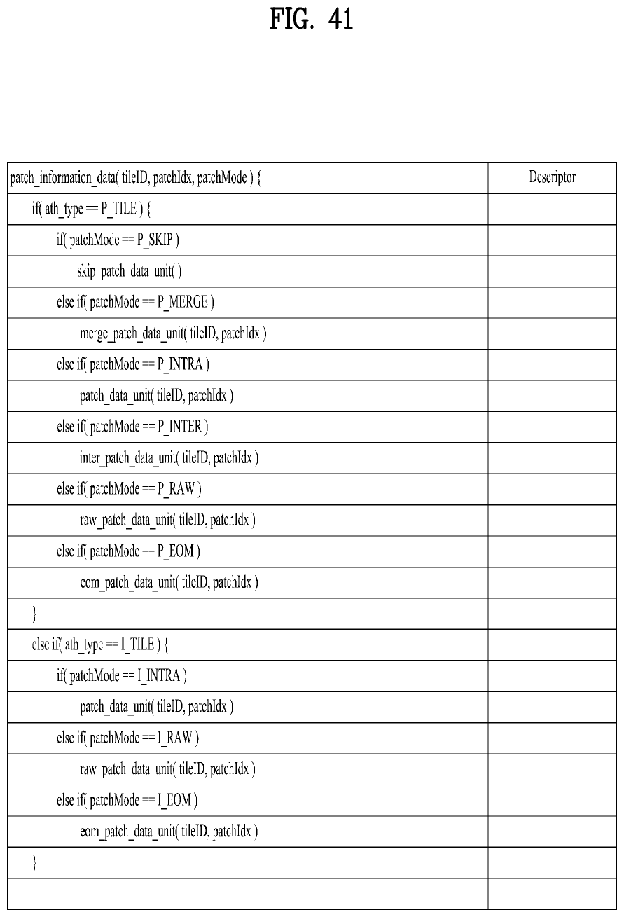

FIG. 41 illustrates an example of a syntax structure of patch information data (patch_information_data(tileID, patchIdx, patchMode)) according to embodiments.

When ath_type indicates P_TILE and patchMode indicates P_INTRA, the patch information data (patch_information_data(tileID, patchIdx, patchMode)) in FIG. 41 may include a patch data unit (patch_data_unit(tileID, patchIdx)). When ath_type indicates P_TILE and patchMode indicates P_INTER, the patch information data may include an inter patch data unit (inter_patch_data_unit(tileID, patchIdx)). In addition, when ath_type indicates I_TILE and patchMode indicates I_INTRA, the patch information data may include a patch data unit (patch_data_unit(tileID, patchIdx)).

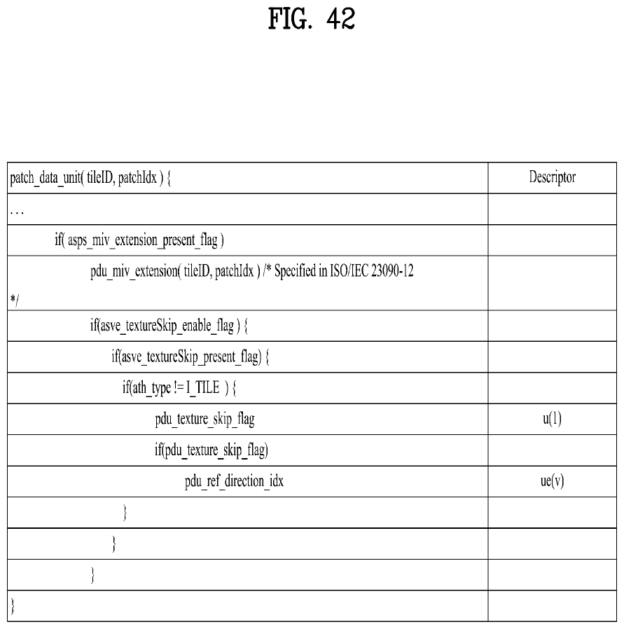

FIG. 42 illustrates an example of a syntax structure of a patch data unit according to embodiments. That is, when the tile type is P_TILE and the patch mode is P_INTRA, or when the tile type is I_TILE and the patch mode is I_INTRA, a patch mode data unit syntax as shown in FIG. 42 is transmitted to the reception apparatus. In FIG. 42, when asve_textureSkip_enable_flag and asve_textureSkip_present_flag are equal to 1 and the tile type is not I_TILE, parse pdu_texture_skip_flag may be parsed for the texture map decoder.

In FIG. 42, pdu_texture_skip_flag is a flag indicating whether a texture map is skipped.

For example, pdu_texture_skip_flag equal to 1 indicates that the texture map is skipped, and pdu_texture_skip_flag equal to 0 indicates that the texture map is not skipped.

pdu_ref_direction_idx is an index indicating a reference direction in deriving a skipped texture map. For example, pdu_ref_direction_idx equal to 0 indicates that a texture map in a past direction is referenced. pdu_ref_direction_idx equal to 1 indicates that a texture map in a future direction is referenced. pdu_ref_direction_idx equal to 2 indicates that texture maps in both directions are referenced.

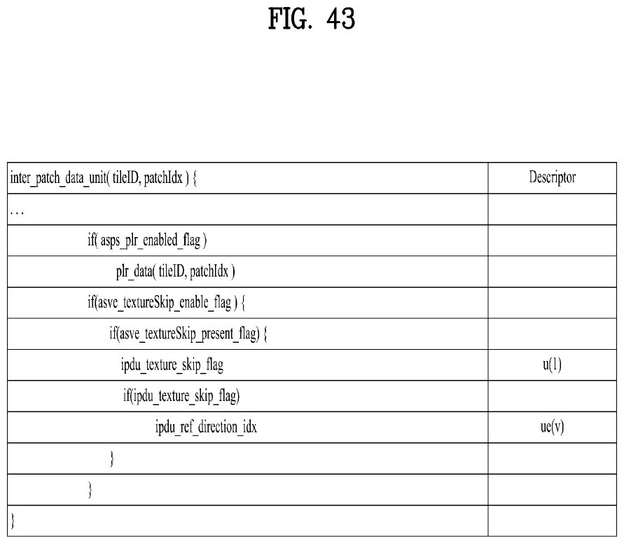

FIG. 43 illustrates an example of a syntax structure of an inter patch data unit according to embodiments. That is, when the tile type is P_TILE and the patch mode is I_INTER, an inter patch data unit syntax as shown in FIG. 43 is transmitted to the reception apparatus. When asve_textureSkip_enable_flag and asve_textureSkip_present_flag are equal to 1, ipdu_texture_skip_flag may be parsed for the texture map decoder.

In FIG. 43, ipdu_texture_skip_flag is a flag indicating whether a texture map is skipped. For example, ipdu_texture_skip_flag equal to 1 indicates that the texture map is skipped, and ipdu_texture_skip_flag equal to 0 indicates that the texture map is not skipped.

ipdu_ref_direction_idx is an index indicating a reference direction in deriving a skipped texture map. For example, ipdu_ref_direction_idx equal to 0 indicates that a texture map in a past direction is referenced. ipdu_ref_direction_idx equal to 1 indicates that a texture map in a future direction is referenced. ipdu_ref_direction_idx equal to 2 indicates that texture maps in both directions are referenced.

According to embodiments, atlas_frame_rbsp( ), which is a structure for transmitting frame-level information, may be added to an existing NAL unit parsing structure, and a texture map skip flag and a reference information index for deriving skipped frames may be transmitted to the reception apparatus.

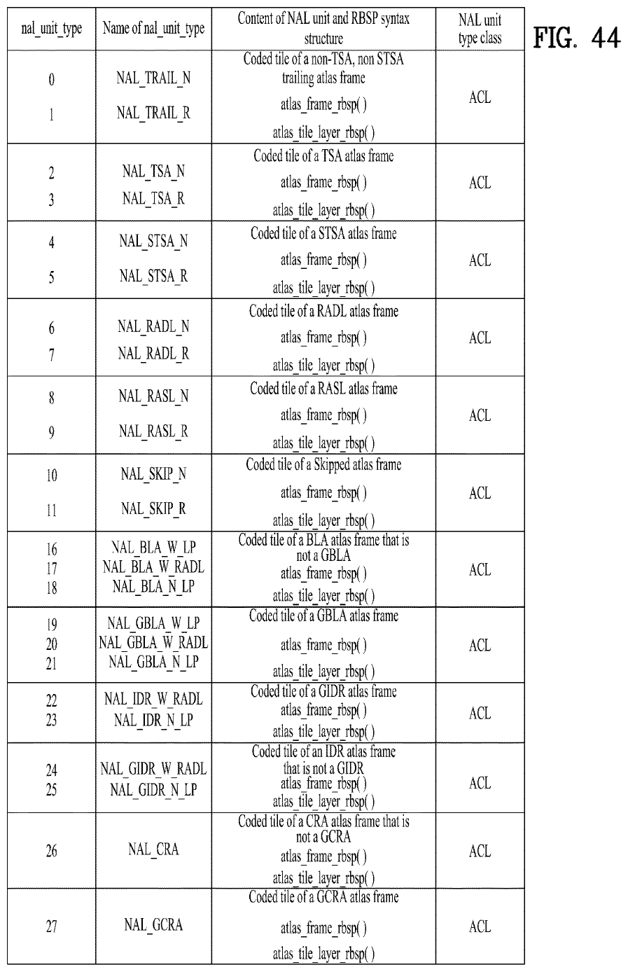

FIG. 44 illustrates an example of semantics of a NAL unit header according to embodiments. That is, FIG. 44 shows examples in which atlas_frame_rbsp( ) is included in the NAL unit header.

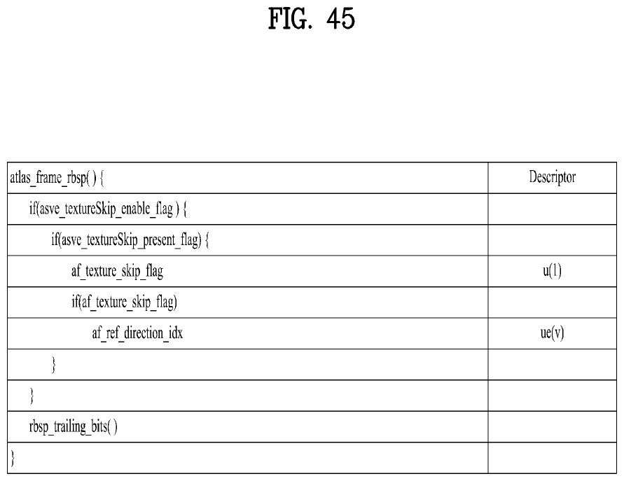

FIG. 45 illustrates an example of a syntax structure of atlas_frame_rbsp( ) according to embodiments. According to embodiments, when asve_textureSkip_enable_flag and asve_textureSkip_present_flag are both equal to 1, af_texture_skip_flag may be parsed for the texture map decoder.

In FIG. 45, af_texture_skip_flag is a flag indicating whether a texture map is skipped. For example, af_texture_skip_flag equal to 1 indicates that the texture map is skipped, and af_texture_skip_flag equal to 0 indicates that the texture map is not skipped.

af_ref_direction_idx is an index indicating a reference direction in deriving a skipped texture map. For example, af_ref_direction_idx equal to 0 indicates that a texture map in a past direction is referenced. af_ref_direction_idx equal to 1 indicates that a texture map in a future direction is referenced. af_ref_direction_idx equal to 2 indicates that texture maps in both directions are referenced.

In this case, textureSkip_present_flag in FIGS. 34 to 45 may have the same meaning as texture_skip_flag in FIGS. 26 to 33. In addition, ref_direction_idx in FIGS. 34 to 45 may have the same meaning as refDirction_idx in FIGS. 26 to 33.

Hereinafter, a description will be given of operations of a transmission apparatus and a reception apparatus when, as shown in FIGS. 34 to 45, a texture map skip flag and a reference information index for deriving a skipped frame are signaled in at least one of an ASPS, an AFPS, an atlas tile header, a patch data unit, an inter patch data unit, or atlas_frame_rbsp. Here, the transmission apparatus may be any one of the transmission apparatus 100 or mesh video encoder 102 of FIG. 12, the encoder (pre-processor and encoder) of FIGS. 2, 6, or 7, the transmission apparatus of FIG. 13, or the transmission apparatus of FIG. 15. In the present disclosure, the transmission apparatus of FIG. 15 is described as an example. In addition, the reception apparatus may be any one of the reception apparatus 110 or mesh video decoder 113 of FIG. 1, the decoder of FIG. 11 or 12, the reception apparatus of FIG. 14, or the reception apparatus of FIG. 20. In the present disclosure, the reception apparatus of FIG. 20 is described as an example.

Specifically, in the transmission apparatus, an original mesh to be transmitted is generated as a base mesh through the mesh decimator 11011 and the mesh parameterizer 11012. The generated base mesh is quantized by the mesh quantizer 11013. In the case of an inter frame, motion vectors from a previous reference reconstructed base mesh are calculated and encoded by the motion vector encoder 11015. In the case of an intra frame, the base mesh is transmitted as a base mesh bitstream through the static mesh encoder 11016. In addition, the mesh decimated through the mesh decimator is subdivided and fitted through the mesh subdivider 11018 and the mesh fitter 11019. The displacement vector calculator 11020 calculates displacement vectors between the subdivided and fitted mesh data and the reconstructed mesh data from the previously encoded base mesh. To efficiently encode the calculated displacement vectors, the displacement vector coordinate transformer 11021 may transform the displacement vector coordinate system into a local coordinate system. Then, the displacement vectors are transformed into displacement vector coefficients and quantized by the displacement vector transformer in the displacement vector encoder 11022. 2D images packed through a displacement vector coefficient packer are encoded using a 2D video encoder such as H.264, HEVC, or VVC to generate a displacement vector bitstream.

The texture map generator 11026 generates a new texture map having color information corresponding to texture coordinates of the reconstructed mesh.

Thereafter, it may be determined whether to apply a texture map skipping technique on a current content or sequence basis. According to the determination, whether the texture map skip determiner 11027 is to be operated is determined. When the texture map skipping technique is applied, the value of asve_textureSkip_enable_flag may be signaled as 1 through an ASPS V-DMC extension to transmit information on whether the texture map skipping technique is applied and texture map-related parameters to the reception apparatus.

The texture map skip determiner 11027 determines whether to skip coding of a texture map of a current frame. Texture map skipping may be determined when a difference between a PSNR calculated based on metrics between an original mesh and a current mesh and a PSNR calculated based on metrics between the original mesh and a reference mesh is less than or equal to a predetermined threshold. When there is a skipped texture map in a current sequence, the value of asve_textureSkip_present_flag may be signaled as 1 to deliver, to the reception apparatus, information indicating that there is a skipped texture in the current sequence and that reconstruction of the skipped texture map is required. In addition, when skipping of texture map coding for the current frame is determined, a texture map coding skip flag and reference direction information may be signaled. In the present disclosure, four methods for signaling the syntax (i.e., information) related to frame-level texture map coding skipping are proposed as follows.

As a first method, when texture map coding skipping is determined, signaling may be performed through a V-DMC extension of the AFPS as shown in FIG. 34. Information indicating whether the texture map of the current frame is skipped (afve_texturemap_skip_flag) may be signaled. In this case, afve_texturemap_skip_flag equal to 1 indicates that the texture map of the current frame is skipped, and afve_texturemap_skip_flag equal to 0 indicates that the texture map is not skipped. In addition, when the texture map is skipped, a reference direction (afve_ref_direction_idx) may be signaled. In this case, afve_ref_direction_idx equal to 0 may indicate that a past frame is referenced, afve_ref_direction_idx equal to 1 may indicate that a future frame is referenced, and afve_ref_direction_idx equal to 2 may indicate that frames in both directions are referenced. When the texture map is not skipped, reference direction information (afve_ref_direction_idx) may not be present, or may be assigned or filled with a predetermined value (e.g., afve_ref_direction_idx=3). In addition, when values or information of afve_texturemap_skip_flag and afve_ref_direction_idx within the AFPS V-DMC extension differ, afps_atlas_frame_parameter_set_id may be differently assigned as 0, 1, 2, or the like and signaled.

As a second method, as shown in FIG. 40, texture map skipping-related parameters may be signaled through atlas_tile_header and transmitted to the reception apparatus. When a tile type is not an I type and a texture map is skipped, information indicating whether the texture map of the current frame is skipped (ath_texture_skip_flag) may be signaled. In this case, ath_texture_skip_flag equal to 1 indicates that the texture map of the current frame is skipped, and ath_texture_skip_flag equal to 0 indicates that the texture map is not skipped. In addition, when the texture map is skipped, a reference direction (ath_ref_direction_idx) may be signaled. In this case, ath_ref_direction_idx equal to 0 may indicate that a past frame is referenced, ath_ref_direction_idx equal to 1 may indicate that a future frame is referenced, and ath_ref_direction_idx equal to 2 may indicate that frames in both directions are referenced. When the texture map is not skipped, reference direction information (ath_ref_direction_idx) may not be present, or may be assigned or filled with a predetermined value (e.g., ath_ref_direction_idx=3).

As a third method, texture map skipping-related parameters may be signaled and transmitted through patch_data_unit. When the tile type is P_TILE and the patch mode is P_INTRA, or when the tile type is I_TILE and the patch mode is I_INTRA,, information indicating whether the texture map of the current frame is skipped (pdu_texture_skip_flag) and reference direction information (pdu_ref_direction_idx) may be transmitted to the reception apparatus through patch data unit( ) as illustrated in FIG. 42. When the tile type is P_TILE and the patch mode is I_INTER, information indicating whether the texture map of the current frame is skipped (ipdu_texture_skip_flag) and reference direction information (ipdu_ref_direction_idx) may be transmitted through an inter patch data unit( ) as illustrated in FIG. 43.

As a fourth method, texture map skipping-related parameters may be signaled and transmitted through nal_unit_header as illustrated in FIGS. 44 and 45. In the present disclosure, a structure atlas_frame_rbsp( ) for transmitting frame-level information, as illustrated in FIG. 44, may be newly added to an existing nal unit parsing structure. Through this structure, a texture map skip flag (af_texture_skip_flag) and reference direction information (af_ref_direction_flag) may be signaled as illustrated in FIG. 45 and transmitted to the reception apparatus. Similarly, af_texture_skip_flag equal to 1 may indicate that the texture map of the current frame is skipped, and af_texture_skip_flag equal to 0 may indicate that the texture map is not skipped. In addition, af_ref_direction_flag equal to 0 may indicate that a past frame is referenced, af_ref_direction_flag equal to 1 may indicate that a future frame is referenced, and af_ref_direction_flag equal to 2 may indicate that frames in both directions are referenced.

When the texture map is not skipped, reference direction information (af_ref_direction_flag) may not be present, or may be assigned or filled with a predetermined value (e.g., af_ref_direction_flag=3).

As described above, among the texture maps generated by the texture map generator 11026, encoding and transmission of texture maps for which texture_skip_flag is determined as 1 by the texture map skip determiner 11027 may be skipped. In contrast, texture maps for which texture_skip_flag is 0 may be encoded by the texture map encoder 11028 using a 2D video encoder or the like.

Then, the base mesh sub-bitstream, displacement vector sub-bitstream, and texture map sub-bitstream generated through the entire process described above in the transmission apparatus are multiplexed into a single bitstream through a multiplexer and transmitted to the reception apparatus through a transmitter.

The reception apparatus receives the bitstream transmitted by the transmission apparatus and decodes the base mesh bitstream, displacement vector bitstream, and texture map bitstream, respectively, through a demultiplexer.

First, the base mesh bitstream is decoded through the motion vector decoder 15012 in the case of an inter frame, or through the static mesh decoder 15013 in the case of an intra frame. The decoded base mesh undergoes mesh subdivision through the base mesh reconstructor 15014 and the mesh subdivider 15015.

The displacement vector bitstream is decoded by the displacement vector decoder 15017 in reverse order of encoding and displacement vector coefficients are restored. The restored displacement vector coefficients are inverse-quantized and inverse-transformed through the displacement vector inverse quantizer 15018 and the displacement vector inverse transformer 15019. Then, the displacement vector coordinate inverse transformer 15020 inverse transforms the coordinate system of the inverse-transformed displacement vectors from a local coordinate system to a Cartesian coordinate system to reconstruct mesh geometry information together with base mesh data.

The mesh reconstructor 15016 may reconstruct final geometry information by calculating the vertex geometry information related to the reconstructed mesh by adding reconstructed displacement vectors to vertices generated through the subdivision operation of the mesh subdivider 15015.

A texture map is reconstructed from the texture map bitstream by the texture map decoder 15021. The operation process of the texture map decoder 15021 according to the present disclosure is described in more detail below.

First, the texture map decoder 15021 may parse asve_textureSkip_enable_flag from the ASPS to determine whether a texture map skipping technique is applied to the current content or sequence. When the value of asve_textureSkip_enable_flag is 1, indicating that the texture map skipping technique is applied, a process for reconstructing a skipped texture map is required. To this end, the texture map decoder 15021 may receive parameters related to texture map skipping. In addition, when asve_texture present_flag is parsed and is equal to 1, it may be determined that some texture maps are skipped within the texture map bitstream received on a per-sequence basis, and a process for reconstructing the skipped texture maps may be performed. In the present disclosure, the following methods may be used to parse parameters required for reconstruction in order to reconstruct skipped texture maps on a per-frame basis.

For the methods in common, when asve_textureSkip_enable_flag in the ASPS may be parsed and is equal to 1, it may be determined that a texture map coding skipping technique is applied to the current content or sequence. Then, when asve_texture_present_flag is parsed and is equal to 1, it may be determined that there are skipped texture maps within the sequence.

Thereafter, texture map reconstruction may be performed by parsing related parameters for reconstructing the skipped texture maps (or related information for reconstructing the skipped texture maps) according to each signaling method.

First, when related information for reconstructing the skipped texture maps is transmitted through the AFPS as illustrated in FIG. 35, afve_texturemap_skip_flag in the atlas frame parameter set V-DMC extension is parsed. Then, when parsed afve_texturemap_skip_flag is equal to 1, it may be determined that the texture map of the current frame is skipped. afve_texturemap_skip_flag equal to 0 indicates that the texture map of the current frame is not skipped. When afve_texturemap_skip_flag is equal to 1, avfe_ref_direction_idx may be parsed to determine a reference direction for reconstructing the skipped texture map. avfe_ref_direction_idx equal to 0 indicates that reconstruction is performed by referencing a past frame. avfe_ref_direction_idx equal to 1 indicates that reconstruction is performed by referencing a future frame. avfe_ref_direction_idx equal to 2 indicates that reconstruction is performed by referencing frames in both directions. When afve_texturemap_skip_flag is equal to 0, avfe_ref_direction_idx may not be present, or may be assigned a specific value or a value agreed upon with the encoder. In addition, in the case of the afps_vdmc_extension, when the configuration or values of syntax elements (also referred to as fields) differ, different set IDs may be assigned to signal the syntax information.

Second, when related information for reconstructing the skipped texture maps is transmitted through the atlas tile header as illustrated in FIG. 40, ath_texture_skip_flag may be parsed from atlas_tile_header( ) when the tile type is not I_TILE. Then, when the parsed flag is equal to 1, it may be determined that the texture map of the current frame is skipped. ath_texture_skip_flag equal to 0 indicates that the texture map of the current frame is not skipped. When ath_texturemap_skip_flag is equal to 1, ath_ref_direction_idx may be parsed to determine a reference direction for reconstructing the skipped texture map. ath_ref_direction_idx equal to O indicates that reconstruction is performed by referencing a past frame. ath_ref_direction_idx equal to 1 indicates that reconstruction is performed by referencing a future frame. ath_ref_direction_idx equal to 2 indicates that reconstruction is performed by referencing frames in both directions. When ath_texturemap_skip_flag is equal to 0, ath_ref_direction_idx may not be present, or may be assigned a specific value or a value agreed upon with the encoder.

Third, when related information for reconstructing the skipped texture maps is transmitted through the patch data unit, the information may vary depending on atlas and patch types in patch_information_data( ) as illustrated in FIG. 41. When the tile type is P type and the patch mode is P_INTRA, or when the atlas type is I type and the patch mode is I_INTRA, pdu_texture_skip_flag in patch_data_unit( )in FIG. 42 is parsed. When the flag is equal to 1, it may be determined that the texture map of the current frame is skipped. pdu_texture_skip_flag equal to 0 indicates that the texture map of the current frame is not skipped. When pdu_texture_skip_flag is 1, pdu_ref_direction_idx may be parsed to determine a reference direction for reconstructing the skipped texture map. pdu_ref_direction_idx equal to 0 indicates that reconstruction is performed by referencing a past frame. pdu_ref_direction_idx equal to 1 indicates that reconstruction is performed by referencing a future frame. pdu_ref_direction_idx equal to 2 indicates that reconstruction is performed by referencing frames in both directions.

When pdu_texture_skip_flag is equal to 0, pdu_ref_direction_idx may not be present, or may be assigned a specific value or a value agreed upon with the encoder. When the tile type is P type and the patch mode is P_INTER, ipdu_texture_skip_flag in inter_patch_data_unit( ) illustrated in FIG. 43 may be parsed to determine whether the texture map is skipped, and ipdu_ref_direction_idx may be parsed to determine the reference direction for the texture map. The meanings of the respective syntax elements are identical to those of the pdu.

Fourth, when related information for reconstructing the skipped texture maps is transmitted through the NAL unit header, atlas_frame_rbsp( ), newly added to an existing NAL unit parsing structure as illustrated in FIG. 44, is parsed. When af_texture_skip_flag is equal to 1, it may be determined that the texture map of the current frame is skipped. af_texture_skip_flag equal to 0 indicates that the texture map of the current frame is not skipped. When af_texture_skip_flag is equal to 1, af_ref_direction_idx may be parsed to determine a reference direction for reconstructing the skipped texture map. af_ref_direction_idx equal to 0 indicates that reconstruction is performed by referencing a past frame. af_ref_direction_idx equal to 1 indicates that reconstruction is performed by referencing a future frame. af_ref_direction_idx equal to 2 indicates that reconstruction is performed by referencing frames in both directions. When af_texture_skip_flag is equal to 0, af_ref_direction_idx may not be present, or may be assigned a specific value or a value agreed upon with the encoder.

As described above, the texture map deriver 16014 of the texture map decoder 15021 may identify frames in which texture maps are skipped using the above described methods, i.e., based on texture_skip_flag and ref_direction_idx, obtain information about a reference frame, and reconstruct the skipped texture maps by copying the skipped texture maps from the reference frame. In the case of bi-directional frame reference, reconstruction may be performed using an average of the texture maps of a past frame and a future frame.

When texture maps are reconstructed through the above-described process, a final reconstructed mesh is generated together with the previously reconstructed final geometry information.

As described above, in the present disclosure, when the similarity between a reference texture map and a current texture map is high, coding of the current texture map is skipped. In addition, to allow the texture map decoder of the reception apparatus receiving a texture map bitstream in which a texture map is skipped (i.e., a texture map for which coding and transmission are skipped) to reconstruct the skipped texture map, the transmission apparatus signals and transmits information related to the skipped texture map to the reception apparatus.

For example, in order to achieve efficient syntax transmission and operation of a V-DMC codec in accordance with an existing V-DMC bitstream structure, a flag indicating whether a texture map skipping technique is enabled and a flag indicating the presence of skipped texture maps within a sequence are signaled and transmitted through an ASPS. In addition, based on an atlas stream, a frame-level texture map skip flag and reference information for deriving a skipped texture map are signaled at respective syntax transmission locations (including an atlas frame parameter set, a tile header, a patch data unit, and a NAL unit header). Accordingly, when a texture map skipping technique is applied to a V-DMC codec and a signaling method for information related to skipped texture maps is used, required bits may be significantly reduced, and faster transmission speed may be achieved.

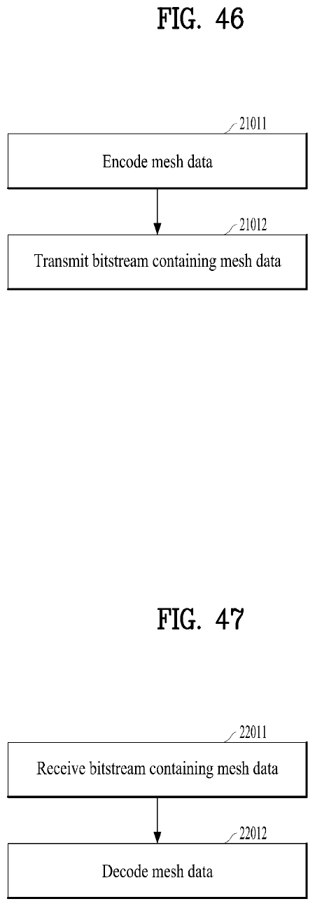

FIG. 46 is a flowchart illustrating an example of a transmission method according to embodiments. The transmission method according to embodiments may include encoding mesh data (21011) and transmitting a bitstream containing the encoded mesh data (21012).

According to embodiments, the encoding (21011) of the mesh data includes skipping coding of a current texture map when the similarity between a reference texture map and the current texture map is high. In this regard, for details of a method of determining the similarity between the reference texture map and the current texture map to skip the texture map, and corresponding signaling of information related to the skipped texture map, which are not described below to avoid redundancy, refer to the descriptions of FIGS. 15 to 19 and FIGS. 26 to 45.

FIG. 47 is a flowchart illustrating an example of a reception method according to embodiments. The receiving method according to embodiments may include receiving a bitstream containing mesh data (22011) and decoding the mesh data contained in the bitstream (22012).

In the present disclosure, the decoding (22012) of the mesh data contained in the bitstream includes reconstructing texture maps by decoding a demultiplexed texture map bitstream based on signaling information. In this case, some texture maps are skipped within the received texture map bitstream, and decoding (22012) of the mesh data includes reconstructing the skipped texture maps based on the signaling information. In this regard, for details of a method of reconstructing the skipped texture maps and signaling information related to the skipped texture maps, which are not described below to avoid redundancy, refer to the descriptions of FIGS. 20 to 45.

Each part, module, or unit described above may be a software, processor, or hardware part that executes successive procedures stored in a memory (or storage unit). Each of the steps described in the above embodiments may be performed by a processor, software, or hardware parts. Each module/block/unit described in the above embodiments may operate as a processor, software, or hardware. In addition, the methods presented by the embodiments may be executed as code. This code may be written on a processor readable storage medium and thus read by a processor provided by an apparatus.

In the specification, when a part “comprises” or “includes” an element, it means that the part further comprises or includes another element unless otherwise mentioned. Also, the term “ . . . module(or unit)” disclosed in the specification means a unit for processing at least one function or operation, and may be implemented by hardware, software or combination of hardware and software.

Although embodiments have been explained with reference to each of the accompanying drawings for simplicity, it is possible to design new embodiments by merging the embodiments illustrated in the accompanying drawings. If a recording medium readable by a computer, in which programs for executing the embodiments mentioned in the foregoing description are recorded, is designed by those skilled in the art, it may fall within the scope of the appended claims and their equivalents.

The apparatuses and methods may not be limited by the configurations and methods of the embodiments described above. The embodiments described above may be configured by being selectively combined with one another entirely or in part to enable various modifications.

Although preferred embodiments of the embodiments have been shown and described, the embodiments are not limited to the specific embodiments described above, and various modifications may be made by one of ordinary skill in the art without departing from the spirit of the embodiments claimed in the claims, and such modifications should not be understood in isolation from the technical ideas or views of the embodiments.

Various elements of the apparatuses of the embodiments may be implemented by hardware, software, firmware, or a combination thereof. Various elements in the embodiments may be implemented by a single chip, for example, a single hardware circuit. According to embodiments, the components according to the embodiments may be implemented as separate chips, respectively. According to embodiments, at least one or more of the components of the apparatus according to the embodiments may include one or more processors capable of executing one or more programs. The one or more programs may perform any one or more of the operations/methods according to the embodiments or include instructions for performing the same. Executable instructions for performing the method/operations of the apparatus according to the embodiments may be stored in a non-transitory CRM or other computer program products configured to be executed by one or more processors, or may be stored in a transitory CRM or other computer program products configured to be executed by one or more processors. In addition, the memory according to the embodiments may be used as a concept covering not only volatile memories (e.g., RAM) but also nonvolatile memories, flash memories, and PROMs. In addition, it may also be implemented in the form of a carrier wave, such as transmission over the Internet. In addition, the processor-readable recording medium may be distributed to computer systems connected over a network such that the processor-readable code may be stored and executed in a distributed fashion.

In this document, the term “/” and “,” should be interpreted to indicate “and/or.” For instance, the expression “A/B” may mean “A and/or B.” Further, “A, B” may mean “A and/or B.” Further, “A/B/C” may mean “at least one of A, B, and/or C.” Also, “A/B/C” may mean “at least one of A, B, and/or C.” Further, in the document, the term “or” should be interpreted to indicate “and/or.” For instance, the expression “A or B” may comprise 1) only A, 2) only B, and/or 3) both A and B. In other words, the term “or” in this document should be interpreted to indicate “additionally or alternatively.”

Various elements of the embodiments may be implemented by hardware, software, firmware, or a combination thereof. Various elements in the embodiments may be executed by a single chip such as a single hardware circuit. According to embodiments, the element may be selectively executed by separate chips, respectively. According to embodiments, at least one of the elements of the embodiments may be executed in one or more processors including instructions for performing operations according to the embodiments.

Operations according to the embodiments described in this specification may be performed by a transmission/reception apparatus including one or more memories and/or one or more processors according to embodiments. The one or more memories may store programs for processing/controlling the operations according to the embodiments, and the one or more processors may control various operations described in this specification. The one or more processors may be referred to as a controller or the like. In embodiments, operations may be performed by firmware, software, and/or combinations thereof. The firmware, software, and/or combinations thereof may be stored in the processor or the memory.

Terms such as first and second may be used to describe various elements of the embodiments. However, various components according to the embodiments should not be limited by the above terms. These terms are only used to distinguish one element from another. For example, a first user input signal may be referred to as a second user input signal. Similarly, the second user input signal may be referred to as a first user input signal. Use of these terms should be construed as not departing from the scope of the various embodiments. The first user input signal and the second user input signal are both user input signals, but do not mean the same user input signal unless context clearly dictates otherwise. The terminology used to describe the embodiments is used for the purpose of describing particular embodiments only and is not intended to be limiting of the embodiments. As used in the description of the embodiments and in the claims, the singular forms “a”, “an”, and “the” include plural referents unless the context clearly dictates otherwise. The expression “and/or” is used to include all possible combinations of terms. The terms such as “includes” or “has” are intended to indicate existence of figures, numbers, steps, elements, and/or components and should be understood as not precluding possibility of existence of additional existence of figures, numbers, steps, elements, and/or components.

As used herein, conditional expressions such as “if” and “when” are not limited to an optional case and are intended to be interpreted, when a specific condition is satisfied, to perform the related operation or interpret the related definition according to the specific condition.

Embodiments may include variations/modifications within the scope of the claims and their equivalents. It will be apparent to those skilled in the art that various modifications and variations may be made in the present disclosure without departing from the spirit and scope of the disclosure. Thus, it is intended that the present disclosure cover the modifications and variations of the present disclosure provided they come within the scope of the appended claims and their equivalents.

### MODE FOR DISCLOSURE

As described above, related contents have been described in the best mode for carrying out the embodiments.

### INDUSTRIAL APPLICABILITY

As described above, the embodiments may be fully or partially applied to the 3D data transmission/reception apparatus and system. It will be apparent to those skilled in the art that various changes or modifications may be made to the embodiments within the scope of the embodiments. Thus, it is intended that the embodiments cover modifications and variations provided they come within the scope of the appended claims and their equivalents.

1. A method of decoding mesh data, the method comprising:
receiving a base mesh bitstream, a displacement vector bitstream, a texture map bitstream, and signaling information;
a base mesh processing operation of reconstructing a base mesh from the base mesh bitstream;
a displacement information processing operation of reconstructing displacement information from the displacement vector bitstream;
a reconstruction operation of reconstructing a mesh based on the base mesh and the displacement information; and
a texture map processing operation of reconstructing texture maps from the texture map bitstream.

2. The method of claim 1, wherein the texture map processing operation comprises:
decoding the texture map bitstream based on the signaling information and reconstructing the texture maps;
checking, based on the signaling information, whether at least one texture map is skipped from the texture map bitstream; and
based on that it is checked that there is the at least one skipped texture map, generating the at least one skipped texture map based on the signaling information and at least one reference frame.

3. The method of claim 2, wherein a unit of skipping of the at least one texture map is at least one of a frame, a patch, a submesh, a tile, or a slice.

4. The method of claim 2, wherein the signaling information comprises:
information for identifying whether the at least one texture map is skipped; and
reference texture map information related to the at least one reference frame.

5. An apparatus for decoding mesh data, comprising:
a receiver configured to receive a base mesh bitstream, a displacement vector bitstream, a texture map bitstream, and signaling information;
a base mesh processor configured to reconstruct a base mesh from the base mesh bitstream;
a displacement information processor configured to reconstruct displacement information from the displacement vector bitstream;
a reconstructor configured to reconstruct a mesh based on the base mesh and the displacement information; and
a texture map processor configured to reconstruct texture maps from the texture map bitstream.

6. The apparatus of claim 5, wherein the texture map processor is configured to:
decode the texture map bitstream based on the signaling information and reconstructing the texture maps;
check, based on the signaling information, whether at least one texture map is skipped from the texture map bitstream; and
based on that it is checked that there is the at least one skipped texture map, generate the at least one skipped texture map based on the signaling information and at least one reference frame.

7. The apparatus of claim 6, wherein a unit of skipping of the at least one texture map is at least one of a frame, a patch, a submesh, a tile, or a slice.

8. The apparatus of claim 6, wherein the signaling information comprises:
information for identifying whether the at least one texture map is skipped; and
reference texture map information related to the at least one reference frame.

9. A method of encoding mesh data, the method comprising:
encoding an original mesh; and
transmitting a bitstream containing the encoded mesh and signaling information.

10. The method of claim 9, wherein the encoding comprises:
a base mesh processing operation of generating a base mesh bitstream by encoding a base mesh generated by decimating the original mesh;
a displacement information processing operation of generating a displacement vector bitstream by encoding displacement information generated based on the base mesh;
a mesh reconstruction operation of reconstructing a mesh based on the encoded base mesh and the encoded displacement information; and
a texture map processing operation of determining whether at least one texture map among texture maps generated based on the original mesh and the reconstructed mesh is skipped and generating a texture map bitstream by encoding texture maps that are not skipped.

11. The method of claim 10, wherein the texture map processing operation comprises:
before encoding the generated texture maps, comparing similarity between a current texture map and a reference texture map and determining whether the current texture map is skipped.

12. The method of claim 11, wherein the texture map processing operation further comprises:
based on that a difference between a peak-signal-to-noise ratio (PSNR) calculated based on the current texture map and a PSNR calculated based on the reference texture map is less than a preset threshold, skipping coding and transmission of the current texture map.

13. The method of claim 10, wherein a unit of skipping of the at least one texture map is at least one of a frame, a patch, a submesh, a tile, or a slice.

14. The method of claim 13, wherein the signaling information comprises:
information for identifying whether the at least one texture map is skipped; and
reference texture map information related to at least one reference frame for generating the skipped texture map.

15. The method of claim 14, wherein the reference texture map information comprises information for identifying a direction of the at least one reference frame.
